(19) United States
(12) Patent Application Publication
(10) Pub. No.: US 2026/0093366 A1
(43) Pub. Date: Apr. 2, 2026

(54) ELECTRONIC DEVICE

(71) Applicant: Samsung Display Co., Ltd., Yongin-si (KR)

(72) Inventor: SANGHYUN LIM, Yongin-si (KR)

(21) Appl. No.: 19/287,602

(22) Filed: Jul. 31, 2025

(30) Foreign Application Priority Data
Oct. 2, 2024 (KR) 10-2024-0133477

(51) Int. Cl. G06F 3/044; G06F 3/041

(52) U.S. Cl. CPC G06F 3/0446; G06F 3/04164; G06F 3/0445; G06F 3/0448; G06F 2203/04111; G06F 2203/04112

(57) ABSTRACT

An electronic device includes a sensor layer having a sensing area and a peripheral area adjacent to the sensing area. The sensor layer includes a plurality of first electrodes and a plurality of second electrodes. The sensing area includes a plurality of sensing units. The plurality of sensing units include a first sensing unit space from the peripheral area and a second sensing unit in contact with the peripheral area. The plurality of first electrodes include a first-second electrode that overlaps the second sensing unit. The plurality of second electrodes include a second-second electrode that overlaps the second sensing unit. The first-second electrode and the second-second electrode have an asymmetrical structure with respect to at least one of a line extending in a first direction or a line extending in a second direction in the second sensing unit.

### CROSS-REFERENCE TO RELATED APPLICATION

This application claims priority to and the benefit of Korean Patent Application No. 10-2024-0133477, filed on Oct. 2, 2024, in the Korean Intellectual Property Office, the entire disclosure of which is incorporated by reference herein.

### BACKGROUND

Embodiments of the present disclosure described herein relate to an electronic device with improved sensing performance.

Multimedia electronic devices, such as a television, a mobile phone, a tablet computer, a notebook computer, a car navigation device, a game machine, and/or the like, include a display device for displaying an image. The electronic devices may include a sensor layer (or, an input sensor) capable of providing a touch-based input method that enables a user to intuitively and conveniently input information or instructions in an easy and simple manner, in addition to a conventional input method such as a button, a keyboard, a mouse, and/or the like. The sensor layer may sense the user's touch and/or pressure. Pens for users accustomed to inputting information using writing instruments or pens for accurate touch inputs in specific application programs (e.g., application programs for sketching or drawing) have been increasingly demanded.

### SUMMARY

Embodiments of the present disclosure provide an electronic device for improving sensing performance and enhancing sensing sensitivity at a periphery accordingly.

According to one or more embodiments, an electronic device includes a sensor layer having a sensing area and a peripheral area adjacent to the sensing area and a sensor driver that drives the sensor layer. The sensor layer includes a plurality of first electrodes arranged along a first direction and a plurality of second electrodes that cross the plurality of first electrodes and that are arranged along a second direction crossing the first direction. The sensing area includes a plurality of sensing units arranged along the first direction and the second direction. The plurality of sensing units include a first sensing unit spaced apart from the peripheral area and a second sensing unit in contact with the peripheral area. The plurality of first electrodes include a first-first electrode that overlaps the first sensing unit and a first-second electrode that overlaps the second sensing unit. The plurality of second electrodes include a second-first electrode that overlaps the first sensing unit and a second-second electrode that overlaps the second sensing unit. The first-first electrode and the second-first electrode have a symmetrical structure with respect to a line extending in the first direction and a line extending in the second direction in the first sensing unit. The first-second electrode and the second-second electrode have an asymmetrical structure with respect to at least one of a line extending in the first direction or a line extending in the second direction in the second sensing unit.

The first-first electrode may include a plurality of first sub-electrodes arranged along the first direction and having substantially the same shape, the first-second electrode may include a plurality of second sub-electrodes arranged along the first direction, and resistance of one second sub-electrode from among the plurality of second sub-electrodes may be lower than resistance of another second sub-electrode from among the plurality of second sub-electrodes.

The one second sub-electrode may be closer to the peripheral area than the other second sub-electrode.

The one second sub-electrode may have a larger area than the other second sub-electrode.

The one second sub-electrode may include a plurality of first mesh lines having a first line width, and the another second sub-electrode may include a plurality of second mesh lines having a second line width smaller than the first line width.

The sensor layer may further include a plurality of third electrodes arranged along the first direction, and the plurality of third electrodes may overlap the plurality of first electrodes in a one-to-one correspondence. The plurality of third electrodes may include one third electrode that overlaps the first-second electrode, and the one third electrode may include a plurality of third sub-electrodes arranged along the first direction.

The plurality of third sub-electrodes may include a third-first sub-electrode that overlaps the one second sub-electrode and a third-second sub-electrode that overlaps the other second sub-electrode, and resistance of the third-first sub-electrode may be lower than resistance of the third-second sub-electrode.

The third-first sub-electrode may include a first bridge pattern on a same layer as the one second sub-electrode, the third-second sub-electrode may include a second bridge pattern on a same layer as the first bridge pattern, and resistance of the first bridge pattern may be lower than resistance of the second bridge pattern.

The number of mesh lines included in the first bridge pattern may be greater than the number of mesh lines included in the second bridge pattern.

First capacitance between the one second sub-electrode and the third-first sub-electrode may be greater than second capacitance between the another second sub-electrode and the third-second sub-electrode, and the third-first sub-electrode may be closer to the peripheral area than the third-second sub-electrode.

The plurality of sensing units may further include a third sensing unit between the first sensing unit and the second sensing unit. The plurality of first electrodes may further include a first-third electrode that overlaps the third sensing unit. The first-third electrode may have a shape different from a shape of the first-first electrode and a shape of the first-second electrode.

The first-first electrode may include a plurality of first sub-electrodes arranged along the first direction and having substantially the same shape. The first-second electrode may include a plurality of second sub-electrodes arranged along the first direction. The first-third electrode may include a plurality of third sub-electrodes arranged along the first direction. The plurality of first sub-electrodes may have a same resistance ratio. A maximum difference in resistance ratio between the plurality of second sub-electrodes may be greater than a maximum difference in resistance ratio between the plurality of third sub-electrodes.

The first-second electrode may include a first layer electrode on a same layer as the first-first electrode and a second layer electrode located below the first layer electrode and electrically connected with the first layer electrode.

The sensor layer may further include an additional electrode connected with one second electrode from among the plurality of second electrodes. The plurality of second electrodes may be sequentially arranged along the second direction, and the one second electrode may be one of two second electrodes at outermost positions from among the plurality of second electrodes.

The sensor layer may further include a plurality of first trace lines electrically connected with the plurality of first electrodes and a plurality of second trace lines electrically connected with the plurality of second electrodes, and some of the plurality of second trace lines may be located between the one second electrode and the additional electrode.

The electronic device may further include a display layer that is located below the sensor layer and that includes a display area and a non-display area adjacent to the display area, and the some of the plurality of second trace lines may overlap the display area.

A crossing area where the first-second electrode and the second-second electrode overlap each other in the second sensing unit may be closer to the peripheral area than a center of the second sensing unit.

The first sensing unit and the second sensing unit may be spaced from each other in the first direction, and the first sensing unit may have a greater width in the first direction than the second sensing unit.

A distance between a center of the first-second electrode and a boundary between the peripheral area and the sensing area may be smaller than half a pitch between the plurality of first electrodes.

According to one or more embodiments, an electronic device includes a sensor layer having a sensing area and a peripheral area adjacent to the sensing area and a sensor driver that drives the sensor layer. The sensor layer includes a plurality of first electrodes, a plurality of second electrodes that cross the plurality of first electrodes, a plurality of third electrodes that overlap the plurality of first electrodes, and a plurality of fourth electrodes that cross the plurality of first electrodes. The sensing area includes a plurality of sensing units arranged along a first direction and a second direction crossing the first direction. The plurality of sensing units include a first sensing unit spaced apart from the peripheral area and a second sensing unit in contact with the peripheral area. The plurality of first electrodes include a first-first electrode that overlaps the first sensing unit and a first-second electrode that overlaps the second sensing unit. The first-first electrode has a shape different from a shape of the first-second electrode.

The first-first electrode may include a plurality of first-first sub-electrodes arranged along the first direction and having substantially the same shape. The first-second electrode may include a plurality of first-second sub-electrodes arranged along the first direction. Resistance of one first-second sub-electrode from among the plurality of first-second sub-electrodes may be lower than resistance of another first-second sub-electrode from among the plurality of first-second sub-electrodes.

The one first-second sub-electrode may be closer to the peripheral area than the another first-second sub-electrode.

According to one or more embodiments, an electronic device includes a sensor layer in which a sensing area and a peripheral area adjacent to the sensing area are defined and a sensor driver that drives the sensor layer. The sensing area includes a plurality of sensing units. The plurality of sensing units include a first sensing unit spaced apart from the peripheral area and a second sensing unit in contact with the peripheral area. The second sensing unit includes a first sub-area adjacent to the peripheral area and a second sub-area spaced apart from the peripheral area with the first sub-area therebetween. An area occupied by a conductive pattern that transfers a predetermined signal in the first sub-area is greater than an area occupied by a conductive pattern that transfers the predetermined signal in the second sub-area.

### BRIEF DESCRIPTION OF THE DRAWINGS

The above and other aspects and features of embodiments of the present disclosure will become apparent by describing in detail embodiments thereof with reference to the accompanying drawings.

FIG. 1A is a perspective view of an electronic device according to one or more embodiments of the present disclosure.

FIG. 1B is a rear perspective view of the electronic device according to one or more embodiments of the present disclosure.

FIG. 2 is a perspective view of an electronic device according to one or more embodiments of the present disclosure.

FIG. 3 is a perspective view of an electronic device according to one or more embodiments of the present disclosure.

FIG. 4 is a schematic sectional view of a display panel according to one or more embodiments of the present disclosure.

FIG. 5 is a view for explaining an operation of an electronic device according to one or more embodiments of the present disclosure.

FIG. 6A is a sectional view of the display panel according to one or more embodiments of the present disclosure;

FIG. 6B is a sectional view illustrating some components of a sensor layer according to one or more embodiments of the present disclosure.

FIG. 7 is a plan view of the sensor layer according to one or more embodiments of the present disclosure.

FIG. 8 is a schematic view illustrating operations of the sensor layer and a sensor driver according to one or more embodiments of the present disclosure.

FIG. 9 is a view illustrating a current generated by a pen.

FIG. 10A is a plan view illustrating a sensing area according to one or more embodiments of the present disclosure.

FIG. 10B is a plan view illustrating a sensing area according to one or more embodiments of the present disclosure.

FIG. 10C is a plan view illustrating a sensing area according to one or more embodiments of the present disclosure.

FIG. 11A is a plan view illustrating a first conductive layer of a first sensing unit according to one or more embodiments of the present disclosure.

FIG. 11B is a plan view illustrating a second conductive layer of the first sensing unit according to one or more embodiments of the present disclosure.

FIG. 12A is a plan view illustrating a first conductive layer of a second sensing unit according to one or more embodiments of the present disclosure.

FIG. 12B is a plan view illustrating a second conductive layer of the second sensing unit according to one or more embodiments of the present disclosure.

FIG. 13A is an enlarged plan view illustrating a portion of the second conductive layer of the second sensing unit according to one or more embodiments of the present disclosure.

FIG. 13B is an enlarged plan view illustrating a portion of the second conductive layer of the second sensing unit according to one or more embodiments of the present disclosure.

FIG. 14A is an enlarged plan view illustrating a portion of the second conductive layer of the second sensing unit according to one or more embodiments of the present disclosure.

FIG. 14B is an enlarged plan view illustrating a portion of the second conductive layer of the second sensing unit according to one or more embodiments of the present disclosure.

FIG. 15A is a plan view illustrating a first conductive layer of a second sensing unit according to one or more embodiments of the present disclosure.

FIG. 15B is a plan view illustrating a second conductive layer of the second sensing unit according to one or more embodiments of the present disclosure.

FIG. 16 is a plan view illustrating a second conductive layer of three sensing units according to one or more embodiments of the present disclosure.

FIG. 17A is a plan view illustrating a first conductive layer of a second sensing unit according to one or more embodiments of the present disclosure.

FIG. 17B is a plan view illustrating a second conductive layer of the second sensing unit according to one or more embodiments of the present disclosure.

FIG. 18A is a plan view illustrating a first conductive layer of a first sensing unit according to one or more embodiments of the present disclosure.

FIG. 18B is a plan view illustrating a second conductive layer of the first sensing unit according to one or more embodiments of the present disclosure.

FIG. 19A is a plan view illustrating a first conductive layer of a second sensing unit according to one or more embodiments of the present disclosure.

FIG. 19B is a plan view illustrating a second conductive layer of the second sensing unit according to one or more embodiments of the present disclosure.

FIG. 20A is a plan view illustrating a first conductive layer of a second sensing unit according to one or more embodiments of the present disclosure.

FIG. 20B is a plan view illustrating a second conductive layer of the second sensing unit according to one or more embodiments of the present disclosure.

FIG. 21A is a plan view illustrating a first conductive layer of a second sensing unit according to one or more embodiments of the present disclosure.

FIG. 21B is a plan view illustrating a second conductive layer of the second sensing unit according to one or more embodiments of the present disclosure.

FIG. 22A is a plan view illustrating a first conductive layer of a second sensing unit according to one or more embodiments of the present disclosure.

FIG. 22B is a plan view illustrating a second conductive layer of the second sensing unit according to one or more embodiments of the present disclosure.

FIG. 23 is a plan view illustrating some of the components included in a second sensing unit according to one or more embodiments of the present disclosure.

FIG. 24A is a plan view illustrating a portion of a first conductive layer of the sensor layer according to one or more embodiments of the present disclosure.

FIG. 24B is a plan view illustrating a portion of a second conductive layer of the sensor layer according to one or more embodiments of the present disclosure.

FIG. 25A is a plan view illustrating a portion of the first conductive layer of the sensor layer according to one or more embodiments of the present disclosure.

FIG. 25B is a plan view illustrating a portion of the second conductive layer of the sensor layer according to one or more embodiments of the present disclosure.

FIG. 26A is a plan view illustrating a portion of the first conductive layer of the sensor layer according to one or more embodiments of the present disclosure.

FIG. 26B is a plan view illustrating a portion of the second conductive layer of the sensor layer according to one or more embodiments of the present disclosure.

FIG. 27 is a plan view of a sensor layer according to one or more embodiments of the present disclosure.

FIG. 28 is a plan view illustrating a sensing area according to one or more embodiments of the present disclosure.

FIG. 29 is a plan view illustrating a second conductive layer of three sensing units according to one or more embodiments of the present disclosure.

FIG. 30 is a view illustrating an operation of the sensor driver according to one or more embodiments of the present disclosure.

FIG. 31 is a view illustrating an operation of the sensor driver according to one or more embodiments of the present disclosure.

FIG. 32 is a view for explaining a first mode according to one or more embodiments of the present disclosure.

FIG. 33 is a view for explaining a second mode according to one or more embodiments of the present disclosure.

FIG. 34A is a graph depicting the waveform of a first signal according to one or more embodiments of the present disclosure.

FIG. 34B is a graph depicting the waveform of a second signal according to one or more embodiments of the present disclosure.

FIG. 35A is a view for explaining the second mode according to one or more embodiments of the present disclosure.

FIG. 35B is a view for explaining the second mode based on one sensing unit according to one or more embodiments of the present disclosure.

### DETAILED DESCRIPTION

In this specification, when a component (or, an area, a layer, a part, etc.) is referred to as being “on”, “connected to” or “coupled to” another component, this means that the component may be directly on, connected to, or coupled to the other component or a third component may be present therebetween.

Identical reference numerals refer to identical components. Additionally, in the drawings, the thicknesses, proportions, and dimensions of components are exaggerated for effective description. As used herein, the term “and/or” includes all of one or more combinations defined by related components.

Terms such as first, second, and/or the like may be used to describe various components, but the components should not be limited by the terms. The terms may be used only for distinguishing one component from other components. For example, without departing the spirit and scope of the present disclosure, a first component may be referred to as a second component, and similarly, the second component may also be referred to as the first component. The terms of a singular form may include plural forms unless otherwise specified.

In addition, terms such as “below”, “under”, “above”, and “over” are used to describe a relationship between components illustrated in the drawings. The terms are relative concepts and are described based on directions illustrated in the drawing.

It should be understood that terms such as “comprise”, “include”, and “have”, when used herein, specify the presence of stated features, numbers, steps, operations, components, parts, or combinations thereof, but do not preclude the presence or addition of one or more other features, numbers, steps, operations, components, parts, and/or combinations thereof.

The terms “part” and “unit” mean a software component or a hardware component that performs a specific function. The hardware component may include, for example, a field-programmable gate array (FPGA) or an application-specific integrated circuit (ASIC). The software component may refer to executable code and/or data used by executable code in an addressable storage medium. Thus, software components may be, for example, object-oriented software components, class components, and working components, and may include processes, functions, properties, procedures, subroutines, program code segments, drivers, firmware, micro-codes, circuits, data, databases, data structures, tables, arrays, and/or variables.

Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Hereinafter, embodiments of the present disclosure will be described with reference to the accompanying drawings.

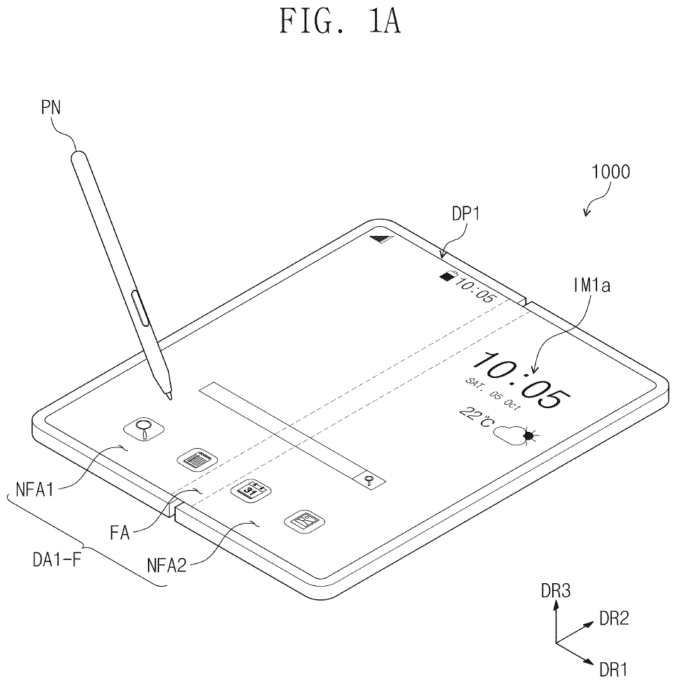

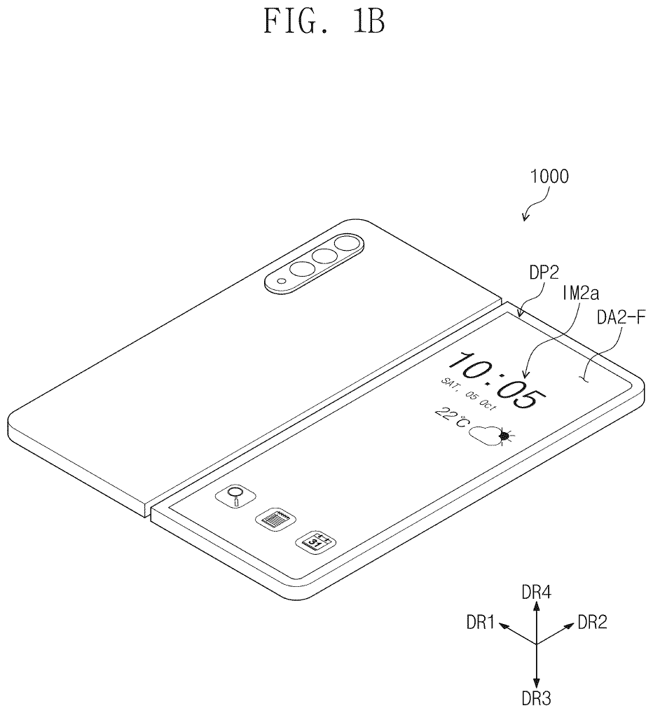

FIG. 1A is a perspective view of an electronic device 1000 according to one or more embodiments of the present disclosure. FIG. 1B is a rear perspective view of the electronic device 1000 according to one or more embodiments of the present disclosure.

Referring to FIGS. 1A and 1B, the electronic device 1000 may be a device activated in response to an electrical signal. For example, the electronic device 1000 may display an image and may sense an input applied from the outside. The external input may be a user input. The user input may include various types of external inputs such as a part of a user's body, a pen PN, light, heat, and/or pressure.

The electronic device 1000 may include a first display panel DP1 and a second display panel DP2. The first display panel DP1 and the second display panel DP2 may be separate panels separated from each other. The first display panel DP1 may be referred to as a main display panel, and the second display panel DP2 may be referred to as an auxiliary display panel or an external display panel.

The first display panel DP1 may include a first display part DA1-F, and the second display panel DP2 may include a second display part DA2-F. The area of the second display panel DP2 may be smaller than the area of the first display panel DP1. In correspondence to the sizes of the first display panel DP1 and the second display panel DP2, the area of the first display part DA1-F may be greater than the area of the second display part DA2-F.

In an unfolded state of the electronic device 1000, the first display part DA1-F may have a plane substantially parallel to a first direction DR1 and a second direction DR2. The thickness direction of the electronic device 1000 may be parallel to a third direction DR3 that crosses the first direction DR1 and the second direction DR2. Accordingly, front surfaces (or, upper surfaces) and rear surfaces (or, lower surfaces) of members constituting the electronic device 1000 may be defined based on the third direction DR3.

The first display panel DP1 or the first display part DA1-F may include a folding area FA that is folded and unfolded and a plurality of non-folding areas NFA1 and NFA2 that are spaced (e.g., spaced apart) from each other with the folding area FA therebetween. The second display panel DP2 may overlap one of the plurality of non-folding areas NFA1 and NFA2. For example, the second display panel DP2 may overlap the first non-folding area NFA1.

The display direction of a first image IM1a displayed on the first display panel DP1 may be opposite to the display direction of a second image IM2a displayed on the second display panel DP2. For example, the first image IM1a may be displayed in the third direction DR3, and the second image IM2a may be displayed in a fourth direction DR4 opposite to the third direction DR3.

In one or more embodiments of the present disclosure, the folding area FA may be bent about a folding axis extending in a direction parallel to the long sides of the electronic device 1000, for example, in a direction parallel to the second direction DR2. The folding area FA has a suitable curvature (e.g., a predetermined curvature) and a suitable radius (e.g., a predetermined radius) of curvature in a folded state of the electronic device 1000. The electronic device 1000 may be folded in an in-folding manner such that the first non-folding area NFA1 and the second non-folding area NFA2 face each other and the first display part DA1-F is not exposed to the outside.

In one or more embodiments of the present disclosure, the electronic device 1000 may be folded in an out-folding manner such that the first display part DA1-F is exposed to the outside. In one or more embodiments of the present disclosure, the electronic device 1000 may be folded in an in-folding or out-folding manner in the unfolded state. However, the present disclosure is not limited thereto.

Although FIG. 1A illustrates an example that one folding area FA is defined (or, provided or included) in the electronic device 1000, the present disclosure is not limited thereto. For example, a plurality of folding axes and a plurality of folding areas corresponding thereto may be defined in the electronic device 1000, and in the unfolded state, the electronic device 1000 may be folded in an in-folding or out-folding manner in each of the plurality of folding areas.

According to one or more embodiments of the present disclosure, at least one of the first display panel DP1 and the second display panel DP2 may sense an input by the pen PN without a digitizer. Because the digitizer for sensing the pen PN is omitted, an increase in the thickness and weight of the electronic device 1000 and a decrease in the flexibility of the electronic device 1000 depending on the addition of the digitizer may not occur. Accordingly, not only the first display panel DP1 but also the second display panel DP2 may be designed to sense the pen PN.

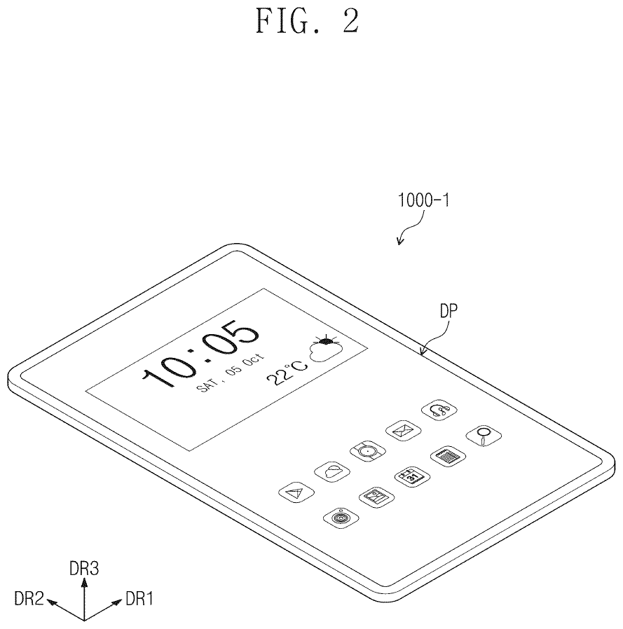

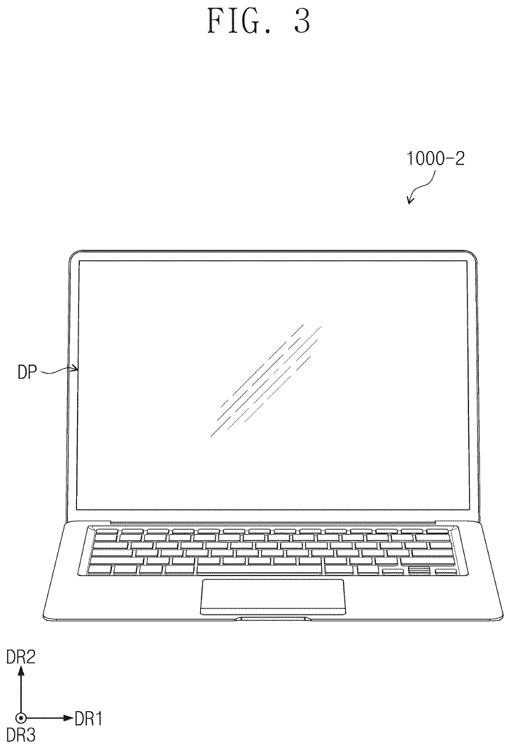

FIG. 2 is a perspective view of an electronic device 1000-1 according to one or more embodiments of the present disclosure. FIG. 3 is a perspective view of an electronic device 1000-2 according to one or more embodiments of the present disclosure.

FIG. 2 illustrates an example that the electronic device 1000-1 is a bar-type electronic device, for example, a mobile phone or a tablet computer, and the electronic device 1000-1 may include a display panel DP. FIG. 3 illustrates an example that the electronic device 1000-2 is a notebook computer, and the electronic device 1000-2 may include the display panel DP. Although FIG. 3 is a perspective view of the electronic device 1000-2, the coordinate axes included in FIG. 3 are displayed based on the display panel DP in the electronic device 1000-2.

In one or more embodiments of the present disclosure, the display panel DP may sense an input applied from the outside. The external input may be a user input. The user input may include various types of external inputs such as a part of the user's body, the pen PN (refer to FIG. 1A), light, heat, and/or pressure.

According to one or more embodiments of the present disclosure, the display panel DP may sense an input by the pen PN without a digitizer. Because the digitizer for sensing the pen PN is omitted, an increase in the thickness and weight of the electronic device 1000-1 or 1000-2 depending on the addition of the digitizer may not occur.

Although the foldable electronic device 1000 is illustrated in FIG. 1A and the bar-type electronic device 1000-1 is illustrated in FIG. 2, the present disclosure to be described below is not limited thereto. For example, the following descriptions may be applied to various electronic devices such as a rollable electronic device, a slidable electronic device, and/or a stretchable electronic device.

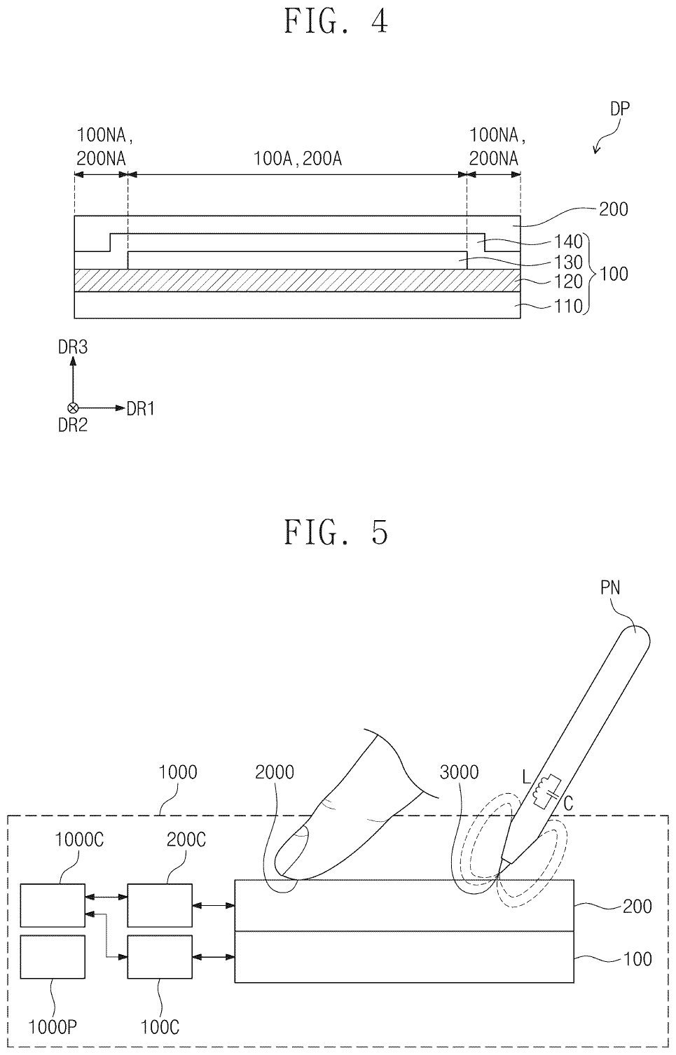

FIG. 4 is a schematic sectional view of the display panel DP according to one or more embodiments of the present disclosure.

Referring to FIG. 4, the display panel DP may include a display layer 100 and a sensor layer 200.

The display layer 100 may be a component that substantially generates an image. A display area 100A and a non-display area 100NA adjacent to the display area 100A may be defined in the display layer 100. An image may be displayed on the display area 100A.

The display layer 100 may be an emissive display layer. For example, the display layer 100 may be an organic light emitting display layer, an inorganic light emitting display layer, an organic-inorganic light emitting display layer, a quantum-dot display layer, a micro-LED display layer, and/or a nano-LED display layer. The display layer 100 may include a base layer 110, a circuit layer 120, a light emitting element layer 130, and an encapsulation layer 140.

The base layer 110 may be a member that provides a base surface on which the circuit layer 120 is disposed. The base layer 110 may have a multi-layer structure or a single-layer structure. The base layer 110 may be a glass substrate, a metal substrate, a silicon substrate, and/or a polymer substrate, but is not particularly limited thereto.

The circuit layer 120 may be disposed on the base layer 110. The circuit layer 120 may include an insulating layer, a semiconductor pattern, a conductive pattern, and/or a signal line. An insulating layer, a semiconductor layer, and/or a conductive layer may be formed on the base layer 110 through a process such as coating and/or deposition. The insulating layer, the semiconductor layer, and the conductive layer may be selectively subjected to patterning by performing a photolithography process a plurality of times.

The light emitting element layer 130 may be disposed on the circuit layer 120. The light emitting element layer 130 may include a light emitting element. For example, the light emitting element layer 130 may include an organic luminescent material, an inorganic luminescent material, an organic-inorganic luminescent material, a quantum dot, a quantum rod, a micro LED, and/or a nano LED.

The encapsulation layer 140 may be disposed on the light emitting element layer 130. The encapsulation layer 140 may protect the light emitting element layer 130 from foreign matter such as moisture, oxygen, and/or dust particles.

The sensor layer 200 may be disposed on the display layer 100. A sensing area 200A and a peripheral area 200NA adjacent to the sensing area 200A may be defined in the sensor layer 200. The sensing area 200A may overlap the display area 100A, and the peripheral area 200NA may overlap the non-display area 100NA.

Although FIG. 4 illustrates an example that the area of the sensing area 200A is substantially the same as the area of the display area 100A, the present disclosure is not limited thereto. For example, the area of the sensing area 200A may be greater than the area of the display area 100A. Accordingly, a portion of the sensing area 200A may overlap the non-display area 100NA. In this case, even though an input occurs adjacent to the boundary between the display area 100A and the non-display area 100NA, the sensor layer 200 may sufficiently recognize a signal because the sensing area 200A overlaps a portion of the non-display area 100NA.

The sensor layer 200 may sense an external input applied from the outside. The sensor layer 200 may be an integrated sensor continuously formed in a process of manufacturing the display layer 100. Alternatively, the sensor layer 200 may be an external sensor attached to the display layer 100. The sensor layer 200 may be referred to as a sensor, an input sensing layer, an input sensing panel, and/or an electronic device for sensing input coordinates.

According to one or more embodiments of the present disclosure, the sensor layer 200 may sense both an input by a passive input means such as a part of the user's body and an input by an input device that generates a magnetic field having a suitable resonant frequency (e.g., a predetermined resonant frequency). The input device may be referred to as a pen, an input pen, a magnetic pen, a stylus pen, and/or an electromagnetic resonance pen.

FIG. 5 is a view for explaining an operation of the electronic device 1000 according to one or more embodiments of the present disclosure.

Referring to FIG. 5, the electronic device 1000 may include the display layer 100, the sensor layer 200, a display driver 100C, a sensor driver 200C, a main driver 1000C, and a power circuit 1000P.

The sensor layer 200 may sense a first input 2000 or a second input 3000 applied from the outside. Each of the first input 2000 and the second input 3000 may be an input by an input means capable of changing the capacitance of the sensor layer 200 or an input by an input means capable of causing an induced current in the sensor layer 200. For example, the first input 2000 may be an input by a passive input means such as a part of the user's body. The second input 3000 may be an input by the pen PN or an input by a radio frequency integrated circuit (RFIC) tag. For example, the pen PN may be a pen of a passive type or a pen of an active type.

In one or more embodiments of the present disclosure, the pen PN may be a device that generates a magnetic field having a suitable resonant frequency (e.g., a predetermined resonant frequency). The pen PN may transmit an output signal based on an electromagnetic resonance scheme. The pen PN may be referred to as an input device, an input pen, a magnetic pen, a stylus pen, and/or an electromagnetic resonance pen.

The pen PN may include an RLC resonance circuit, and the RLC resonance circuit may include at least an inductor L and a capacitor C. In one or more embodiments of the present disclosure, the RLC resonance circuit may be a variable resonance circuit that varies the resonant frequency. In this case, the inductor L may be a variable inductor, and/or the capacitor C may be a variable capacitor. However, the present disclosure is not particularly limited thereto.

The inductor L generates a current by a magnetic field formed in the electronic device 1000, for example, the sensor layer 200. However, the present disclosure is not particularly limited thereto. For example, when the pen PN operates in an active type, the pen PN may generate a current even though a magnetic field is not provided from the outside. The generated current is transferred to the capacitor C. The capacitor C charges the current input from the inductor L and discharges the charged current to the inductor L. Thereafter, the inductor L may emit a magnetic field having a resonant frequency. An induced current may flow in the sensor layer 200 by the magnetic field emitted from the pen PN. The induced current may be transferred to the sensor driver 200C as a reception signal (e.g., a sensing signal or a signal).

The main driver 1000C may control overall operation of the electronic device 1000. For example, the main driver 1000C may control operations of the display driver 100C and the sensor driver 200C. The main driver 1000C may include at least one microprocessor and may further include a graphic controller. The main driver 1000C may be referred to as an application processor, a central processing unit, and/or a main processor.

The display driver 100C may drive the display layer 100. The display driver 100C may receive image data and a control signal from the main driver 1000C. The control signal may include various signals. For example, the control signal may include an input vertical synchronization signal, an input horizontal synchronization signal, a main clock signal, and/or a data enable signal.

The sensor driver 200C may drive the sensor layer 200. The sensor driver 200C may receive a control signal from the main driver 1000C. The control signal may include a clock signal of the sensor driver 200C. In addition, the control signal may further include a mode determination signal for determining an operation mode of the sensor driver 200C and the sensor layer 200.

The sensor driver 200C may be implemented with an integrated circuit (IC) and may be electrically connected with the sensor layer 200. For example, the sensor driver 200C may be directly mounted on a suitable area (e.g., a predetermined area) of the display panel. Alternatively, the sensor driver 200C may be mounted on a separate printed circuit board (PCB) using a chip on film (COF) method and may be electrically connected with the sensor layer 200.

The sensor driver 200C and the sensor layer 200 may selectively operate in a first mode or a second mode. For example, the first mode may be a mode for sensing a touch input, for example, the first input 2000. The second mode may be a mode for sensing an input by the pen PN, for example, the second input 3000. The first mode may be referred to as a touch sensing mode, and the second mode may be referred to as a pen sensing mode.

Switching between the first mode and the second mode may be performed in various ways. For example, the sensor driver 200C and the sensor layer 200 may be driven in the first mode and the second mode in a time-division manner and may sense the first input 2000 and the second input 3000. Alternatively, the switching between the first mode and the second mode may be performed by the user's selection or the user's specific action (or, input). In another case, by activation or deactivation of a specific application, one of the first mode or the second mode may be activated or deactivated, or the operation mode may be switched from one mode to the other mode. In yet another case, when the first input 2000 is sensed while the sensor driver 200C and the sensor layer 200 alternately operate in the first mode and the second mode, the sensor driver 200C and the sensor layer 200 may be maintained in the first mode, and when the second input 3000 is sensed, the sensor driver 200C and the sensor layer 200 may be maintained in the second mode.

The sensor driver 200C may calculate coordinate information of an input based on a signal received from the sensor layer 200 and may provide a coordinate signal having the coordinate information to the main driver 1000C. The main driver 1000C executes an operation corresponding to the user input, based on the coordinate signal. For example, the main driver 1000C may operate the display driver 100C such that a new application image is displayed on the display layer 100.

The power circuit 1000P may include a power management integrated circuit (PMIC). The power circuit 1000P may generate a plurality of drive voltages for driving the display layer 100, the sensor layer 200, the display driver 100C, the sensor driver 200C, and/or the main driver 1000C. For example, the plurality of drive voltages may include a gate high-voltage, a gate low-voltage, a first drive voltage (e.g., an ELVSS voltage), a second drive voltage (e.g., an ELVDD voltage), and an initialization voltage, but are not particularly limited to the examples.

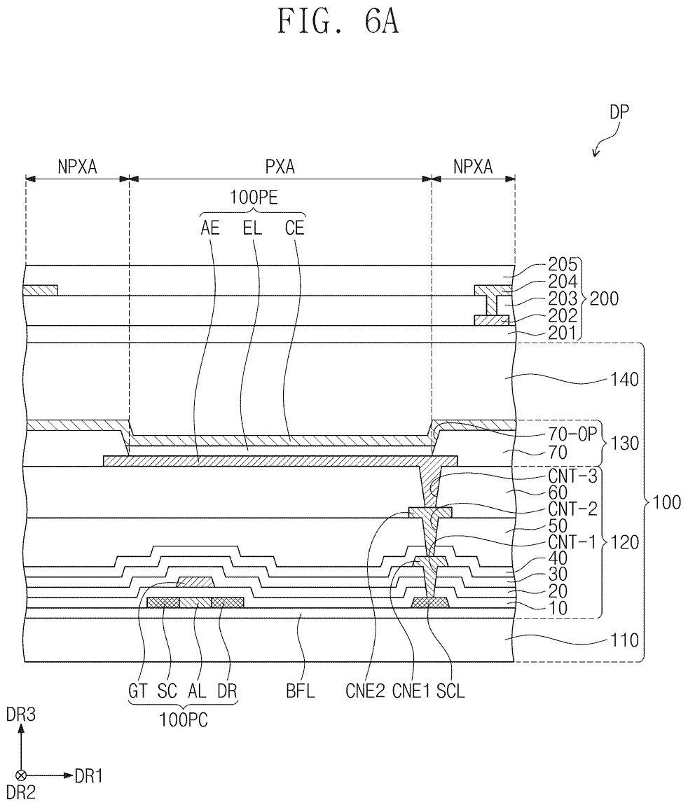

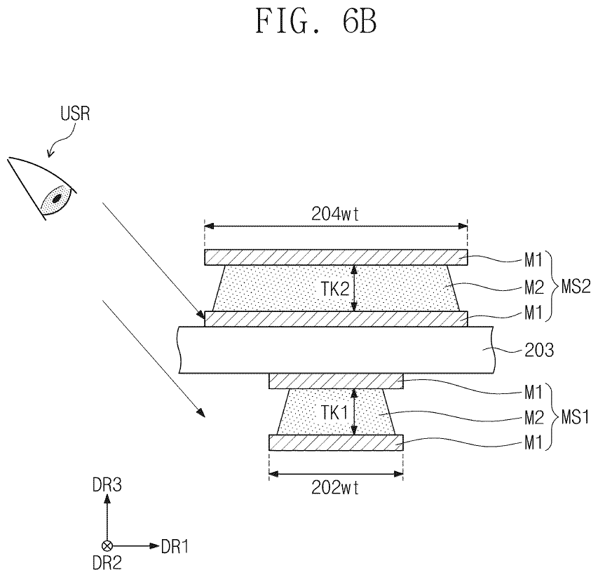

FIG. 6A is a sectional view of the display panel DP according to one or more embodiments of the present disclosure.

Referring to FIG. 6A, at least one buffer layer BFL is formed on the upper surface of the base layer 110. The buffer layer BFL may improve the coupling force between the base layer 110 and a semiconductor pattern. The buffer layer BFL may be formed of multiple layers. Alternatively, the display layer 100 may further include a barrier layer. The buffer layer BFL may include at least one of silicon oxide, silicon nitride, or silicon oxy nitride. For example, the buffer layer BFL may include a structure in which silicon oxide layers and silicon nitride layers are alternately stacked one above another.

The semiconductor pattern SC, AL, DR, and SCL may be disposed on the buffer layer BFL. The semiconductor pattern SC, AL, DR, and SCL may include poly silicon. However, without being limited thereto, the semiconductor pattern SC, AL, DR, and SCL may include amorphous silicon, low-temperature polycrystalline silicon, and/or an oxide semiconductor.

FIG. 6A illustrates only a portion of the semiconductor pattern SC, AL, DR, and SCL, and the semiconductor pattern may be additionally disposed in other areas. The semiconductor pattern SC, AL, DR, and SCL may be arranged according to a specific rule across pixels. The semiconductor pattern SC, AL, DR, and SCL may have different electrical properties depending on whether doping is performed or not. The semiconductor pattern SC, AL, DR, and SCL may include first areas SC, DR, and SCL having a high conductivity and a second area AL having a low conductivity. The first areas SC, DR, and SCL may be doped with an N-type dopant or a P-type dopant. A P-type transistor may include a doped area doped with a P-type dopant, and an N-type transistor may include a doped area doped with an N-type dopant. The second area AL may be a non-doped area or may be an area more lightly doped than the first areas SC, DR, and SCL.

The first areas SC, DR, and SCL may have a higher conductivity than the second area AL and may substantially serve as electrodes or signal lines. The second area AL may substantially correspond to an active area AL (or, a channel) of a transistor 100PC. In other words, one portion AL of the semiconductor pattern SC, AL, DR, and SCL may be the active area AL of the transistor 100PC, another portion SC or DR may be a source area SC or a drain area DR of the transistor 100PC, and the other portion SCL may be a connecting electrode or a connecting signal line SCL.

Each of the pixels may have an equivalent circuit including a plurality of transistors, at least one capacitor, and at least one light emitting element, and the equivalent circuit of the pixel may be modified in various forms. In FIG. 6A, one transistor 100PC and one light emitting element 100PE included in the pixel are illustrated.

The source area SC, the active area AL, and the drain area DR of the transistor 100PC may be formed from the semiconductor pattern SC, AL, DR, and SCL. The source area SC and the drain area DR may extend from the active area AL in opposite directions on the cross-section. In FIG. 6A, a portion of the connecting signal line SCL formed from the semiconductor pattern SC, AL, DR, and SCL is illustrated. In one or more embodiments, the connecting signal line SCL may be connected to the drain area DR of the transistor 100PC when viewed from above the plane (e.g., in a plan view).

A first insulating layer 10 may be disposed on the buffer layer BFL. The first insulating layer 10 may commonly overlap the plurality of pixels and may cover the semiconductor pattern SC, AL, DR, and SCL. The first insulating layer 10 may be an inorganic layer and/or an organic layer and may have a single-layer structure or a multi-layer structure. The first insulating layer 10 may include aluminum oxide, titanium oxide, silicon oxide, silicon nitride, silicon oxy nitride, zirconium oxide, and/or hafnium oxide. In this embodiment, the first insulating layer 10 may be a single silicon oxide layer. Not only the first insulating layer 10 but also insulating layers of the circuit layer 120 to be described below may be inorganic layers and/or organic layers and may have a single-layer structure or a multi-layer structure. The inorganic layers may include at least one of the aforementioned materials, but are not limited thereto.

A gate GT of the transistor 100PC is disposed on the first insulating layer 10. The gate GT may be a portion of a metal pattern. The gate GT overlaps the active area AL. The gate GT may function as a mask in a process of doping or reducing the semiconductor pattern SC, AL, DR, and SCL.

A second insulating layer 20 may be disposed on the first insulating layer 10 and may cover the gate GT. The second insulating layer 20 may commonly overlap the pixels. The second insulating layer 20 may be an inorganic layer and/or an organic layer and may have a single-layer structure or a multi-layer structure. The second insulating layer 20 may include silicon oxide, silicon nitride, and/or silicon oxy nitride. In this embodiment, the second insulating layer 20 may have a multi-layer structure including a silicon oxide layer and a silicon nitride layer.

A third insulating layer 30 may be disposed on the second insulating layer 20. The third insulating layer 30 may have a single-layer structure or a multi-layer structure. For example, the third insulating layer 30 may have a multi-layer structure including a silicon oxide layer and a silicon nitride layer.

A first connecting electrode CNE1 may be disposed on the third insulating layer 30. The first connecting electrode CNE1 may be connected to the connecting signal line SCL through a contact hole CNT-1 that penetrates the first insulating layer 10, the second insulating layer 20, and the third insulating layer 30.

A fourth insulating layer 40 may be disposed on the third insulating layer 30 and may cover the first connecting electrode CNE1. The fourth insulating layer 40 may be a single silicon oxide layer. A fifth insulating layer 50 may be disposed on the fourth insulating layer 40. The fifth insulating layer 50 may be an organic layer.

A second connecting electrode CNE2 may be disposed on the fifth insulating layer 50. The second connecting electrode CNE2 may be connected to the first connecting electrode CNE1 through a contact hole CNT-2 that penetrates the fourth insulating layer 40 and the fifth insulating layer 50.

A sixth insulating layer 60 may be disposed on the fifth insulating layer 50 and may cover the second connecting electrode CNE2. The sixth insulating layer 60 may be an organic layer.

The light emitting element layer 130 may be disposed on the circuit layer 120. The light emitting element layer 130 may include the light emitting element 100PE. For example, the light emitting element layer 130 may include an organic luminescent material, an inorganic luminescent material, an organic-inorganic luminescent material, a quantum dot, a quantum rod, a micro LED, or a nano LED. Hereinafter, it will be exemplified that the light emitting element 100PE is an organic light emitting element. However, the present disclosure is not particularly limited thereto.

The light emitting element 100PE may include a first electrode AE, an emissive layer EL, and a second electrode CE.

The first electrode AE may be disposed on the sixth insulating layer 60. The first electrode AE may be connected to the second connecting electrode CNE2 through a contact hole CNT-3 that penetrates the sixth insulating layer 60.

A pixel defining layer 70 may be disposed on the sixth insulating layer 60 and may cover a portion of the first electrode AE. The pixel defining layer 70 has an opening 70-OP defined therein. The opening 70-OP of the pixel defining layer 70 exposes at least a portion of the first electrode AE.

The first display part DA1-F (refer to FIG. 1A) may include an emissive area PXA and a non-emissive area NPXA adjacent to the emissive area PXA. The non-emissive area NPXA may be around (e.g., may surround) the emissive area PXA. In this embodiment, the emissive area PXA is defined to correspond to a partial area of the first electrode AE exposed through the opening 70-OP.

The emissive layer EL may be disposed on the first electrode AE. The emissive layer EL may be disposed in an area corresponding to the opening 70-OP. Although FIG. 6A illustrates an example that the emissive layer EL is disposed in the opening 70-OP, the present disclosure is not particularly limited thereto. For example, in one or more embodiments, the emissive layer EL may extend to cover the side surface of the pixel defining layer 70 that defines the opening 70-OP and a portion of the upper surface of the pixel defining layer 70.

In one or more embodiments of the present disclosure, the emissive layer EL may be separately formed in each of the pixels. When the emissive layer EL is separately formed in each of the pixels, each of the emissive layers EL may emit at least one of blue light, red light, or green light. However, without being limited thereto, the emissive layer EL may have a one-body shape and may be commonly included in the plurality of pixels. In this case, the emissive layer EL may provide blue light or white light.

The second electrode CE may be disposed on the emissive layer EL. The second electrode CE may have a one-body shape and may be commonly included in the plurality of pixels.

In one or more embodiments of the present disclosure, a hole control layer may be disposed between the first electrode AE and the emissive layer EL. The hole control layer may be commonly disposed in the emissive area PXA and the non-emissive area NPXA. The hole control layer may include a hole transport layer and may further include a hole injection layer. An electron control layer may be disposed between the emissive layer EL and the second electrode CE. The electron control layer may include an electron transport layer and may further include an electron injection layer. The hole control layer and the electron control layer may be commonly formed in the plurality of pixels using an open mask or an ink-jet process.

The encapsulation layer 140 may be disposed on the light emitting element layer 130. The encapsulation layer 140 may include an inorganic layer, an organic layer, and an inorganic layer sequentially stacked one above another. However, layers constituting the encapsulation layer 140 are not limited thereto. The inorganic layers may protect the light emitting element layer 130 from moisture and/or oxygen, and the organic layer may protect the light emitting element layer 130 from foreign matter such as dust particles. The inorganic layers may include a silicon nitride layer, a silicon oxy nitride layer, a silicon oxide layer, a titanium oxide layer, and/or an aluminum oxide layer. The organic layer may include an acrylic organic layer, but is not limited thereto.

The sensor layer 200 may include a base layer 201, a first conductive layer 202, a first insulating layer 203, a second conductive layer 204, and a second insulating layer 205.

The base layer 201 may be an inorganic layer including at least one of silicon nitride, silicon oxy nitride, or silicon oxide. Alternatively, the base layer 201 may be an organic layer including an epoxy resin, an acrylic resin, or an imide-based resin. The base layer 201 may have a single-layer structure or may have a multi-layer structure stacked in the third direction DR3. In one or more embodiments of the present disclosure, the sensor layer 200 may not include the base layer 201.

Each of the first conductive layer 202 and the second conductive layer 204 may have a single-layer structure or may have a multi-layer structure stacked in the third direction DR3.

Each of the first conductive layer 202 and the second conductive layer 204 that have a single-layer structure may include a metal layer or a transparent conductive layer. The metal layer may include molybdenum, silver, titanium, copper, aluminum, and/or an alloy thereof. The transparent conductive layer may include transparent conductive oxide such as indium tin oxide (ITO), indium zinc oxide (IZO), zinc oxide (ZnO), and/or indium zinc tin oxide (IZTO). In addition, the transparent conductive layer may include a conductive polymer such as poly(3,4-ethylenedioxythiophene) (PEDOT), a metal nano wire, and/or graphene.

Each of the first conductive layer 202 and the second conductive layer 204 that have a multi-layer structure may include metal layers. The meal layers may have, for example, a three-layer structure of titanium/aluminum/titanium. The conductive layer having the multi-layer structure may include at least one metal layer and at least one transparent conductive layer.

In one or more embodiments of the present disclosure, the thickness of the first conductive layer 202 may be greater than or equal to the thickness of the second conductive layer 204. When the thickness of the first conductive layer 202 is greater than the thickness of the second conductive layer 204, the resistance of a component (e.g., an electrode, a pattern, and/or a bridge pattern) included in the first conductive layer 202 may be decreased. In addition, because the first conductive layer 202 is disposed below the second conductive layer 204, the probability that components included in the first conductive layer 202 will be visually recognized due to the reflection of external light may be lower than that of the second conductive layer 204 even though the thickness of the first conductive layer 202 is increased.

At least one of the first insulating layer 203 or the second insulating layer 205 may include an inorganic film. The inorganic film may include aluminum oxide, titanium oxide, silicon oxide, silicon nitride, silicon oxy nitride, zirconium oxide, and/or hafnium oxide.

At least one of the first insulating layer 203 or the second insulating layer 205 may include an organic film. The organic film may include an acrylic resin, a methacrylic resin, a polyisoprene resin, a vinyl resin, an epoxy resin, a urethane-based resin, a celluosic resin, a siloxane-based resin, a polyimide resin, a polyamide resin, and/or a perylene-based resin.

Although it has been described that the sensor layer 200 includes the first conductive layer 202 and the second conductive layer 204, that is, a total of two conductive layers, the present disclosure is not particularly limited thereto. For example, the sensor layer 200 may include three or more conductive layers.

FIG. 6B is a sectional view illustrating some components of the sensor layer 200 (refer to FIG. 6A) according to one or more embodiments of the present disclosure.

Referring to FIGS. 6A and 6B, the second width 204wt of a second mesh line MS2 included in the second conductive layer 204 may be greater than or equal to the first width 202wt of a first mesh line MS1 included in the first conductive layer 202. When a user USR looks at the first mesh line MS1 and the second mesh line MS2 from the side, the probability that the first mesh line MS1 will be visually recognized by the user USR may be reduced because the first mesh line MS1 has a smaller width than the second mesh line MS2.

Each of the first mesh line MS1 and the second mesh line MS2 may include first metal layers M1 and a second metal layer M2 disposed between the first metal layers M1. For example, the first metal layers M1 may include titanium (Ti), and the second metal layer M2 may include aluminum (Al). However, this is only an example, and the present disclosure is not particularly limited thereto.

In one or more embodiments of the present disclosure, the first thickness TK1 of the second metal layer M2 of the first mesh line MS1 and the second thickness TK2 of the second metal layer M2 of the second mesh line MS2 may be substantially the same as each other, but are not particularly limited thereto. For example, the first thickness TK1 may be greater than the second thickness TK2. Alternatively, the second thickness TK2 may be greater than the first thickness TK1. In one or more embodiments of the present disclosure, each of the first thickness TK1 and the second thickness TK2 may be 1000 angstroms or more, for example, 6000 angstroms.

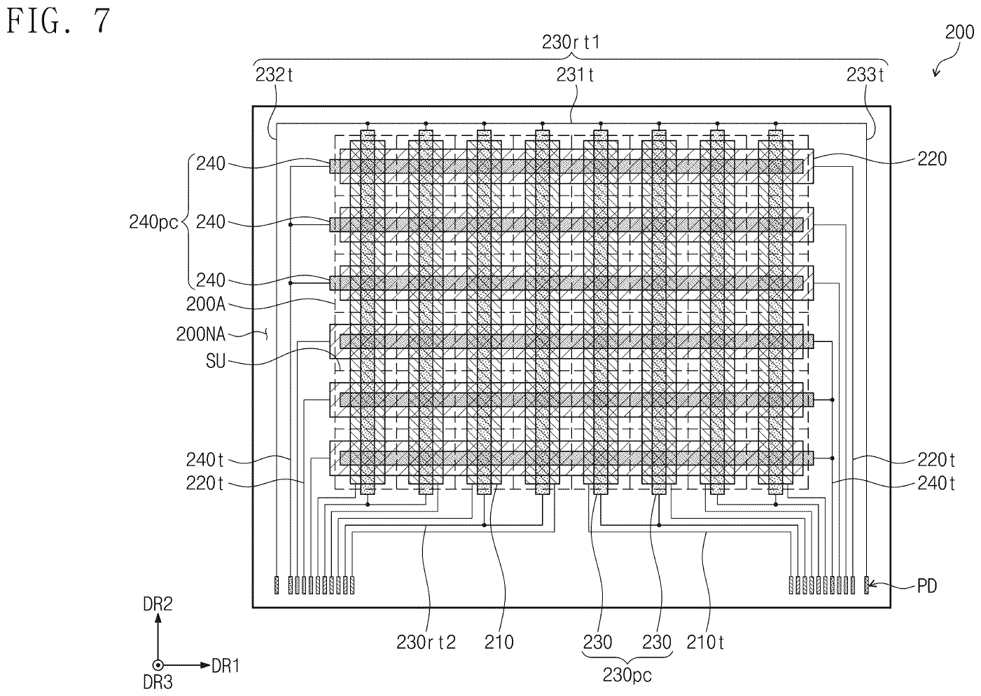

FIG. 7 is a plan view of the sensor layer 200 according to one or more embodiments of the present disclosure.

Referring to FIG. 7, the sensing area 200A and the peripheral area 200NA adjacent to the sensing area 200A may be defined in the sensor layer 200.

The sensor layer 200 may include a plurality of first electrodes 210, a plurality of second electrodes 220, a plurality of third electrodes 230, and a plurality of fourth electrodes 240 disposed in the sensing area 200A.

Each of the first electrodes 210 may cross the second electrodes 220. Each of the first electrodes 210 may extend in the second direction DR2, and the first electrodes 210 may be spaced (e.g., spaced apart) from one another along the first direction DR1. Each of the second electrodes 220 may extend in the first direction DR1, and the second electrodes 220 may be spaced (e.g., spaced apart) from one another along the second direction DR2.

The sensing area 200A may include a plurality of sensing units SU arranged along the first direction DR1 and the second direction DR2. One sensing unit SU may include an area where one first electrode 210 and one second electrode 220 cross each other. In FIG. 7, eight first electrodes 210 and six second electrodes 220 are illustrated as an example, and 48 sensing units SU are illustrated as an example. However, the number of first electrodes 210 and the number of second electrodes 220 are not limited thereto.

Each of the third electrodes 230 may extend in the second direction DR2, and the third electrodes 230 may be spaced (e.g., spaced apart) from one another along the first direction DR1. One third electrode 230 may overlap at least a portion of one first electrode 210. According to one or more embodiments of the present disclosure, the capacitance (or, the coupling capacitance) between one first electrode 210 and one third electrode 230 may be adjusted by adjusting the overlapping area between the one first electrode 210 and the one third electrode 230.

In one or more embodiments of the present disclosure, at least some of the third electrodes 230 may be connected in parallel. For example, FIG. 7 illustrates an example that two third electrodes 230 are connected with each other in parallel to form a first electrode group 230pc, and four first electrode groups 230pc may be arranged along the first direction DR1. However, the number of third electrodes 230 constituting the first electrode group 230pc is not limited thereto. For example, one first electrode group 230pc may include only one third electrode 230 or may include three or more third electrodes 230.

As the number of third electrodes 230 included in the first electrode group 230pc and connected in parallel is increased, the resistance of the first electrode group 230pc may be lowered, and thus power efficiency and sensing sensitivity may be improved. In contrast, as the number of third electrodes 230 included in the first electrode group 230pc is decreased, a loop coil pattern formed using the first electrode group 230pc may be implemented in more various forms.

The fourth electrodes 240 may be arranged in the second direction DR2. The fourth electrodes 240 may extend in the first direction DR1. One fourth electrode 240 may at least partially overlap one second electrode 220. According to one or more embodiments of the present disclosure, the capacitance (or, the coupling capacitance) between one second electrode 220 and one fourth electrode 240 may be adjusted by adjusting the overlapping area between the one second electrode 220 and the one fourth electrode 240.

In one or more embodiments of the present disclosure, at least some of the fourth electrodes 240 may be electrically connected to form one second electrode group 240pc. For example, FIG. 7 illustrates an example that three fourth electrodes 240 are connected to the same trace line, for example, a group trace line 240t to form one second electrode group 240pc. Accordingly, in FIG. 7, two second electrode groups 240pc are illustrated as being arranged along the second direction DR2. However, the number of fourth electrodes 240 constituting one second electrode group 240pc is not limited thereto. For example, the number of fourth electrodes 240 constituting one second electrode group 240pc may be 6, and in this case, the sensor layer 200 may include only the one second electrode group 240pc.

The sensor layer 200 may further include a plurality of first trace lines 210t and a plurality of second trace lines 220t disposed in the peripheral area 200NA. The first trace lines 210t may be electrically connected to the first electrodes 210 in a one-to-one correspondence. The second trace lines 220t may be electrically connected to the second electrodes 220 in a one-to-one correspondence. In one or more embodiments of the present disclosure, at least some of the first trace lines 210t and at least some of the second trace lines 220t may overlap the display area 100A (refer to FIG. 4) of the display layer 100 (refer to FIG. 4).

The sensor layer 200 may further include a first loop trace line 230rt1, the group trace lines 240t, and second loop trace lines 230rt2 disposed in the peripheral area 200NA.

The first loop trace line 230rt1 may be electrically connected with the third electrodes 230. In one or more embodiments of the present disclosure, the first loop trace line 230rt1 may be electrically connected with all of the third electrodes 230. The first loop trace line 230rt1 may include a first line portion 231t that extends in the first direction DR1 and that is electrically connected to the third electrodes 230, a second line portion 232t that extends from a first end of the first line portion 231t in the second direction DR2, and a third line portion 233t that extends from a second end of the first line portion 231t in the second direction DR2.

In one or more embodiments of the present disclosure, each of the resistance of the second line portion 232t and the resistance of the third line portion 233t may be substantially the same as the resistance of one first electrode group from among the first electrode groups 230pc. Accordingly, each of the second line portion 232t and the third line portion 233t may serve as the first electrode group 230pc, and the same effect as placing the third electrodes 230 in the peripheral area 200NA may be obtained. For example, one of the second line portion 232t or the third line portion 233t and one of the third electrodes 230 may form a coil. Accordingly, the pen located in an area adjacent to the peripheral area 200NA may also be sufficiently charged by a loop including the second line portion 232t or the third line portion 233t.

In one or more embodiments of the present disclosure, the widths of the second line portion 232t and the third line portion 233t in the first direction DR1 may be adjusted to adjust the resistance of the second line portion 232t and the resistance of the third line portion 233t. However, this is only an example, and the first to third line portions 231t, 232t, and 233t may have substantially the same width.

The second loop trace lines 230rt2 may be connected to the first electrode groups 230pc in a one-to-one correspondence. That is, the number of second loop trace lines 230rt2 may correspond to the number of first electrode groups 230pc. In FIG. 7, four second loop trace lines 230rt2 and four first electrode groups 230pc are illustrated as an example.

In one or more embodiments of the present disclosure, the second loop trace lines 230rt2 may be omitted, and a charging operation mode for charging the pen may be omitted. In this case, the sensor layer 200 may sense an input by an active pen capable of emitting a magnetic field even though a magnetic field is not provided from the sensor layer 200.

The group trace lines 240t may be spaced (e.g., spaced apart) from each other with the sensing area 200A therebetween. The group trace lines 240t may be electrically connected to the second electrode groups 240pc in a one-to-one correspondence. FIG. 7 illustrates an example that two second electrode groups 240pc are arranged. The group trace line 240t connected to one second electrode group 240pc and the group trace line 240t connected to the other second electrode group 240pc may be spaced (e.g., spaced apart) from each other with the sensing area 200A therebetween. However, the present disclosure is not particularly limited thereto. The group trace lines 240t may be referred to as trace lines.

The sensor layer 200 may include a plurality of pads PD disposed in the peripheral area 200NA. The pads PD may be spaced (e.g., spaced apart) from one another along the first direction DR1. Although FIG. 7 illustrates an example that the pads PD are arranged in one row along the first direction DR1, the present disclosure is not particularly limited thereto. For example, the pads PD may be arranged in a plurality of rows.

The pads PD may be electrically connected to the first trace lines 210t, the second trace lines 220t, one end and an opposite end of the first loop trace lines 230rt1, the second loop trace lines 230rt2, and the group trace lines 240t, which have been described above, in a one-to-one correspondence.

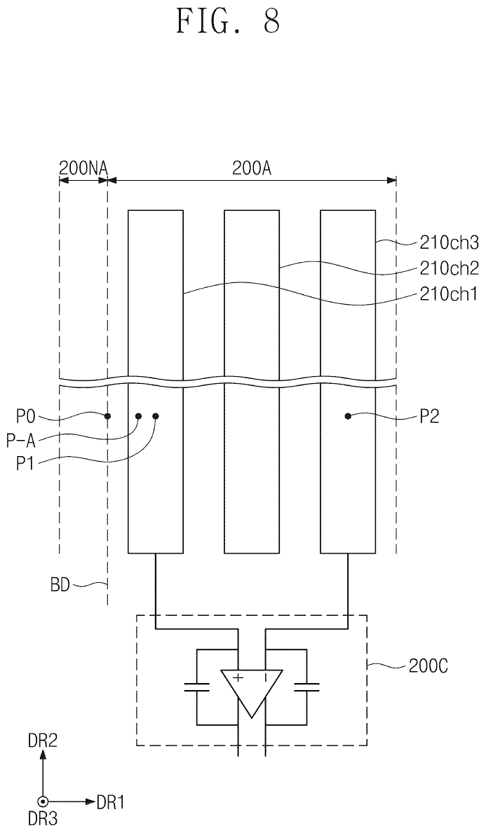

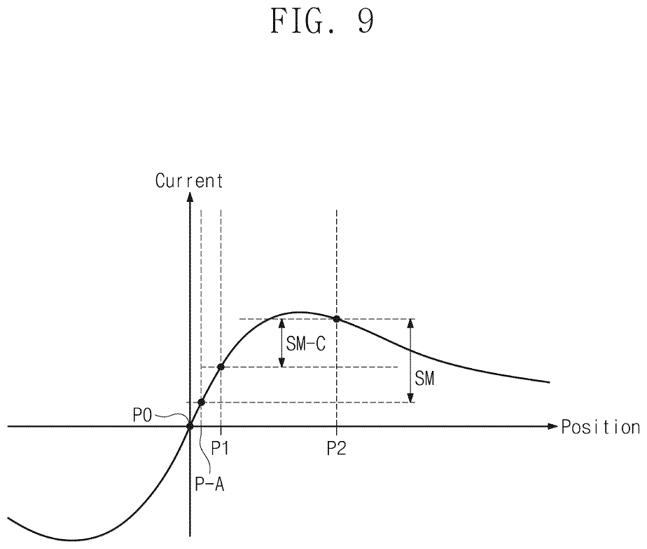

FIG. 8 is a schematic view illustrating operations of the sensor layer 200 (refer to FIG. 7) and the sensor driver 200C according to one or more embodiments of the present disclosure. FIG. 9 is a view illustrating an induced current generated by the pen PN (refer to FIG. 5).

Referring to FIGS. 7, 8, and 9, the sensor driver 200C may differentially sense channels adjacent to each other or channels spaced (e.g., spaced apart) from each other to sense a current induced by the pen PN. For example, to sense an X-axis coordinate parallel to the first direction DR1, the sensor driver 200C may differentially sense signals received from the first electrodes 210. To sense a Y-axis coordinate parallel to the second direction DR2, the sensor driver 200C may differentially sense signals received from the second electrodes 220.

The first electrodes 210 and the second electrodes 220 may be referred to as channels, respectively. The following description is based on the first electrodes 210 and may also be applied to the second electrodes 220. The signals may be induced currents induced by the pen PN. For example, an induced current corresponding to the position of a current path may be generated in each of the channels. Accordingly, when the position of the current path of the channel is adjusted, the intensity (or, magnitude) of the current may be varied.

In FIG. 8, three channels 210ch1, 210ch2, and 210ch3 adjacent to the boundary BD between the sensing area 200A and the peripheral area 200NA are illustrated as an example. The three channels 210ch1, 210ch2, and 210ch3 may correspond to three first electrodes 210. In one or more embodiments of the present disclosure, the sensor driver 200C may differentially sense signals received from the X^{th} channel and the (X+2)^{th} channel, but is not particularly limited thereto. X is a positive integer of 1 or more.

In FIGS. 8 and 9, the center P1 of the first channel 210ch1 and the center P2 of the third channel 210ch3 are illustrated. The center P1 of the first channel 210ch1 may be spaced (e.g., spaced apart) from the boundary BD between the sensing area 200A and the peripheral area 200NA by half the pitch between the first electrodes 210.

FIG. 9 is a graph depicting an induced current when the pen PN (refer to FIG. 5) is located at a first point P0 corresponding to the boundary BD. The direction of an induced current flowing to the channels located on the left side with respect to the position of the pen PN may be different from the direction of an induced current flowing to the channels located on the right side with respect to the position of the pen PN. The strength of a magnetic field may be proportional to a current. Accordingly, the Y-axis of the graph illustrated in FIG. 9 may represent the strength of a magnetic field.

When the pen PN is disposed to overlap the sensing area 200A, the sensor driver 200C may differentially sense induced currents received from the first electrodes 210 disposed on the opposite sides with respect to the position of the pen PN and may obtain absolute value data. For example, the maximum value of the absolute value data may be obtained by differentially sensing induced currents facing in different directions.

When the pen PN is located at the first point P0 or at a position adjacent to the first point P0, an electrode to sense an induced current is not disposed because the left side with respect to the pen PN corresponds to the peripheral area 200NA. Accordingly, the sensor driver 200C may sense the position of the pen PN by differentiating signals received from the channels 210ch1, 210ch2, and 210ch3 disposed on the right side with respect to the pen PN. Because the sensor driver 200C has to differentially sense induced currents provided from the pen using the first electrodes 210 disposed on one side with respect to the pen, the sensitivity may be decreased as compared with when the pen is disposed to overlap the sensing area 200A.

According to one or more embodiments of the present disclosure, the resistances or shapes of channels disposed adjacent to the peripheral area 200NA may be adjusted to improve the pen sensing sensitivity in an area adjacent to the peripheral area 200NA. For example, the current path of the first channel 210ch1 may be designed to move from the center P1 of the first channel 210ch1 to an adjustment point P-A of the first channel 210ch1.

The adjustment point P-A may be closer to the peripheral area 200NA than the center P1 of the first channel 210ch1. Accordingly, the sensor driver 200C may not receive an induced current corresponding to the center P1 of the first channel 210ch1, but may receive an induced current corresponding to the adjustment point P-A closer to the peripheral area 200NA than the center P1.

The adjustment point P-A of the first channel 210ch1 may be spaced (e.g., spaced apart) from the boundary BD between the sensing area 200A and the peripheral area 200NA by less than half the pitch between the first electrodes 210. A difference SM between the induced current corresponding to the adjustment point P-A of the first channel 210ch1 and the induced current received from the third channel 210ch3 may be greater than a difference SM-C between the induced current corresponding to the center P1 of the first channel 210ch1 and the induced current received from the third channel 210ch3. As the difference value increases, the pen sensitivity may be improved.

That is, according to one or more embodiments of the present disclosure, the resistance or shape of the first channel 210ch1 disposed adjacent to the peripheral area 200NA may be asymmetrically designed. For example, the current path of the first channel 210ch1 may be adjusted so as to be closer to the peripheral area 200NA than the center P1 of the first channel 210ch1. In this case, a difference between signals, for example, a difference in intensity between induced currents may be further increased during differential sensing, and thus the pen (PN) sensing sensitivity in an area adjacent to the peripheral area 200NA may be further improved.

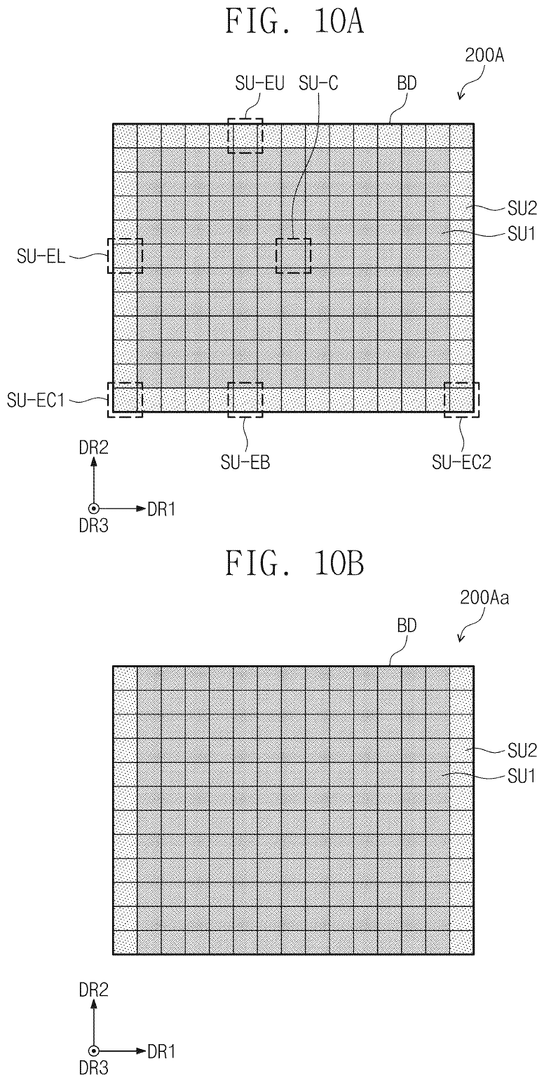

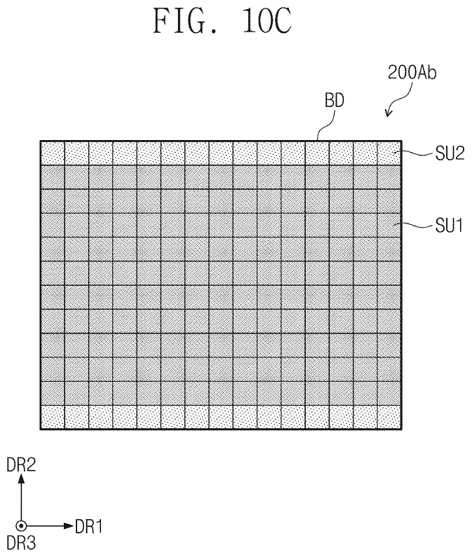

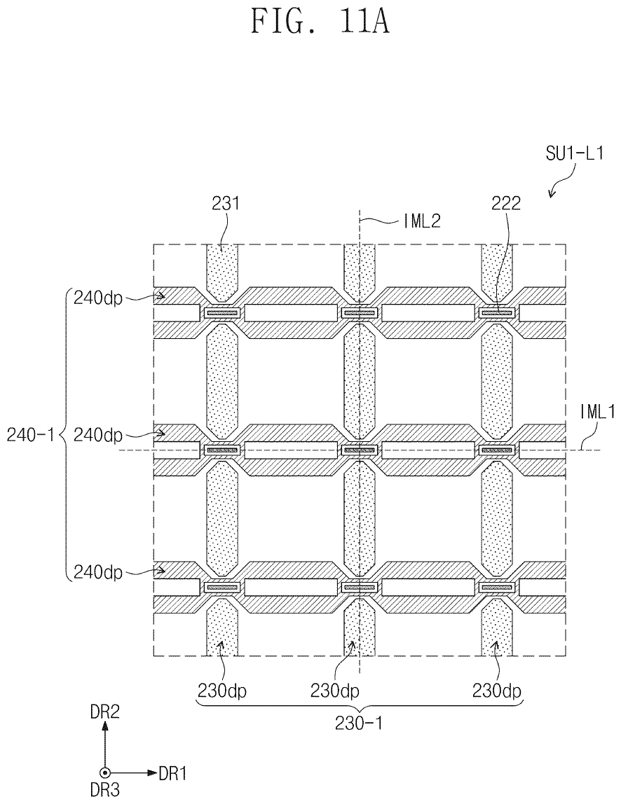

FIG. 10A is a plan view illustrating the sensing area 200A according to one or more embodiments of the present disclosure.

Referring to FIGS. 7 and 10A, the sensing area 200A may include a plurality of sensing units SU1 and SU2. The sensing units SU1 and SU2 may be arranged along the first direction DR1 and the second direction DR2. Each of the sensing units SU1 and SU2 may correspond to an area where one channel and another channel cross each other.

The sensing units SU1 and SU2 may include the first sensing units SU1 and the second sensing units SU2.

The first sensing units SU1 may include a reference sensing unit SU-C. Portions of electrodes included in the reference sensing unit SU-C may have symmetrical shapes with respect to a virtual line crossing the center of the first sensing unit SU1. The center of resistance of each of the first sensing units SU1 may be substantially the same as the center of the first sensing unit SU1. Accordingly, the current path of the first sensing unit SU1 may correspond to the center of the first sensing unit SU1.

The second sensing units SU2 may include a plurality of outer sensing units SU-EU, SU-EL, SU-EC1, SU-EC2, and SU-EB. Portions of electrodes included in each of the outer sensing units SU-EU, SU-EL, SU-EC1, SU-EC2, and SU-EB may have asymmetrical shapes. For example, each of the outer sensing units SU-EU, SU-EL, SU-EC1, SU-EC2, and SU-EB may be shaped differently from the reference sensing unit SU-C. Accordingly, the current paths of the second sensing units SU2 may not coincide with the centers of the second sensing units SU2.

The center of resistance of each of the second sensing units SU2 may be different from the center of the second sensing unit SU2. For example, the center of resistance of each of the second sensing units SU2 may be closer to the peripheral area 200NA than the center of the second sensing unit SU2. For example, the first outer sensing unit SU-EL is disposed to the right of the boundary BD. Accordingly, the center of resistance of the first outer sensing unit SU-EL may be disposed to the left of the center of the first outer sensing unit SU-EL. The second outer sensing unit SU-EU is disposed below the boundary BD. Accordingly, the center of resistance of the second outer sensing unit SU-EU may be disposed above the center of the second outer sensing unit SU-EU.

That is, the resistances or shapes of electrodes disposed in the second sensing units SU2 may be designed such that the current paths of the second sensing units SU2 are closer to the peripheral area 200NA than the centers of the second sensing units SU2. Accordingly, even though a pen input occurs adjacent to the peripheral area 200NA, a difference between induced currents provided from channels may be increased, and thus the pen sensing sensitivity may be improved.

According to one or more embodiments of the present disclosure, the second sensing units SU2 may completely surround the first sensing units SU1. Accordingly, the first sensing units SU1 may not be in contact with the boundary BD and may be spaced (e.g., spaced apart) from the boundary BD with the second sensing units SU2 therebetween. Thus, the pen sensing sensitivity for upper, lower, left, and right outer areas with respect to the sensing area 200A may be further improved.

FIG. 10B is a plan view illustrating a sensing area 200Aa according to one or more embodiments of the present disclosure. In describing FIG. 10B, components identical to the components described with reference to FIG. 10A will be assigned with identical reference numerals, and description thereabout will be omitted.

Referring to FIGS. 7 and 10B, the sensing area 200Aa may include a plurality of sensing units SU1 and SU2. The sensing units SU1 and SU2 may include the first sensing units SU1 and the second sensing units SU2.

Some of the second sensing units SU2 may be arranged along the second direction DR2, and the other second sensing units SU2 may be arranged along the second direction DR2. The some of the second sensing units SU2 and the other second sensing units SU2 may be spaced (e.g., spaced apart) from each other in the first direction DR1 with the first sensing units SU1 therebetween.

Portions of the boundary BD that extend in the second direction DR2 may be in contact with the second sensing units SU2, and portions of the boundary BD that extend in the first direction DR1 may be in contact with the first sensing units SU1.

The resistances or shapes of electrodes disposed in the second sensing units SU2 may be designed such that the current paths of the second sensing units SU2 are closer to the peripheral area 200NA than the centers of the second sensing units SU2. Thus, the pen sensing sensitivity for left and right outer areas with respect to the sensing area 200Aa may be further improved.

FIG. 10C is a plan view illustrating a sensing area 200Ab according to one or more embodiments of the present disclosure. In describing FIG. 10C, components identical to the components described with reference to FIG. 10A will be assigned with identical reference numerals, and description thereabout will be omitted.

Referring to FIGS. 7 and 10C, the sensing area 200Ab may include a plurality of sensing units SU1 and SU2. The sensing units SU1 and SU2 may include the first sensing units SU1 and the second sensing units SU2.

Some of the second sensing units SU2 may be arranged along the first direction DR1, and the other second sensing units SU2 may be arranged along the first direction DR1. The some of the second sensing units SU2 and the other second sensing units SU2 may be spaced (e.g., spaced apart) from each other in the second direction DR2 with the first sensing units SU1 therebetween.

Portions of the boundary BD that extend in the first direction DR1 may be in contact with the second sensing units SU2, and portions of the boundary BD that extend in the second direction DR2 may be in contact with the first sensing units SU1.

The resistances or shapes of electrodes disposed in the second sensing units SU2 may be designed such that the current paths of the second sensing units SU2 are closer to the peripheral area 200NA than the centers of the second sensing units SU2. Thus, the pen sensing sensitivity for upper and lower outer areas with respect to the sensing area 200Ab may be further improved.

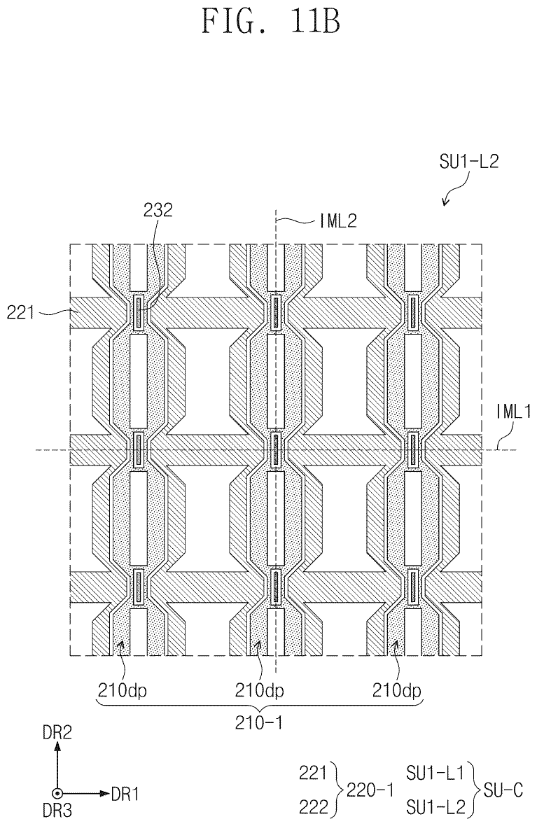

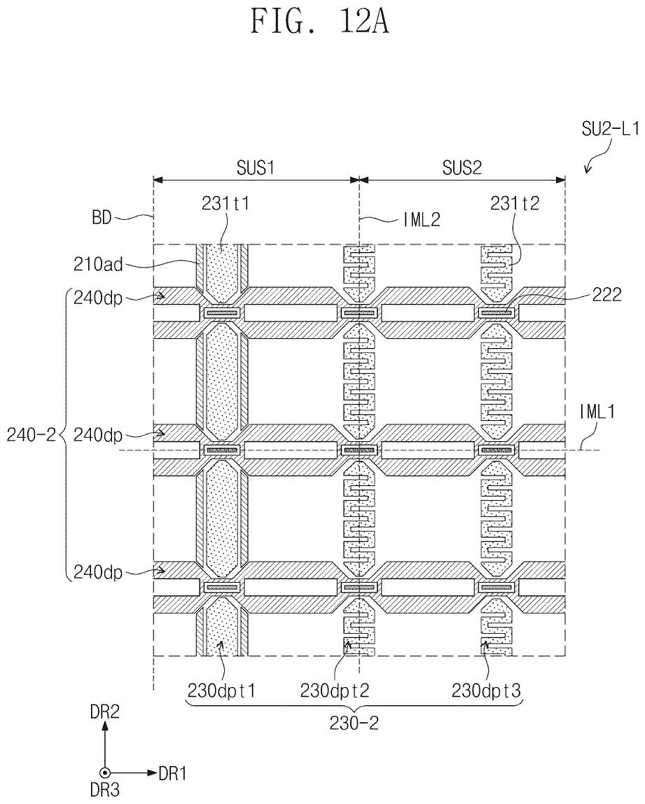

FIG. 11A is a plan view illustrating a first conductive layer SU1-L1 of the first sensing unit SU-C (e.g., the reference sensing unit SU-C) according to one or more embodiments of the present disclosure. FIG. 11B is a plan view illustrating a second conductive layer SU1-L2 of the first sensing unit SU-C according to one or more embodiments of the present disclosure.

Referring to FIGS. 11A and 11B, the first conductive layer SU1-L1 of the first sensing unit SU-C (or, referred to as the reference sensing unit) may be included in the first conductive layer 202 illustrated in FIG. 6A, and the second conductive layer SU1-L2 may be included in the second conductive layer 204 illustrated in FIG. 6A. The shapes of the first conductive layer SU1-L1 and the second conductive layer SU1-L2 illustrated in FIGS. 11A and 11B are only an example, and the present disclosure is not limited thereto. The shape of the first sensing unit SU-C may be modified in various ways.

In FIGS. 11A and 11B, the shape of a mesh structure is not illustrated, and the boundaries between components are briefly illustrated by lines. That is, it may be understood that the lines illustrated in FIGS. 11A and 11B correspond to lines from which a mesh structure is removed, and two components spaced (e.g., spaced apart) from each other with a line therebetween may be electrically insulated from each other. In addition, dummy patterns may be disposed in the areas where hatching is not drawn in FIGS. 11A and 11B. The dummy patterns may be electrically floated or electrically grounded and may have a mesh structure.

Referring to FIGS. 7, 11A, and 11B, the first electrodes 210 may include a first-first electrode 210-1 overlapping the first sensing unit SU-C, and the second electrodes 220 may include a second-first electrode 220-1 overlapping the first sensing unit SU-C. In addition, the third electrodes 230 may include a third-first electrode 230-1 overlapping the first sensing unit SU-C, and the fourth electrodes 240 may include a fourth-first electrode 240-1 overlapping the first sensing unit SU-C.

In FIGS. 11A and 11B, portions of the first-first electrode 210-1, the second-first electrode 220-1, the third-first electrode 230-1, and the fourth-first electrode 240-1 that overlap the first sensing unit SU-C are illustrated. The portions of the first-first electrode 210-1, the second-first electrode 220-1, the third-first electrode 230-1, and the fourth-first electrode 240-1 may have a symmetrical structure with respect to a first virtual line IML1 extending in the first direction DR1 and a second virtual line IML2 extending in the second direction DR2. For example, the first virtual line IML1 and the second virtual line IML2 may cross each other at the center of the first sensing unit SU-C in the first direction DR1 and the second direction DR2.

In one or more embodiments of the present disclosure, the first-first electrode 210-1 may include a plurality of first sub-electrodes 210dp that are arranged along the first direction DR1 and that have substantially the same shape. The shapes of the first sub-electrodes 210dp may be the same as one another. FIG. 11B illustrates an example that one first-first electrode 210-1 includes three first sub-electrodes 210dp. The three first sub-electrodes 210dp may be connected to one first trace line 210t (refer to FIG. 7).

The second-first electrode 220-1 may include a plurality of first patterns 221 and a plurality of first bridge patterns 222 electrically connected to the first patterns 221. The first patterns 221 spaced (e.g., spaced apart) from one another in the first direction DR1 may be electrically connected by the first bridge patterns 222. The first patterns 221 may be included in the second conductive layer SU1-L2, and the first bridge patterns 222 may be included in the first conductive layer SU1-L1.

Two first patterns 221 adjacent to each other in the first direction DR1 in the second-first electrode 220-1 may be electrically connected with each other by three first bridge patterns 222. An increase in the number of first bridge patterns 222 arranged along the second direction DR2 crossing the first direction DR1 that is the extension direction of the second-first electrode 220-1 may correspond to an increase in the number of signal paths. Accordingly, as the number of signal paths is increased, the resistance of the second-first electrode 220-1 may be decreased. Thus, the sensing sensitivity of the sensor layer 200 may be improved.

The third-first electrode 230-1 may include a plurality of first sub-auxiliary electrodes 230dp spaced (e.g., spaced apart) from one another in the first direction DR1. Each of the first sub-auxiliary electrodes 230dp may extend in the second direction DR2. The first sub-auxiliary electrodes 230dp may be spaced (e.g., spaced apart) from one another in the first direction DR1. The first sub-auxiliary electrodes 230dp may at least partially overlap the first sub-electrodes 210dp when viewed in the third direction DR3.

Each of the first sub-auxiliary electrodes 230dp may include a plurality of second patterns 231 and a plurality of second bridge patterns 232 electrically connected to the second patterns 231. The second patterns 231 and the second bridge patterns 232 may be electrically connected with each other through contact holes defined in the first insulating layer 203 (refer to FIG. 6A).

The fourth-first electrode 240-1 may include a plurality of second sub-auxiliary electrodes 240dp spaced (e.g., spaced apart) from one another in the second direction DR2. Each of the second sub-auxiliary electrodes 240dp may extend in the first direction DR1. The second sub-auxiliary electrodes 240dp may be spaced (e.g., spaced apart) from one another in the second direction DR2. The second sub-auxiliary electrodes 240dp may at least partially overlap the plurality of first patterns 221 of the second-first electrode 220-1 when viewed in the third direction DR3.

In one or more embodiments of the present disclosure, a first capacitor may be defined between the first-first electrode 210-1 and the third-first electrode 230-1, and a second capacitor may be defined between the second-first electrode 220-1 and the fourth-first electrode 240-1. The first capacitance of the first capacitor and the second capacitance of the second capacitor may be adjusted by the overlapping area between the first-first electrode 210-1 and the third-first electrode 230-1 and the overlapping area between the second-first electrode 220-1 and the fourth-first electrode 240-1.

As the first capacitance and the second capacitance are increased, the amount of induced current transferred from the third-first electrode 230-1 to the first-first electrode 210-1 may be increased, and the amount of induced current transferred from the fourth-first electrode 240-1 to the second-first electrode 220-1 may be increased. Accordingly, the pen sensing performance of the sensor layer 200 may be improved as the first capacitance and the second capacitance are increased. In addition, the first capacitance and the second capacitance may act as loads when a touch is sensed. Accordingly, touch sensing performance may be improved as the first capacitance and the second capacitance are decreased.

In one or more embodiments of the present disclosure, the overlapping area between the first-first electrode 210-1 and the third-first electrode 230-1 and the overlapping area between the second-first electrode 220-1 and the fourth-first electrode 240-1 may be adjusted. Accordingly, the sensor layer 200 having an appropriate level of capacitances considering touch sensitivity and pen sensing sensitivity may be provided. Thus, the electronic device 1000 (refer to FIG. 1A) with improved pen sensitivity and touch sensitivity may be provided.

In one or more embodiments of the present disclosure, in the second conductive layer SU1-L2 in one sensing unit SU, the area occupied by the components included in the first-first electrode 210-1 and the second-first electrode 220-1 may be greater than the area occupied by the components included in the third-first electrode 230-1 and the fourth-first electrode 240-1. A change in capacitance by the first input 2000 (refer to FIG. 5) may be increased as the distance is decreased. Accordingly, a component for sensing the first input 2000 (refer to FIG. 4) may be disposed in a relatively large area in a layer adjacent to the surface of the electronic device 1000 (refer to FIG. 1A). Thus, touch performance may be improved.

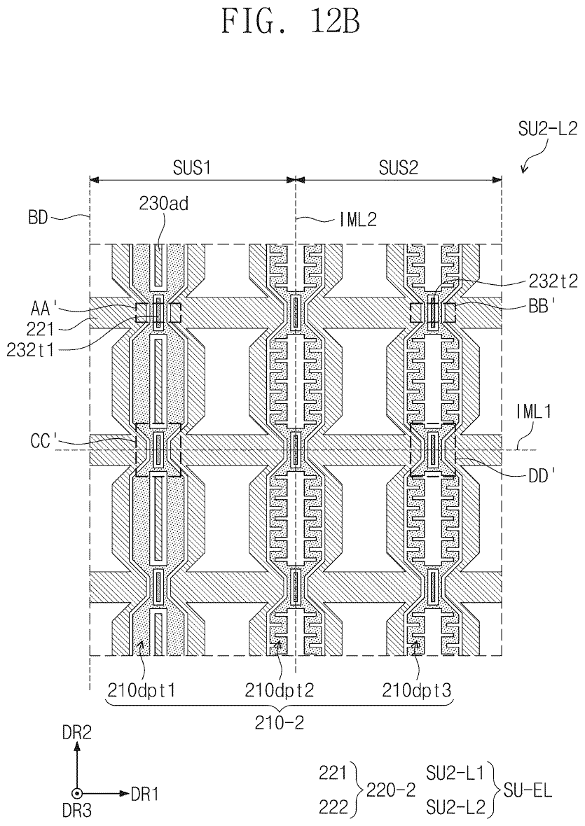

FIG. 12A is a plan view illustrating a first conductive layer SU2-L1 of the second sensing unit SU-EL according to an embodiment of the present disclosure. FIG. 12B is a plan view illustrating a second conductive layer SU2-L2 of the second sensing unit SU-EL according to one or more embodiments of the present disclosure.

Referring to FIGS. 7, 12A, and 12B, the second sensing unit SU-EL may be disposed to the right of the boundary BD and may correspond to the first outer sensing unit SU-EL described above with reference to FIG. 10A.

The first electrodes 210 may include a first-second electrode 210-2 overlapping the second sensing unit SU-EL, and the second electrodes 220 may include a second-second electrode 220-2 overlapping the second sensing unit SU-EL. In addition, the third electrodes 230 may include a third-second electrode 230-2 overlapping the second sensing unit SU-EL, and the fourth electrodes 240 may include a fourth-second electrode 240-2 overlapping the second sensing unit SU-EL. The shape of the first-second electrode 210-2 may be different from the shape of the first-first electrode 210-1 (refer to FIG. 11B). In addition, the shape of the third-second electrode 230-2 may be different from the shape of the third-first electrode 230-1 (refer to FIG. 11A).

In FIGS. 12A and 12B, portions of the first-second electrode 210-2, the second-second electrode 220-2, the third-second electrode 230-2, and the fourth-second electrode 240-2 are illustrated. The portions of the first-second electrode 210-2, the second-second electrode 220-2, the third-second electrode 230-2, and the fourth-second electrode 240-2 may have an asymmetrical structure with respect to one of a first virtual line IML1 extending in the first direction DR1 and a second virtual line IML2 extending in the second direction DR2. For example, FIGS. 12A and 12B illustrate an example that the portions of the first-second electrode 210-2, the second-second electrode 220-2, the third-second electrode 230-2, and the fourth-second electrode 240-2 have an asymmetrical structure with respect to the second virtual line IML2.

The first-second electrode 210-2 may include a plurality of second sub-electrodes 210dpt1, 210dpt2, and 210dpt3 arranged along the first direction DR1. The second sub-electrodes 210dpt1, 210dpt2, and 210dpt3 may be connected to one first trace line 210t (refer to FIG. 7).

According to one or more embodiments of the present disclosure, the resistance of one second sub-electrode 210dpt1 from among the second sub-electrodes 210dpt1, 210dpt2, and 210dpt3 may be lower than the resistance of another second sub-electrode 210dpt3. The one second sub-electrode 210dpt1 may be closer to the peripheral area 200NA than the another second sub-electrode 210dpt3. The current path of a channel (e.g., the first-second electrode 210-2) overlapping the second sensing unit SU-EL may be adjusted so as to be closer to the peripheral area 200NA than the center of the channel. Accordingly, a difference between signals, for example, a difference in intensity between induced currents may be further increased during differential sensing, and thus the sensitivity in the channel adjacent to the peripheral area 200NA may be further improved.

The second sub-electrodes 210dpt1, 210dpt2, and 210dpt3 may be referred to as the second-first sub-electrode 210dpt1, the second-second sub-electrode 210dpt2, and the second-third sub-electrode 210dpt3. The resistance ratio between the second-first sub-electrode 210dpt1, the second-second sub-electrode 210dpt2, and the second-third sub-electrode 210dpt3 may be 0.5:2:2, but is not particularly limited thereto. The resistance ratio may be adjusted in various ways, as long as the resistance of the second-first sub-electrode 210dpt1 adjacent to the peripheral area 200NA is made lower.

Various designs may be applied to make the resistances of the second sub-electrodes 210dpt1, 210dpt2, and 210dpt3 non-uniform. For example, the area of the second-first sub-electrode 210dpt1 may be greater than the areas of the second-second sub-electrode 210dpt2 and the second-third sub-electrode 210dpt3. In FIG. 12B, a cutting pattern may be provided to each of the second-second sub-electrode 210dpt2 and the second-third sub-electrode 210dpt3 such that the second-second sub-electrode 210dpt2 and the second-third sub-electrode 210dpt3 have a higher resistance than the second-first sub-electrode 210dpt1.

In addition, according to one or more embodiments of the present disclosure, the first-second electrode 210-2 may further include an additional electrode 210ad electrically connected with the second-first sub-electrode 210dpt1. The additional electrode 210ad may be disposed below the second-first sub-electrode 210dpt1 and may be electrically connected with the second-first sub-electrode 210dpt1. Accordingly, the resistance of the second-first sub-electrode 210dpt1 may be further decreased. The second-first sub-electrode 210dpt1 may be referred to as a first layer electrode disposed on (e.g., at) the same layer as the first-first electrode 210-1, and the additional electrode 210ad may be referred to as a second layer electrode disposed below the first layer electrode. In one or more embodiments of the present disclosure, the additional electrode 210ad may be omitted.

The second-second electrode 220-2 may include a plurality of first patterns 221 and a plurality of first bridge patterns 222 electrically connected to the first patterns 221. The first patterns 221 spaced (e.g., spaced apart) from one another in the first direction DR1 may be electrically connected by the first bridge patterns 222. The first patterns 221 may be included in the second conductive layer SU2-L2, and the first bridge patterns 222 may be included in the first conductive layer SU2-L1.

The third-second electrode 230-2 may include a plurality of third sub-electrodes 230dpt1, 230dpt2, and 230dpt3 spaced (e.g., spaced apart) from one another in the first direction DR1. The third sub-electrodes 230dpt1, 230dpt2, and 230dpt3 may be referred to as first sub-auxiliary electrodes.

The third sub-electrodes 230dpt1, 230dpt2, and 230dpt3 may include the third-first sub-electrode 230dpt1 overlapping the second-first sub-electrode 210dpt1, the third-second sub-electrode 230dpt2 overlapping the second-second sub-electrode 210dpt2, and the third-third sub-electrode 230dpt3 overlapping the second-third sub-electrode 210dpt3. The resistance of the third-first sub-electrode 230dpt1 may be lower than the resistance of the third-second sub-electrode 230dpt2 and the resistance of the third-third sub-electrode 230dpt3.

The third-first sub-electrode 230dpt1 may include a plurality of second-first patterns 231t1 and a plurality of second-first bridge patterns 232t1 electrically connected to the second-first patterns 231t1. Each of the third-second sub-electrode 230dpt2 and the third-third sub-electrode 230dpt3 may include a plurality of second-second patterns 231t2 and a plurality of second-second bridge patterns 232t2 electrically connected to the second-second patterns 231t2.

According to one or more embodiments of the present disclosure, various designs may be applied to make the resistances of the third sub-electrodes 230dpt1, 230dpt2, and 230dpt3 non-uniform. For example, the area of each of the second-first patterns 231t1 may be greater than the areas of the second-second patterns 231t2. In FIG. 12A, a cutting pattern may be provided to each of the second-second patterns 231t2 such that the second-second patterns 231t2 have a higher resistance than the second-first patterns 231t1.

In addition, according to one or more embodiments of the present disclosure, the third-second electrode 230-2 may further include an additional auxiliary electrode 230ad electrically connected with the second-first patterns 231t1. The additional auxiliary electrode 230ad may be disposed above the second-first pattern 231t1 and may be electrically connected with the second-first pattern 231t1. Accordingly, the resistance of the second-first pattern 231t1 may be further decreased. In one or more embodiments of the present disclosure, the additional auxiliary electrode 230ad may be omitted.

The fourth-second electrode 240-2 may include a plurality of second sub-auxiliary electrodes 240dp spaced (e.g., spaced apart) from one another in the second direction DR2. The second sub-auxiliary electrodes 240dp may at least partially overlap the plurality of first patterns 221 of the second-second electrode 220-2 when viewed in the third direction DR3.

The boundary BD in contact with the second sensing unit SU-EL may extend parallel to the second virtual line IML2. Accordingly, the second sensing unit SU-EL may include a first sub-area SUS1 between the second virtual line IML2 and the boundary BD and a second sub-area SUS2 spaced (e.g., spaced apart) from the boundary BD with the first sub-area SUS1 therebetween. In this case, the resistance of the first sub-area SUS1 may be lower than the resistance of the second sub-area SUS2 because the area of conductive patterns disposed in the first sub-area SUS1 is greater than the area of conductive patterns disposed in the second sub-area SUS2.

In addition, the area occupied by a conductive pattern that transfers a suitable (e.g., a predetermined signal) in the first sub-area SUS1 may be greater than the area occupied by a conductive pattern that transfers a suitable signal (e.g., a predetermined signal) in the second sub-area SUS2. For example, in FIG. 12B, a conductive pattern constituting the first-second electrode 210-2 may be disposed at a higher density in the first sub-area SUS1 than in the second sub-area SUS2.

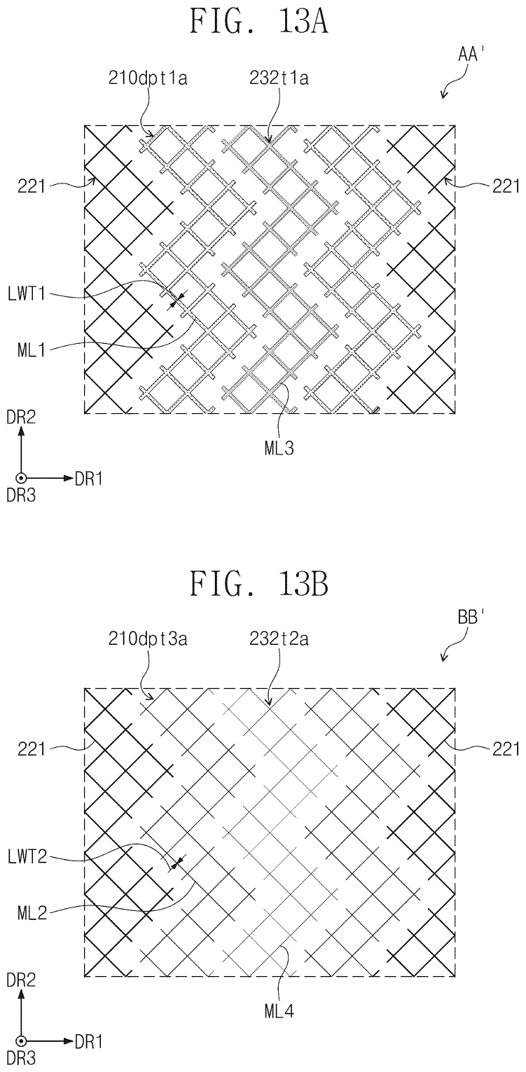

FIG. 13A is an enlarged plan view illustrating a portion of the second conductive layer 204 (refer to FIG. 6A) of the second sensing unit SU2 (refer to FIG. 10A) according to one or more embodiments of the present disclosure. FIG. 13B is an enlarged plan view illustrating a portion of the second conductive layer 204 (refer to FIG. 6A) of the second sensing unit SU2 (refer to FIG. 10A) according to one or more embodiments of the present disclosure. For example, FIG. 13A may be an enlarged plan view of an area corresponding to an area AA′ illustrated in FIG. 12B, and FIG. 13B may be an enlarged plan view of an area corresponding to an area BB′ illustrated in FIG. 12B.

Referring to FIGS. 13A and 13B, resistance may be adjusted by adjusting the line width of a mesh line in the second sensing unit SU2 (refer to FIG. 10A).

According to one or more embodiments of the present disclosure, a second-first sub-electrode 210dpt1a may include a plurality of first mesh lines ML1 having a first line width LWT1, and a second-third sub-electrode 210dpt3a may include a plurality of second mesh lines ML2 having a second line width LWT2 smaller than the first line width LWT1. In addition, second-first bridge patterns 232t1a may include a plurality of third mesh lines ML3 having the first line width LWT1, and second-second bridge patterns 232t2a may include a plurality of fourth mesh lines ML4 having the second line width LWT2 smaller than the first line width LWT1.

The resistance of the second-first sub-electrode 210dpt1a may be lower than the resistance of the second-third sub-electrode 210dpt3a. In addition, the resistance of each of the second-first bridge patterns 232t1a may be lower than the resistance of each of the second-second bridge patterns 232t2a. The current path of a channel (e.g., the first-second electrode 210-2) overlapping the second sensing unit SU2 may be adjusted so as to be closer to the peripheral area 200NA than the center of the channel. Accordingly, a difference between signals, for example, a difference in intensity between induced currents may be further increased during differential sensing, and thus the sensitivity in the channel adjacent to the peripheral area 200NA may be further improved.

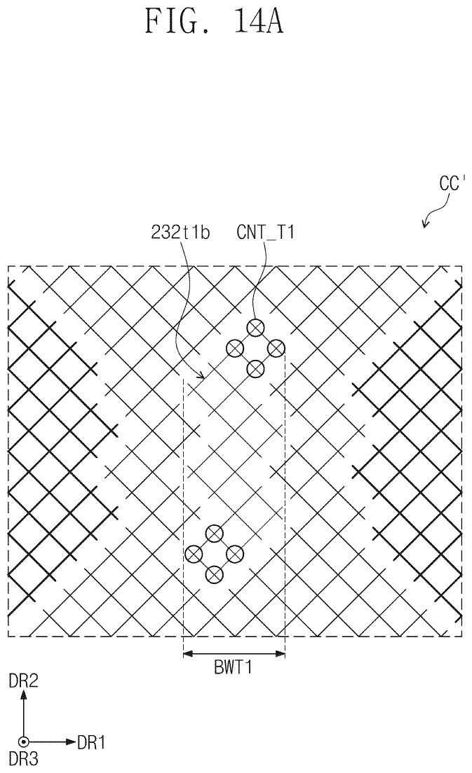

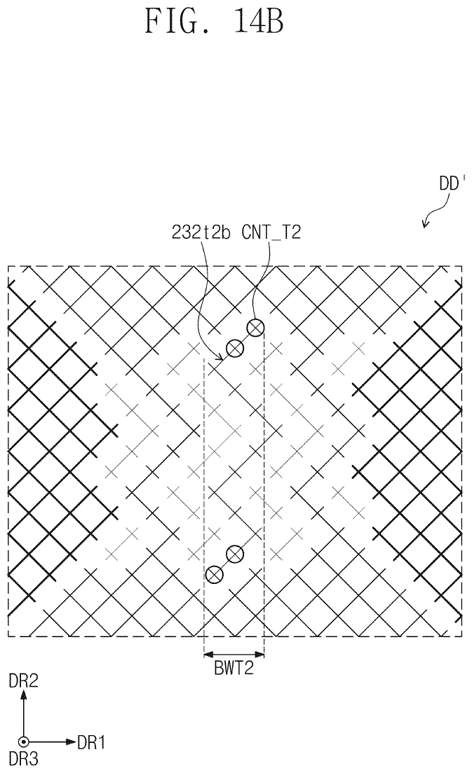

FIG. 14A is an enlarged plan view illustrating a portion of the second conductive layer 204 (refer to FIG. 6A) of the second sensing unit SU2 (refer to FIG. 10A) according to one or more embodiments of the present disclosure. FIG. 14B is an enlarged plan view illustrating a portion of the second conductive layer 204 (refer to FIG. 6A) of the second sensing unit SU2 (refer to FIG. 10A) according to one or more embodiments of the present disclosure. For example, FIG. 14A may be an enlarged plan view of an area corresponding to an area CC′ illustrated in FIG. 12B, and FIG. 14B may be an enlarged plan view of an area corresponding to an area DD′ illustrated in FIG. 12B.

Referring to FIGS. 14A and 14B, the resistance of each of second-first bridge patterns 232t1b may be lower than the resistance of each of second-second bridge patterns 232t2b. For example, the width BWT1 of the second-first bridge pattern 232t1b in the first direction DR1 may be greater than the width BWT2 of the second-second bridge pattern 232t2b in the first direction DR1. The number of mesh lines included in the second-first bridge pattern 232t1b may be greater than the number of mesh lines included in the second-second bridge pattern 232t2b.

According to one or more embodiments of the present disclosure, the second-first bridge pattern 232t1b may be electrically connected with the second-first pattern 231t1 (refer to FIG. 12A) through four first contacts CNT_T1, and the second-second bridge pattern 232t2b may be electrically connected with the second-second pattern 231t2 (refer to FIG. 12A) through two second contacts CNT_T2. The number of first contacts CNT_T1 is not particularly limited to the above-described number, as long as the number of first contacts CNT_T1 is greater than the number of second contacts CNT_T2. The resistance may be further decreased as the number of contacts is increased.

According to one or more embodiments of the present disclosure, either one or both of the structure described with reference to FIGS. 13A and 13B and the structure described with reference to FIGS. 14A and 14B may be applied to the second sensing unit SU2 described with reference to FIGS. 12A and 12B. In addition, neither the structure described with reference to FIGS. 13A and 13B nor the structure described with reference to FIGS. 14A and 14B may be applied to the second sensing unit SU2 described with reference to FIGS. 12A and 12B.

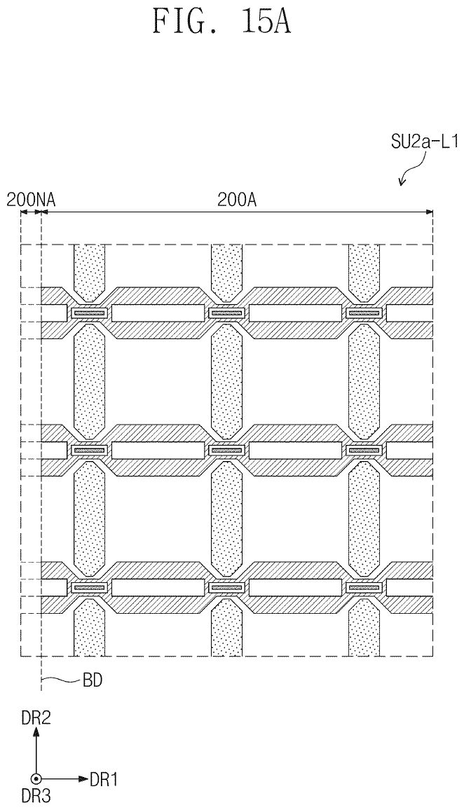

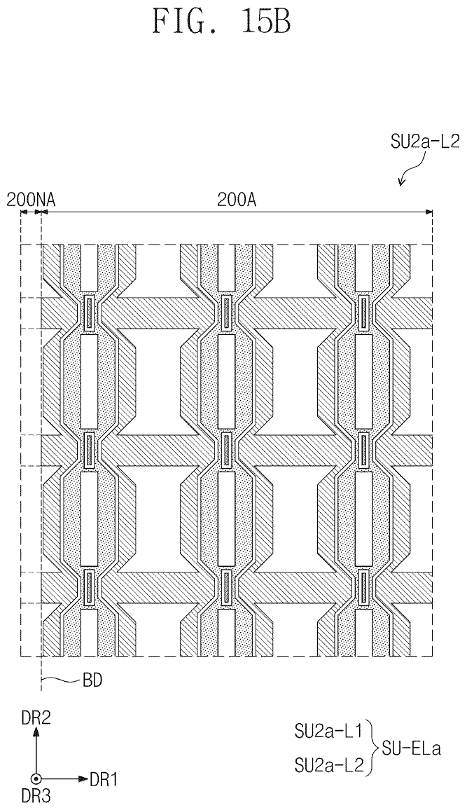

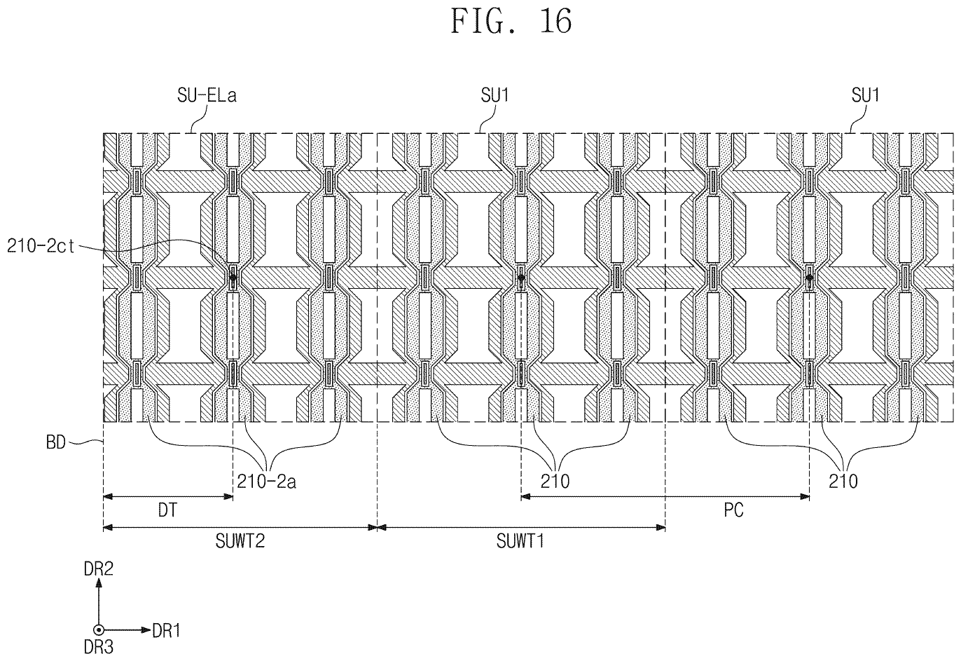

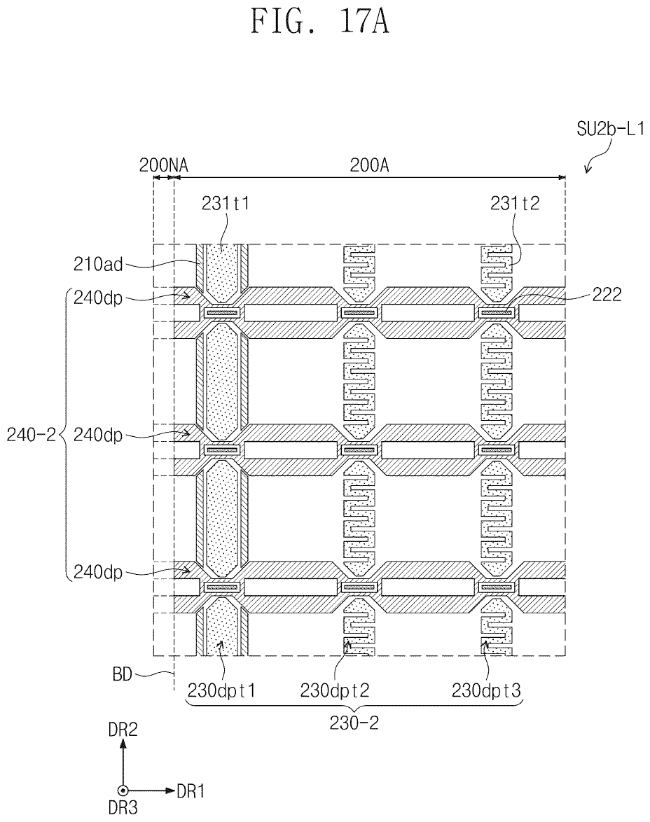

FIG. 15A is a plan view illustrating a first conductive layer SU2a-L1 of a second sensing unit SU-ELa according to one or more embodiments of the present disclosure. FIG. 15B is a plan view illustrating a second conductive layer SU2a-L2 of the second sensing unit SU-ELa according to one or more embodiments of the present disclosure. FIG. 16 is a plan view illustrating the second conductive layer 204 (refer to FIG. 6A) of three sensing units SU-ELa, SU1, and SU1 according to one or more embodiments of the present disclosure.

Referring to FIGS. 7, 15A, and 15B, the second sensing unit SU-ELa may be disposed to the right of the boundary BD and may correspond to the first outer sensing unit SU-EL described above with reference to FIG. 10A.

When compared to the first sensing unit SU-C illustrated in FIGS. 11A and 11B, the second sensing unit SU-ELa illustrated in FIGS. 15A and 15B may have a shape similar to a shape in which a portion adjacent to the boundary BD is cut off or omitted.

When compared to the first conductive layer SU1-L1 illustrated in FIG. 11A, the first conductive layer SU2a-L1 of the second sensing unit SU-ELa may have a shape in which a portion is cut off. When compared to the second conductive layer SU1-L2 illustrated in FIG. 11B, the second conductive layer SU2a-L2 of the second sensing unit SU-ELa may have a shape in which a portion is cut off. In FIGS. 15A and 15B, the omitted pattern portions are illustrated by dotted lines when compared to the patterns illustrated in FIGS. 11A and 11B.

According to one or more embodiment of the present disclosure, because the portions of the patterns that are adjacent to the boundary BD are omitted, the current path of a channel included in the second sensing unit SU-ELa may further move toward the boundary BD. Accordingly, a difference between signals, for example, a difference in intensity between induced currents may be further increased during differential sensing, and thus the sensitivity in the channel adjacent to the peripheral area 200NA may be further improved.

Referring to FIG. 16, the second sensing unit SU-ELa and two first sensing units SU1 sequentially arranged in a direction away from the boundary BD are illustrated. The second sensing unit SU-ELa may be in contact with a portion of the boundary BD extending in the second direction DR2, and the two first sensing units SU1 may be spaced (e.g., spaced apart) from the second sensing unit SU-ELa in the first direction DR1. According to one or more embodiments of the present disclosure, the width SUWT2 of the second sensing unit SU-ELa in the first direction DR1 may be adjusted. For example, as described with reference to FIGS. 15A and 15B, a portion of the second sensing unit SU-ELa may be removed. Accordingly, the width SUWT1 of the first sensing unit SU1 in the first direction DR1 may be greater than the width SUWT2 of the second sensing unit SU-ELa in the first direction DR1.

In addition, the distance DT between the center 210-2ct of a first-second electrode 210-2a overlapping the second sensing unit SU-ELa and the boundary BD may be smaller than half the pitch PT between the remaining first electrodes 210. Accordingly, as compared with when a portion of the pattern of the second sensing unit SU-ELa is not removed, the current path of the first-second electrode 210-2a may further move toward the boundary BD. Accordingly, a difference between signals, for example, a difference in intensity between induced currents may be further increased during differential sensing, and thus the sensitivity in the channel adjacent to the peripheral area 200NA may be further improved.

According to one or more embodiments of the present disclosure, even though the second sensing unit SU-ELa, when compared to the first sensing unit SU-C (refer to FIG. 11B), has a shape in which a portion is cut off, the first coupling capacitance between the first electrode 210 (refer to FIG. 7) and the third electrode 230 (refer to FIG. 7) and the second coupling capacitance between the second electrode 220 (refer to FIG. 7) and the fourth electrode 240 (refer to FIG. 7) may be adjusted so as not to be decreased, when compared to the first coupling capacitance and the second coupling capacitance of the first sensing unit SU-C. For example, the coupling capacitance decreased by the omitted pattern may be compensated for by increasing the area of the first electrode 210 or the third electrode 230 included in the second sensing unit SU-ELa or increasing the area of the second electrode 220 or the fourth electrode 240 included in the second sensing unit SU-ELa.

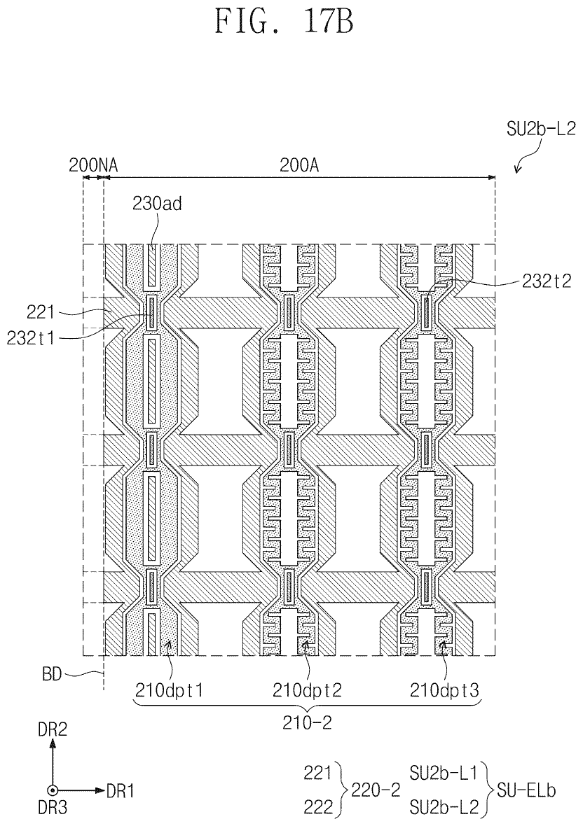

FIG. 17A is a plan view illustrating a first conductive layer SU2b-L1 of a second sensing unit SU-ELb according to one or more embodiments of the present disclosure. FIG. 17B is a plan view illustrating a second conductive layer SU2b-L2 of the second sensing unit SU-ELb according to one or more embodiments of the present disclosure.

Referring to FIGS. 17A and 17B, the second sensing unit SU-ELb may be disposed to the right of the boundary BD and may correspond to the first outer sensing unit SU-EL described above with reference to FIG. 10A.

When compared to the second sensing unit SU-EL illustrated in FIGS. 12A and 12B, the second sensing unit SU-ELb illustrated in FIGS. 17A and 17B may have a shape in which a portion adjacent to the boundary BD is cut off or omitted.

When compared to the first conductive layer SU2-L1 illustrated in FIG. 12A, the first conductive layer SU2b-L1 of the second sensing unit SU-ELb may have a shape in which a portion is cut off. When compared to the second conductive layer SU2-L2 illustrated in FIG. 12B, the second conductive layer SU2b-L2 of the second sensing unit SU-ELb may have a shape in which a portion is cut off. In FIGS. 17A and 17B, the omitted pattern portions are illustrated by dotted lines when compared to the patterns illustrated in FIGS. 12A and 12B.

According to one or more embodiments of the present disclosure, the resistance of one second sub-electrode 210dpt1 from among second sub-electrodes 210dpt1, 210dpt2, and 210dpt3 may be lower than the resistance of another second sub-electrode 210dpt3. The one second sub-electrode 210dpt1 may be closer to the peripheral area 200NA than the another second sub-electrode 210dpt3. The current path of a channel (e.g., a first-second electrode 210-2) overlapping the second sensing unit SU-ELb may be adjusted so as to be closer to the peripheral area 200NA than the center of the channel. Because the portions of the patterns that are adjacent to the boundary BD are omitted, the current path of a channel included in the second sensing unit SU-ELb may further move toward the boundary BD. Accordingly, a difference between signals, for example, a difference in intensity between induced currents may be further increased during differential sensing, and thus the sensitivity in the channel adjacent to the peripheral area 200NA may be further improved.

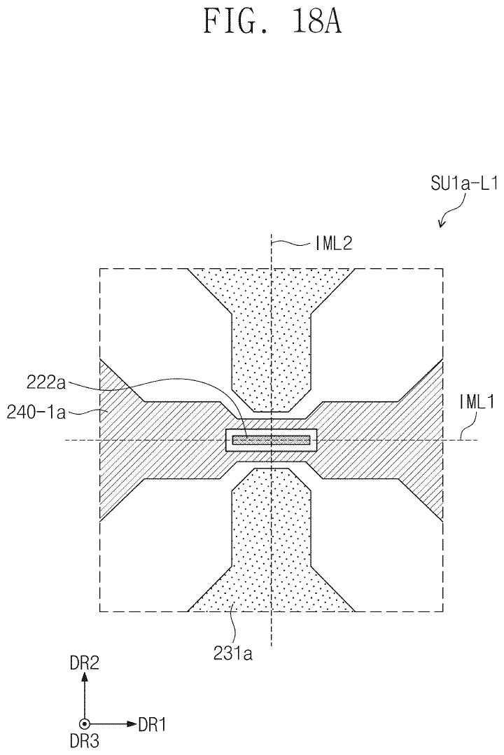

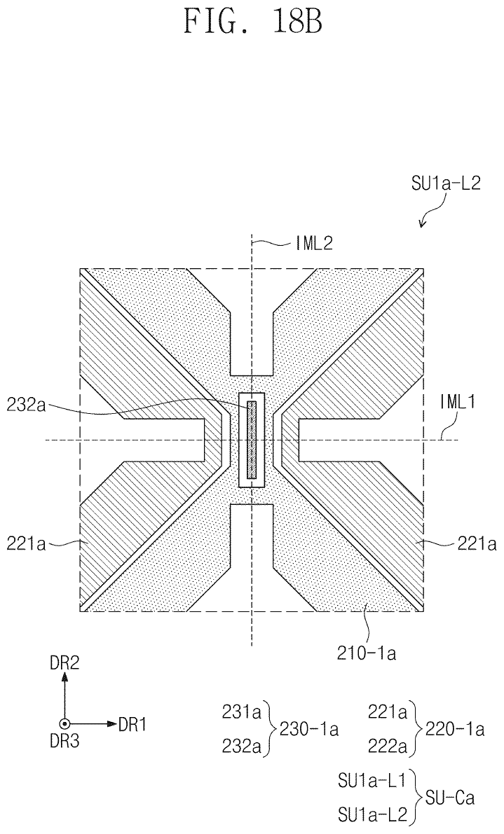

FIG. 18A is a plan view illustrating a first conductive layer SU1a-L1 of a first sensing unit SU-Ca according to one or more embodiments of the present disclosure. FIG. 18B is a plan view illustrating a second conductive layer SU1a-L2 of the first sensing unit SU-Ca according to one or more embodiments of the present disclosure.

Referring to FIGS. 7, 18A, and 18B, the first electrodes 210 may include a first-first electrode 210-1a overlapping the first sensing unit SU-Ca, and the second electrodes 220 may include a second-first electrode 220-1a overlapping the first sensing unit SU-Ca. In addition, the third electrodes 230 may include a third-first electrode 230-1a overlapping the first sensing unit SU-Ca, and the fourth electrodes 240 may include a fourth-first electrode 240-1a overlapping the first sensing unit SU-Ca.

In FIGS. 18A and 18B, portions of the first-first electrode 210-1a, the second-first electrode 220-1a, the third-first electrode 230-1a, and the fourth-first electrode 240-1a that overlap the first sensing unit SU-Ca are illustrated. The portions of the first-first electrode 210-1a, the second-first electrode 220-1a, the third-first electrode 230-1a, and the fourth-first electrode 240-1a may have a symmetrical structure with respect to a first virtual line IML1 extending in the first direction DR1 and a second virtual line IML2 extending in the second direction DR2.

The second-first electrode 220-1a may include a plurality of first patterns 221a and a first bridge pattern 222a electrically connected to the first patterns 221a. The third-first electrode 230-1a may include a plurality of second patterns 231a and a second bridge pattern 232a electrically connected to the second patterns 231a.

The fourth-first electrode 240-1a, the first bridge pattern 222a, and the second patterns 231a may be disposed on (e.g., at) the same layer. For example, the fourth-first electrode 240-1a, the first bridge pattern 222a, and the second patterns 231a may be included in the first conductive layer 202 illustrated in FIG. 6A. The fourth-first electrode 240-1a may have an opening defined therein, and one first bridge pattern 222a may be disposed to correspond to the opening. The second patterns 231a may be spaced (e.g., spaced apart) from each other with the fourth-first electrode 240-1a and the first bridge pattern 222a therebetween.

The first-first electrode 210-1a, the first patterns 221a, and the second bridge pattern 232a may be disposed on (e.g., at) the same layer. For example, the first-first electrode 210-1a, the first patterns 221a, and the second bridge pattern 232a may be included in the second conductive layer 204 illustrated in FIG. 6A. The first-first electrode 210-1a may have an opening defined therein, and the second bridge pattern 232a may be disposed to correspond to the opening. The first patterns 221a may be spaced (e.g., spaced apart) from each other with the first-first electrode 210-1a and the second bridge pattern 232a therebetween.

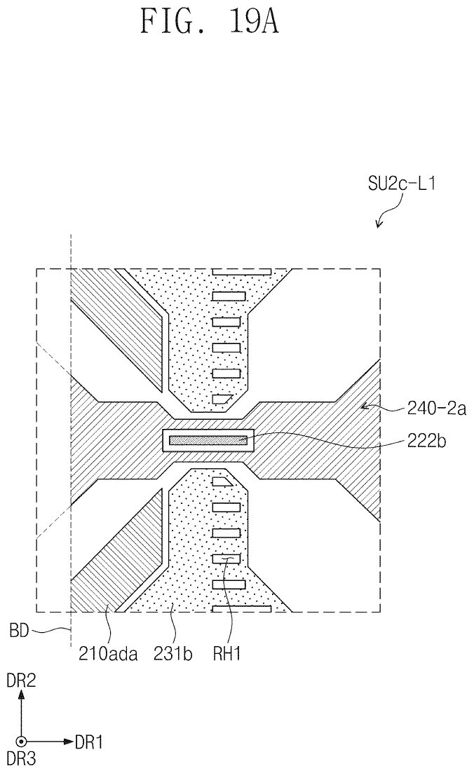

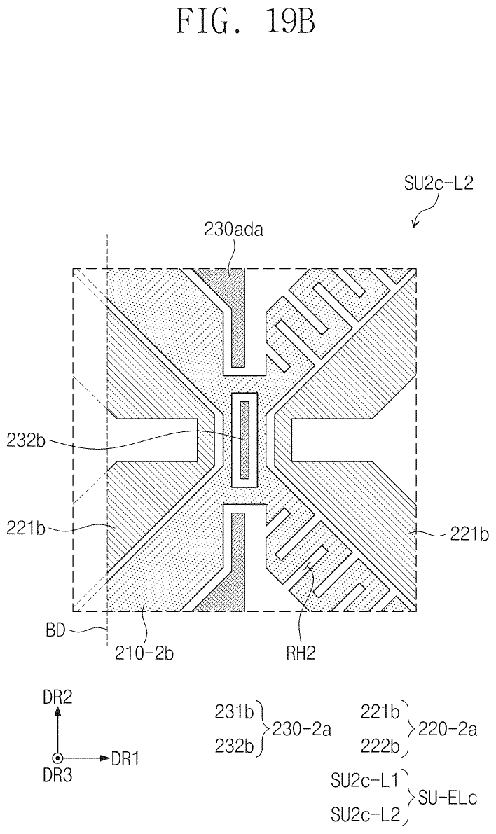

FIG. 19A is a plan view illustrating a first conductive layer SU2c-L1 of a second sensing unit SU-ELc according to one or more embodiments of the present disclosure. FIG. 19B is a plan view illustrating a second conductive layer SU2c-L2 of the second sensing unit SU-ELc according to one or more embodiments of the present disclosure.

Referring to FIGS. 19A and 19B, the second sensing unit SU-ELc may be disposed to the right of the boundary BD and may correspond to the first outer sensing unit SU-EL described above with reference to FIG. 10A.

When compared to the first sensing unit SU-Ca illustrated in FIGS. 18A and 18B, the second sensing unit SU-ELc illustrated in FIGS. 19A and 19B may include a shape in which a portion adjacent to the boundary BD is cut off or omitted. In FIGS. 19A and 19B, the omitted pattern portions are illustrated by dotted lines when compared to the patterns illustrated in FIGS. 18A and 18B.

Referring to FIGS. 7, 19A, and 19B, the first electrodes 210 may include a first-second electrode 210-2b overlapping the second sensing unit SU-ELc, and the second electrodes 220 may include a second-second electrode 220-2a overlapping the second sensing unit SU-ELc. In addition, the third electrodes 230 may include a third-second electrode 230-2a overlapping the second sensing unit SU-ELc, and the fourth electrodes 240 may include a fourth-second electrode 240-2a overlapping the second sensing unit SU-ELc.

The second-second electrode 220-2a may include a plurality of first patterns 221b and a first bridge pattern 222b electrically connected to the first patterns 221b. The third-second electrode 230-2a may include a plurality of second patterns 231b and a second bridge pattern 232b electrically connected to the second patterns 231b.

The first conductive layer SU2c-L1 may include the second patterns 231b and the fourth-second electrode 240-2a. In addition, the first conductive layer SU2c-L1 may further include first additional patterns 210ada. The first additional patterns 210ada may be disposed between the boundary BD and the fourth-second electrode 240-2a. The first additional patterns 210ada may be electrically connected to the first-second electrode 210-2b. In addition, a first cutting pattern RH1 may be provided to the second patterns 231b. When the first cutting pattern RH1 is provided, the resistances of portions of the second patterns 231b may be increased.

The second conductive layer SU2c-L2 may include the first-second electrode 210-2b, the first patterns 221b, and the second bridge pattern 232b. In addition, the second conductive layer SU2c-L2 may further include second additional patterns 230ada. The second additional patterns 230ada may overlap the second patterns 231b and may be electrically connected to the second patterns 231b. In addition, a second cutting pattern RH2 may be provided to the first-second electrode 210-2b. When the second cutting pattern RH2 is provided, the resistance of a portion of the first-second electrode 210-2b may be increased.

According to one or more embodiments of the present disclosure, because the portions of the patterns that are adjacent to the boundary BD are omitted, the current path of a channel included in the second sensing unit SU-ELc may further move toward the boundary BD. In addition, non-uniform resistance may be implemented in the second sensing unit SU-ELc by additionally placing a conductive pattern (e.g., the first additional pattern 210ada and the second additional pattern 230ada) in an area closer to the boundary BD and providing a cutting pattern (e.g., the first cutting pattern RH1 and the second cutting pattern RH2) to a portion spaced further apart from the boundary BD. In particular, by making the resistance of an area adjacent to the boundary BD lower, the current path of a channel included in the second sensing unit SU-ELc may further move toward the boundary BD. Accordingly, a difference between signals, for example, a difference in intensity between induced currents may be further increased during differential sensing, and thus the sensitivity in the channel adjacent to the peripheral area 200NA may be further improved.

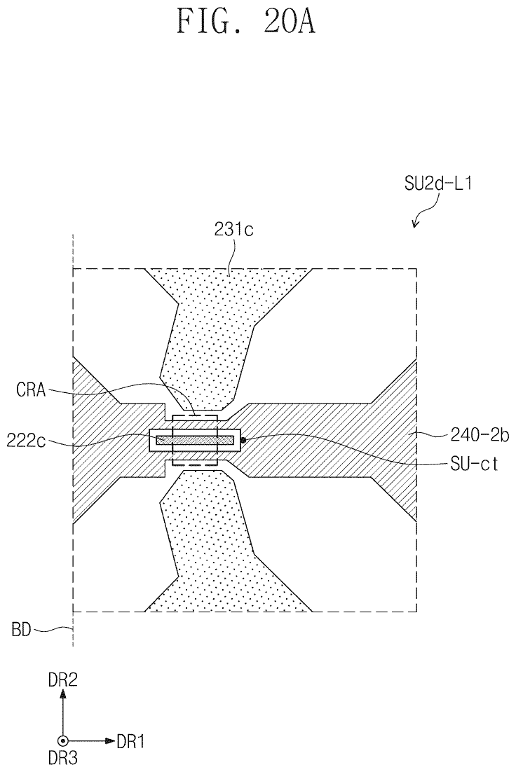

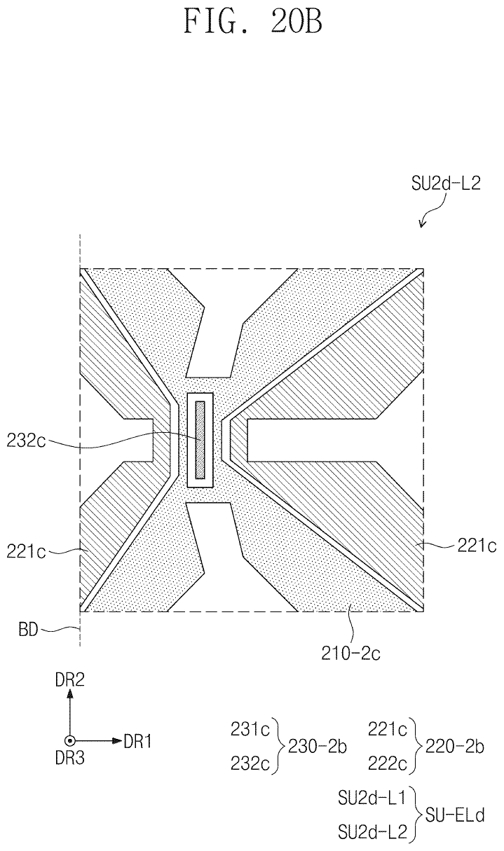

FIG. 20A is a plan view illustrating a first conductive layer SU2d-L1 of a second sensing unit SU-ELd according to one or more embodiments of the present disclosure. FIG. 20B is a plan view illustrating a second conductive layer SU2d-L2 of the second sensing unit SU-ELd according to one or more embodiments of the present disclosure.

Referring to FIGS. 20A and 20B, the second sensing unit SU-ELd may be disposed to the right of the boundary BD and may correspond to the first outer sensing unit SU-EL described above with reference to FIG. 10A.

Referring to FIGS. 7, 20A, and 20B, the first electrodes 210 may include a first-second electrode 210-2c overlapping the second sensing unit SU-ELd, and the second electrodes 220 may include a second-second electrode 220-2b overlapping the second sensing unit SU-ELd. In addition, the third electrodes 230 may include a third-second electrode 230-2b overlapping the second sensing unit SU-ELd, and the fourth electrodes 240 may include a fourth-second electrode 240-2b overlapping the second sensing unit SU-ELd.

The second-second electrode 220-2b may include a plurality of first patterns 221c and a first bridge pattern 222c electrically connected to the first patterns 221c. The third-second electrode 230-2b may include a plurality of second patterns 231c and a second bridge pattern 232c electrically connected to the second patterns 231c.

In the second sensing unit SU-ELd, a crossing area CRA where the first-second electrode 210-2c and the second-second electrode 220-2b overlap each other may be closer to the peripheral area 200NA or the boundary BD than the center SU-ct of the second sensing unit SU-ELd. The crossing area CRA may overlap the area where the first bridge pattern 222c and the second bridge pattern 232c are disposed.

According to one or more embodiments of the present disclosure, the position of the crossing area CRA may be adjusted such that the current path is closer to the boundary BD. Accordingly, a difference between signals, for example, a difference in intensity between induced currents may be further increased during differential sensing, and thus the sensitivity in the channel adjacent to the peripheral area 200NA may be further improved.

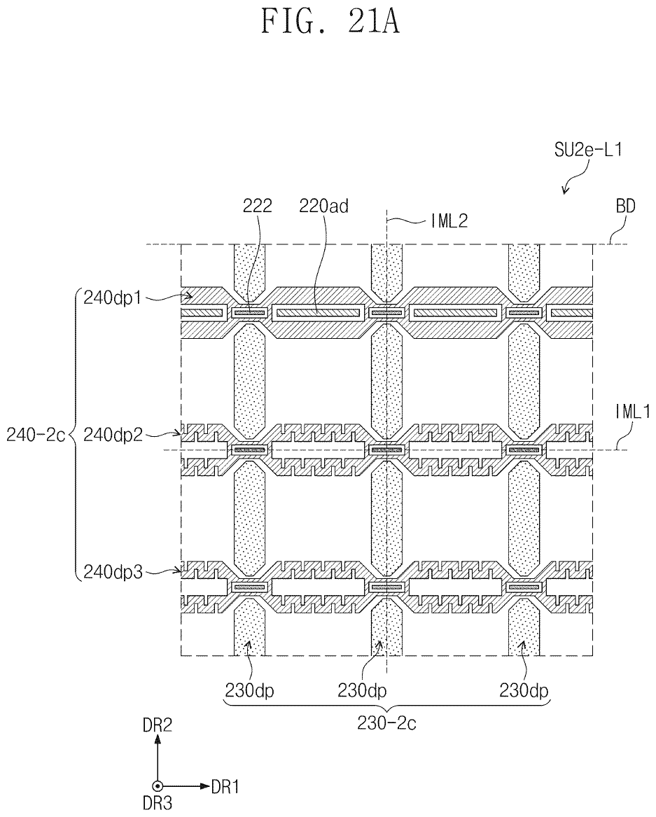

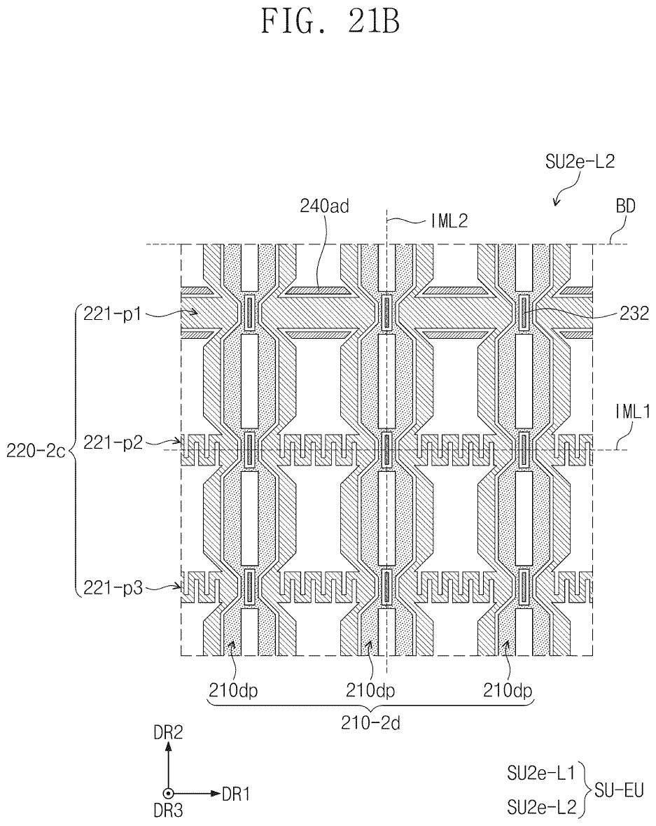

FIG. 21A is a plan view illustrating a first conductive layer SU2e-L1 of a second sensing unit SU-EU according to one or more embodiments of the present disclosure. FIG. 21B is a plan view illustrating a second conductive layer SU2e-L2 of the second sensing unit SU-EU according to one or more embodiments of the present disclosure.

Referring to FIGS. 21A and 21B, the second sensing unit SU-EU may be disposed below the boundary BD and may correspond to the second outer sensing unit SU-EU described above with reference to FIG. 10A.

Referring to FIGS. 7, 21A, and 21B, the first electrodes 210 may include a first-second electrode 210-2d overlapping the second sensing unit SU-EU, and the second electrodes 220 may include a second-second electrode 220-2c overlapping the second sensing unit SU-EU. In addition, the third electrodes 230 may include a third-second electrode 230-2c overlapping the second sensing unit SU-EU, and the fourth electrodes 240 may include a fourth-second electrode 240-2c overlapping the second sensing unit SU-EU.

In FIGS. 21A and 21B, portions of the first-second electrode 210-2d, the second-second electrode 220-2c, the third-second electrode 230-2c, and the fourth-second electrode 240-2c are illustrated. The portions of the first-second electrode 210-2d, the second-second electrode 220-2c, the third-second electrode 230-2c, and the fourth-second electrode 240-2c may have an asymmetrical structure with respect to one of a first virtual line IML1 extending in the first direction DR1 and a second virtual line IML2 extending in the second direction DR2. For example, FIGS. 21A and 21B illustrate an example that the portions of the first-second electrode 210-2d, the second-second electrode 220-2c, the third-second electrode 230-2c, and the fourth-second electrode 240-2c have an asymmetrical structure with respect to the first virtual line IML1.

The first-second electrode 210-2d may include first sub-electrodes 210dp arranged along the first direction DR1. The first sub-electrodes 210dp may have the same shape. The third-second electrode 230-2c may include second sub-electrodes 230dp arranged along the first direction DR1. The second sub-electrodes 230dp may have the same shape.

The second-second electrode 220-2c may include first to third pattern portions 221-p1, 221-p2, and 221-p3 and a second bridge pattern 222. The fourth-second electrode 240-2c may include third sub-electrodes 240dp1, 240dp2, and 240dp3 arranged along the second direction DR2. The third sub-electrodes 240dp1, 240dp2, and 240dp3 may include the third-first sub-electrode 240dp1, the third-second sub-electrode 240dp2, and the third-third sub-electrode 240dp3 in a direction away from the boundary BD. The first pattern portion 221-p1 may overlap the third-first sub-electrode 240dp1, the second pattern portion 221-p2 may overlap the third-second sub-electrode 240dp2, and the third pattern portion 221-p3 may overlap the third-third sub-electrode 240dp3.

According to one or more embodiments of the present disclosure, a cutting pattern may be provided to make the resistance ratio between the second-second electrode 220-2c and the fourth-second electrode 240-2c non-uniform in the second sensing unit SU-EU. For example, the cutting pattern may be provided to the third-second sub-electrode 240dp2, the third-third sub-electrode 240dp3, the second pattern portion 221-p2, and the third pattern portion 221-p3. The resistance ratio between the third-first sub-electrode 240dp1, the third-second sub-electrode 240dp2, and the third-third sub-electrode 240dp3 may be 0.5:2:2, but is not particularly limited thereto. The resistance ratio may be adjusted in various ways, as long as the resistance of the third-first sub-electrode 240dp1 adjacent to the peripheral area 200NA is made lower.

According to one or more embodiments of the present disclosure, the first conductive layer SU2e-L1 may further include a first additional electrode 220ad that overlaps the first pattern portion 221-p1 and that is electrically connected to the first pattern portion 221-p1. In addition, the second conductive layer SU2e-L2 may further include a second additional electrode 240ad that overlaps the third-first sub-electrode 240dp1 and that is electrically connected to the third-first sub-electrode 240dp1.

According to one or more embodiments of the present disclosure, the current path of a channel (e.g., the second-second electrode 220-2c) overlapping the second sensing unit SU-EU may be adjusted so as to be closer to the peripheral area 200NA than the center of the channel. Accordingly, a difference between signals, for example, a difference in intensity between induced currents may be further increased during differential sensing, and thus the sensitivity in the channel adjacent to the peripheral area 200NA may be further improved.

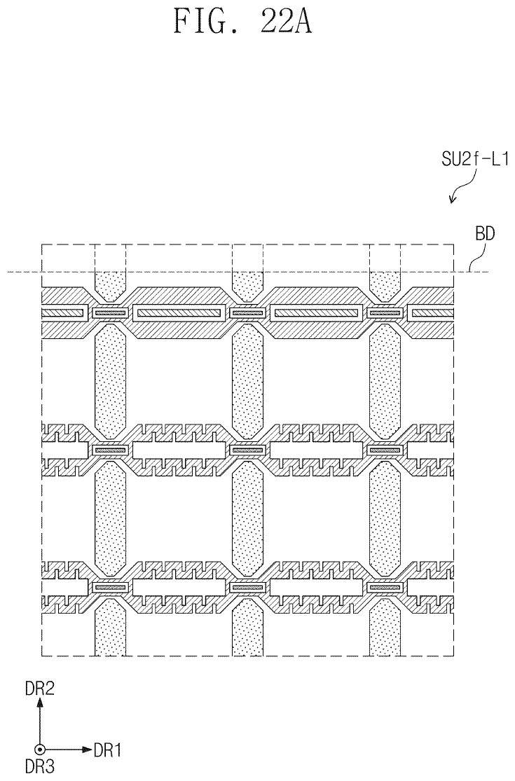

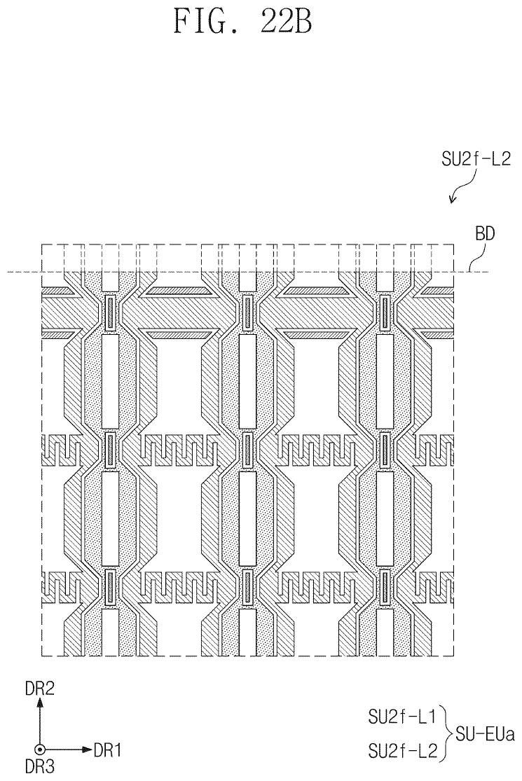

FIG. 22A is a plan view illustrating a first conductive layer SU2f-L1 of a second sensing unit SU-EUa according to one or more embodiments of the present disclosure. FIG. 22B is a plan view illustrating a second conductive layer SU2f-L2 of the second sensing unit SU-EUa according to one or more embodiments of the present disclosure.

Referring to FIGS. 22A and 22B, when compared to the second sensing unit SU-EU illustrated in FIGS. 21A and 21B, the second sensing unit SU-EUa may have a shape in which a portion adjacent to the boundary BD is cut off or omitted.

When compared to the first conductive layer SU2e-L1 illustrated in FIG. 21A, the first conductive layer SU2f-L1 of the second sensing unit SU-ELa may have a shape in which a portion is cut off. When compared to the second conductive layer SU2e-L2 illustrated in FIG. 21B, the second conductive layer SU2f-L2 of the second sensing unit SU-ELa may have a shape in which a portion is cut off. In FIGS. 22A and 22B, the omitted pattern portions are illustrated by dotted lines when compared to the patterns illustrated in FIGS. 21A and 21B.

Because the portions of the patterns that are adjacent to the boundary BD are omitted, the current path of a channel included in the second sensing unit SU-EUa may further move toward the boundary BD. Accordingly, a difference between signals, for example, a difference in intensity between induced currents may be further increased during differential sensing, and thus the sensitivity in the channel adjacent to the peripheral area 200NA may be further improved.

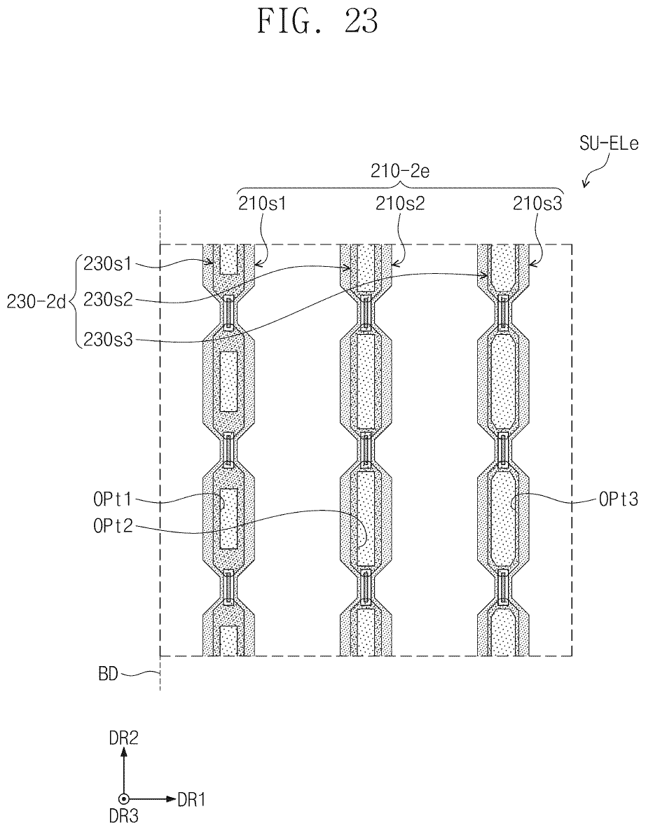

FIG. 23 is a plan view illustrating some of the components included in a second sensing unit SU-ELe according to one or more embodiments of the present disclosure.

Referring to FIGS. 7 and 23, the second sensing unit SU-ELe may be disposed to the right of the boundary BD and may correspond to the first outer sensing unit SU-EL described above with reference to FIG. 10A.

The first electrodes 210 may include a first-second electrode 210-2e overlapping the second sensing unit SU-ELe, and the third electrodes 230 may include a third-second electrode 230-2d overlapping the second sensing unit SU-ELe.

The first-second electrode 210-2e may include first sub-electrodes 210s1, 210s2, and 210s3 arranged along the first direction DR1, and the third electrodes 230 may include second sub-electrodes 230s1, 230s2, and 230s3 arranged along the first direction DR1. The first sub-electrodes 210s1, 210s2, and 210s3 may include the first-first sub-electrode 210s1, the first-second sub-electrode 210s2, and the first-third sub-electrode 210s3 arranged in a direction away from the boundary BD. The second sub-electrodes 230s1, 230s2, and 230s3 may include the second-first sub-electrode 230s1, the second-second sub-electrode 230s2, and the second-third sub-electrode 230s3 arranged in the direction away from the boundary BD.

An induced current may be transferred through a coupling capacitor generated between the first-second electrode 210-2e and the third-second electrode 230-2d. According to one or more embodiments of the present disclosure, a current path may be adjusted by adjusting the capacitance of the coupling capacitor. Because the amount of transferred current is proportional to the magnitude of capacitance, coupling capacitance closer to the boundary BD may be adjusted so as to be larger. For example, first capacitance between the first-first sub-electrode 210s1 and the second-first sub-electrode 230s1 may be greater than second capacitance between the first-third sub-electrode 210s3 and the second-third sub-electrode 230s3.

According to one or more embodiments of the present disclosure, to provide a difference between the first capacitance and the second capacitance, the overlapping area between the first-first sub-electrode 210s1 and the second-first sub-electrode 230s1 and the overlapping area between the first-third sub-electrode 210s3 and the second-third sub-electrode 230s3 may be adjusted so as to be different from each other. For example, a first opening OPt1 may be defined in the first-first sub-electrode 210s1, a second opening OPt2 may be defined in the first-second sub-electrode 210s2, and a third opening OPt3 may be defined in the first-third sub-electrode 210s3. The size of the third opening OPt3 may be greater than the size of the first opening OPt1. Accordingly, the overlapping area between the first-first sub-electrode 210s1 and the second-first sub-electrode 230s1 may be greater than the overlapping area between the first-third sub-electrode 210s3 and the second-third sub-electrode 230s3.

In one or more embodiments of the present disclosure, the first-first sub-electrode 210s1 and the first-third sub-electrode 210s3 may be disposed on (e.g., at) the same layer. In this case, capacitance may be increased by increasing the area by which the first-first sub-electrode 210s1 and the first-third sub-electrode 210s3 face each other. For example, the boundary between the first-first sub-electrode 210s1 and the first-third sub-electrode 210s3 may be provided in a zigzag or uneven shape rather than a straight line to increase capacitance.

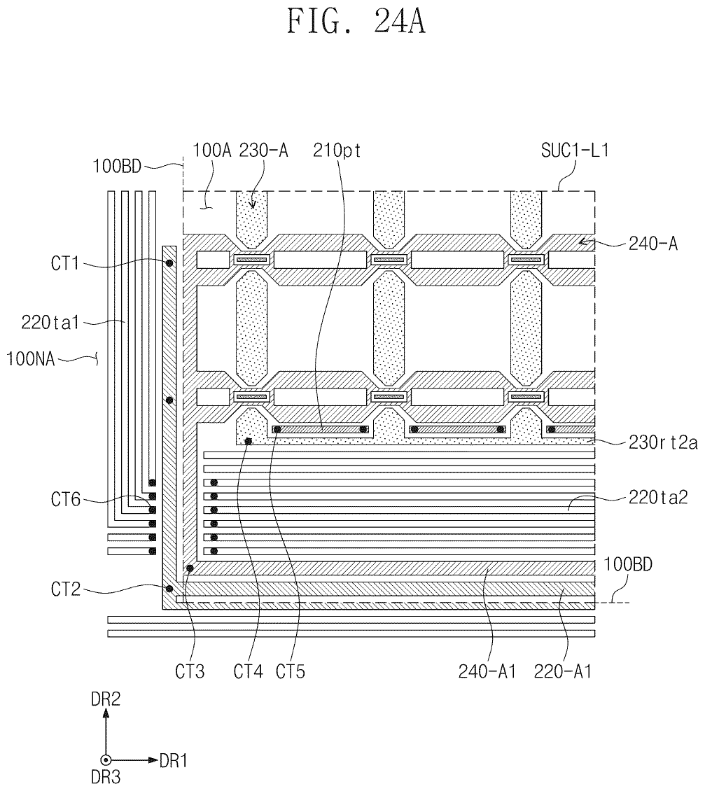

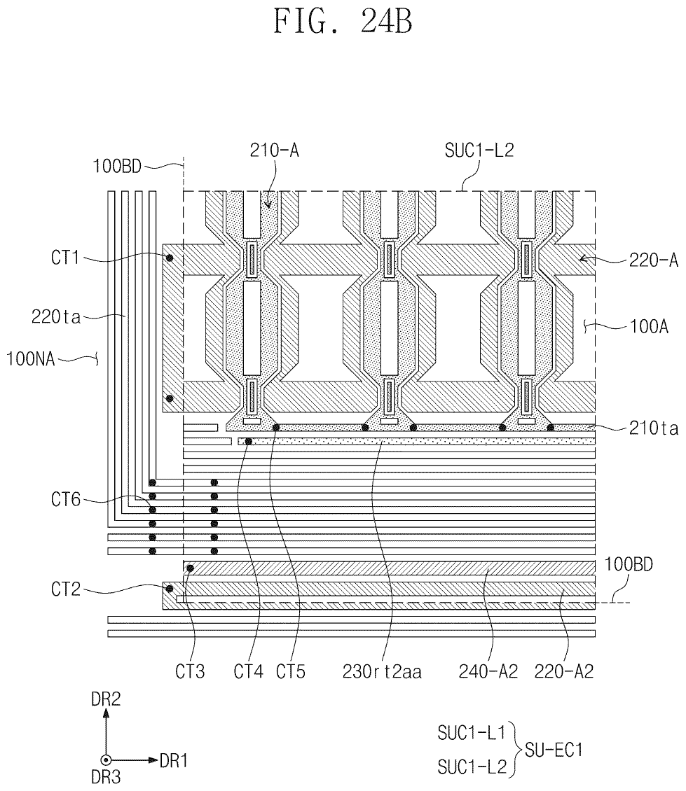

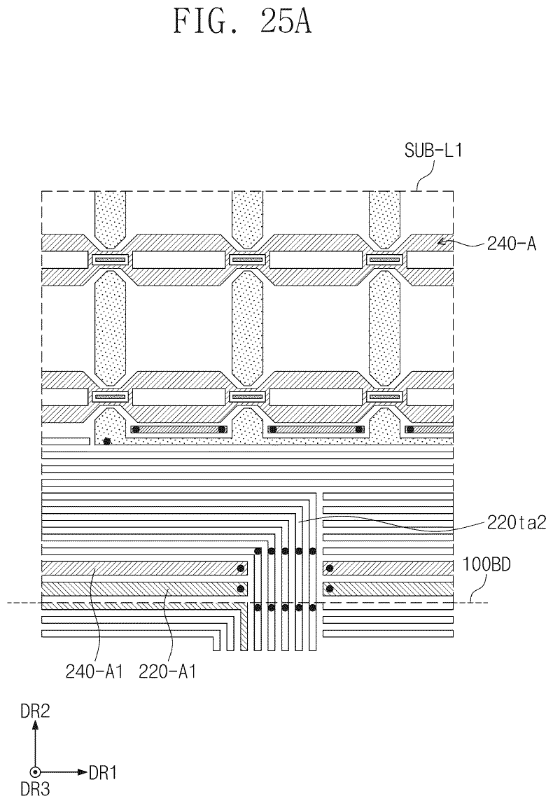

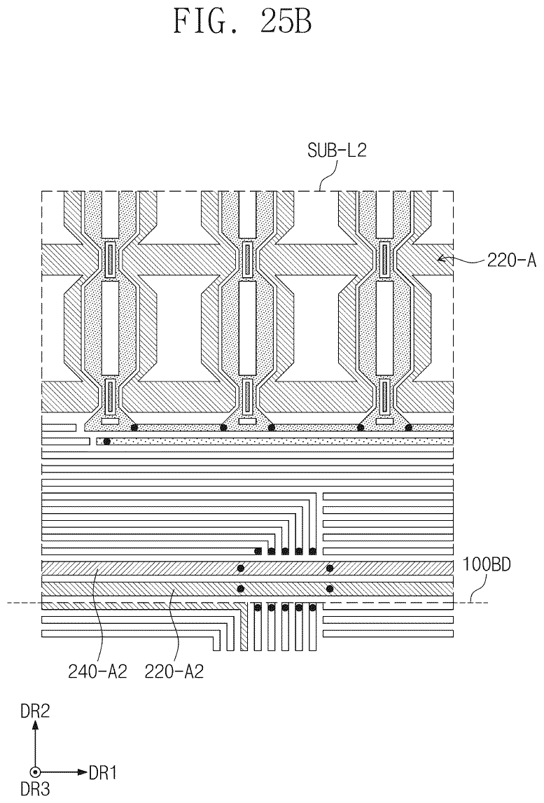

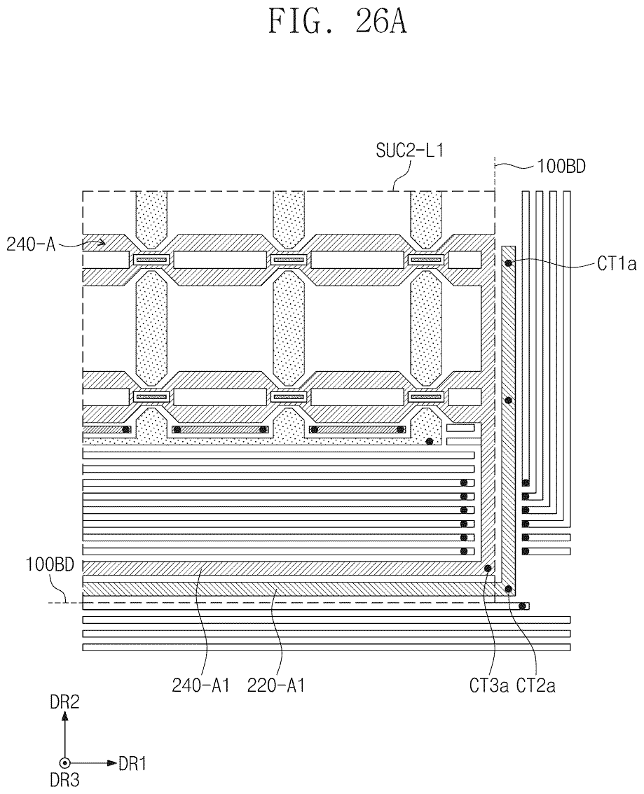

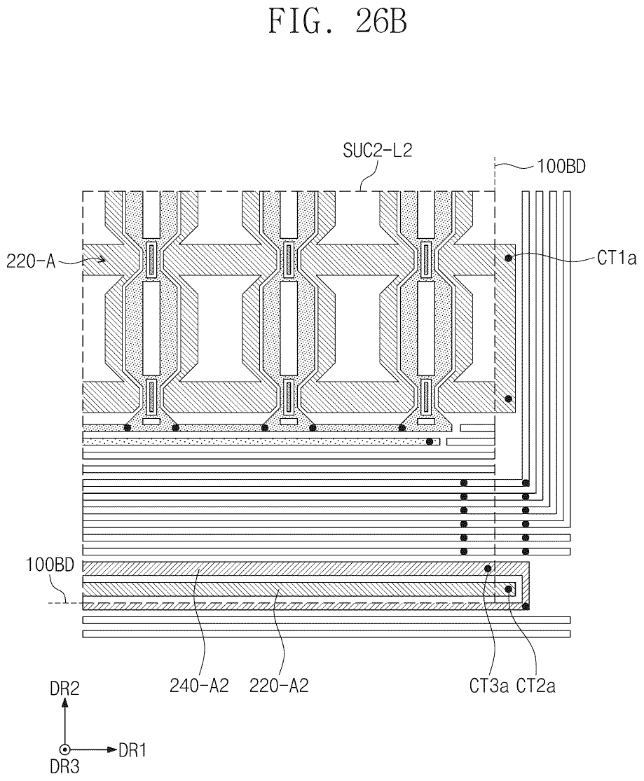

FIG. 24A is a plan view illustrating a portion of the first conductive layer 202 (refer to FIG. 6A) of the sensor layer according to one or more embodiments of the present disclosure. FIG. 24B is a plan view illustrating a portion of the second conductive layer 204 (refer to FIG. 6A) of the sensor layer according to one or more embodiments of the present disclosure. FIG. 25A is a plan view illustrating a portion of the first conductive layer 202 (refer to FIG. 6A) of the sensor layer according to one or more embodiments of the present disclosure. FIG. 25B is a plan view illustrating a portion of the second conductive layer 204 (refer to FIG. 6A) of the sensor layer according to one or more embodiments of the present disclosure. FIG. 26A is a plan view illustrating a portion of the first conductive layer 202 (refer to FIG. 6A) of the sensor layer according to one or more embodiments of the present disclosure. FIG. 26B is a plan view illustrating a portion of the second conductive layer 204 (refer to FIG. 6A) of the sensor layer according to one or more embodiments of the present disclosure.

Referring to FIG. 24A-26B, the boundary 100BD between the display area 100A and the non-display area 100NA adjacent to the display area 100A, which have been described with reference to FIG. 4, is illustrated.

According to one or more embodiments of the present disclosure, at least some of the trace lines of the sensor layer 200 (refer to FIG. 7) may overlap the display area 100A. The area of the peripheral area 200NA of the sensor layer 200 may be reduced. Thus, the area occupied by the peripheral area 200NA on the front surface of the electronic device 1000 (refer to FIG. 1A) may be decreased, and a narrow bezel may be implemented.

A first conductive layer SUC1-L1 and a second conductive layer SUC1-L2 illustrated in FIGS. 24A and 24B may include the first corner outer sensing unit SU-EC1 illustrated in FIG. 10A, a first conductive layer SUB-L1 and a second conductive layer SUB-L2 illustrated in FIGS. 25A and 25B may include the lower outer sensing unit SU-EB illustrated in FIG. 10A, and a first conductive layer SUC2-L1 and a second conductive layer SUC2-L2 illustrated in FIGS. 26A and 26B may include the second corner outer sensing unit SU-EC2 illustrated in FIG. 10A.

The first corner outer sensing unit SU-EC1, the lower outer sensing unit SU-EB, and the second corner outer sensing unit SU-EC2 may be disposed at the lower edge of the sensing area 200A and may be spaced (e.g., spaced apart) from one another in the first direction DR1. A second outer electrode 220-A disposed at the outermost position from among the second electrodes 220 and a fourth outer electrode 240-A disposed at the outermost position among the fourth electrodes 240 may each overlap the first corner outer sensing unit SU-EC1, the lower outer sensing unit SU-EB, and the second corner outer sensing unit SU-EC2.

Each of the second outer electrode 220-A and the fourth outer electrode 240-A may be spaced (e.g., spaced apart) from the boundary 100BD with the trace lines therebetween. For example, the second outer electrode 220-A may have a smaller width in the second direction DR2 than the second-first electrode 220-1 illustrated in FIG. 11B, and the fourth outer electrode 240-A may have a smaller width in the second direction DR2 than the fourth-first electrode 240-1 illustrated in FIG. 11A.

According to one or more embodiments of the present disclosure, additional electrodes 220-A1 and 220-A2 and additional auxiliary electrodes 240-A1 and 240-A2 may be added adjacent to the boundary 100BD to prevent a decrease in pen sensitivity. The additional electrodes 220-A1 and 220-A2 and the additional auxiliary electrodes 240-A1 and 240-A2 may be provided in the area where the trace lines are disposed.

For example, the additional electrodes 220-A1 and 220-A2 and the additional auxiliary electrodes 240-A1 and 240-A2 may be disposed inside the boundary 100BD and may overlap the display area 100A. Alternatively, the additional electrodes 220-A1 and 220-A2 and the additional auxiliary electrodes 240-A1 and 240-A2 may overlap the boundary 100BD. In another case, at least some of the additional electrodes 220-A1 and 220-A2 and the additional auxiliary electrodes 240-A1 and 240-A2 may be disposed inside the boundary 100BD, and the rest may be disposed outside the boundary 100BD. In yet another case, the additional electrodes 220-A1 and 220-A2 and the additional auxiliary electrodes 240-A1 and 240-A2 may be disposed outside the boundary 100BD. The area inside the boundary 100BD may mean the area overlapping the display area 100A, and the area outside the boundary 100BD may mean the area overlapping the non-display area 100NA.

The additional electrodes 220-A1 and 220-A2 may include the first layer additional electrode 220-A1 and the second layer additional electrode 220-A2. Referring to FIG. 24A, the first layer additional electrode 220-A1 may extend corresponding to the extension direction of the boundary 100BD. For example, one portion of the additional electrode 220-A1 may extend in the second direction DR2, and another portion of the additional electrode 220-A1 may extend in the first direction DR1.

Referring to FIGS. 24A and 24B, the first layer additional electrode 220-A1 may be electrically connected with the second outer electrode 220-A through a first contact CT1. The second layer additional electrode 220-A2 may be electrically connected with the first layer additional electrode 220-A1 through a second contact CT2. Referring to FIGS. 26A and 26B, the first layer additional electrode 220-A1 may be electrically connected with the second outer electrode 220-A through a first contact CT1a. The second layer additional electrode 220-A2 may be electrically connected with the first layer additional electrode 220-A1 through a second contact CT2a. That is, the additional electrodes 220-A1 and 220-A2 may be connected to the opposite ends of the second outer electrode 220-A. Accordingly, the path of an induced current induced in the additional electrode 220-A1 and the second outer electrode 220-A may be moved so as to be closer to the boundary 100BD than the path of an induced current induced in the second outer electrode 220-A to which the additional electrode 220-A1 is not connected.

The additional auxiliary electrodes 240-A1 and 240-A2 may include the first layer additional auxiliary electrode 240-A1 and the second layer additional auxiliary electrode 240-A2. Referring to FIG. 24A, the first layer additional auxiliary electrode 240-A1 may be disposed on (e.g., at) the same layer as the fourth outer electrode 240-A and may be integrally connected with the fourth outer electrode 240-A. The first layer additional auxiliary electrode 240-A1 may extend corresponding to the extension direction of the boundary 100BD. For example, one portion of the first layer additional auxiliary electrode 240-A1 may extend in the second direction DR2, and another portion of the first layer additional auxiliary electrode 240-A1 may extend in the first direction DR1.

Referring to FIGS. 24A and 24B, the first layer additional auxiliary electrode 240-A1 may be electrically connected with the second layer additional auxiliary electrode 240-A2 through a third contact CT3. Referring to FIGS. 26A and 26B, the first layer additional auxiliary electrode 240-A1 may be electrically connected with the second layer additional auxiliary electrode 240-A2 through a third contact CT3a. That is, the additional auxiliary electrodes 240-A1 and 240-A2 may be connected to the opposite ends of the fourth outer electrode 240-A.

Referring to FIGS. 24A and 24B, a portion of one third electrode 230-A and a portion of one first electrode 210-A disposed in the first corner outer sensing unit SU-EC1 (refer to FIG. 10A) are illustrated.

A second loop trace line 230rt2a connected to the one third electrode 230-A may be disposed inside the boundary 100BD and may overlap the display area 100A. The sensor layer 200 (refer to FIG. 7) may further include a first line 230rt2aa connected with the second loop trace line 230rt2a through a fourth contact CT4. The first line 230rt2aa may also overlap the display area 100A.

A first trace line 210ta connected to the one first electrode 210-A may be disposed inside the boundary 100BD and may overlap the display area 100A. The sensor layer 200 (refer to FIG. 7) may further include trace patterns 210pt connected with the first trace line 210ta. The trace patterns 210pt may be electrically connected to the first trace line 210ta through a fifth contact CT5.

Referring to FIG. 24B, one second trace line 220ta is illustrated as an example. The one second trace line 220ta may include a portion extending in an area overlapping the non-display area 100NA and a portion extending in an area overlapping the display area 100A. Referring to FIG. 24A, the sensor layer 200 (refer to FIG. 7) may further include a second line 220ta1 and a third line 220ta2 that are connected with the one second trace line 220ta through a sixth contact CT6. The second line 220ta1 may overlap the non-display area 100NA, and the third line 220ta2 may overlap the display area 100A.

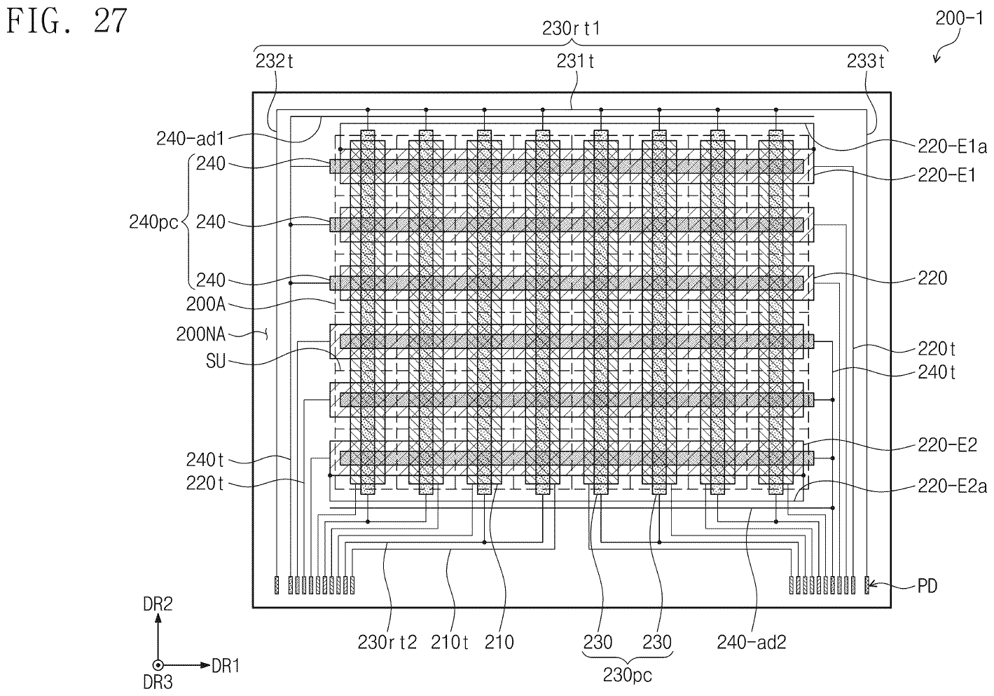

FIG. 27 is a plan view of a sensor layer 200-1 according to one or more embodiments of the present disclosure. In describing FIG. 27, components identical to the components described with reference to FIG. 7 will be assigned with identical reference numerals, and description thereabout will be omitted.

Referring to FIG. 27, a sensing area 200A and a peripheral area 200NA adjacent to the sensing area 200A may be defined in the sensor layer 200-1. The sensor layer 200-1 may include a plurality of first electrodes 210, a plurality of second electrodes 220, a plurality of third electrodes 230, and a plurality of fourth electrodes 240 disposed in the sensing area 200A.

According to one or more embodiments of the present disclosure, the sensor layer 200-1 may further include a first additional electrode 220-E1a and a second additional electrode 220-E2a. The first additional electrode 220-E1a and the second additional electrode 220-E2a may be disposed in the peripheral area 200NA. For example, the first additional electrode 220-E1a and the second additional electrode 220-E2a may be provided between trace lines or may be provided adjacent to the outer edge of the sensor layer 200-1. One of the first additional electrode 220-E1a and the second additional electrode 220-E2a may be omitted.

The first additional electrode 220-E1a may be electrically connected with one second electrode 220-E1 from among the second electrodes 220, and the second additional electrode 220-E2a may be electrically connected with another second electrode 220-E2 from among the second electrodes 220. When the second electrodes 220 are sequentially arranged along the second direction DR2, the one second electrode 220-E1 and the other second electrode 220-E2 may be disposed at the outermost positions.

One end and an opposite end of the first additional electrode 220-E1a may be electrically connected with the one second electrode 220-E1, and one end and an opposite end of the second additional electrode 220-E2a may be electrically connected with the other second electrode 220-E2. That is, the first additional electrode 220-E1a and the one second electrode 220-E1 may function as one channel, and the second additional electrode 220-E2a and the other second electrode 220-E2 may function as one channel.

In one or more embodiments of the present disclosure, the sensor layer 200-1 may further include a first additional auxiliary electrode 240-ad1 and a second additional auxiliary electrode 240-ad2. The first additional auxiliary electrode 240-ad1 may be electrically connected to one second electrode group 240pc, and the second additional auxiliary electrode 240-ad2 may be electrically connected to another second electrode group 240pc. The first additional auxiliary electrode 240-ad1 may be disposed adjacent to the first additional electrode 220-E1a, and the second additional auxiliary electrode 240-ad2 may be disposed adjacent to the second additional electrode 220-E2a.

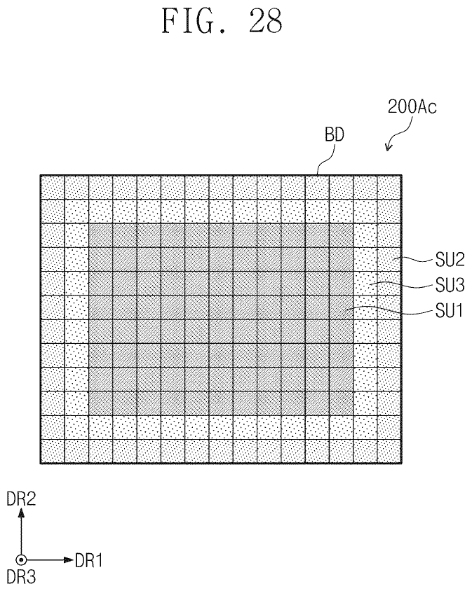

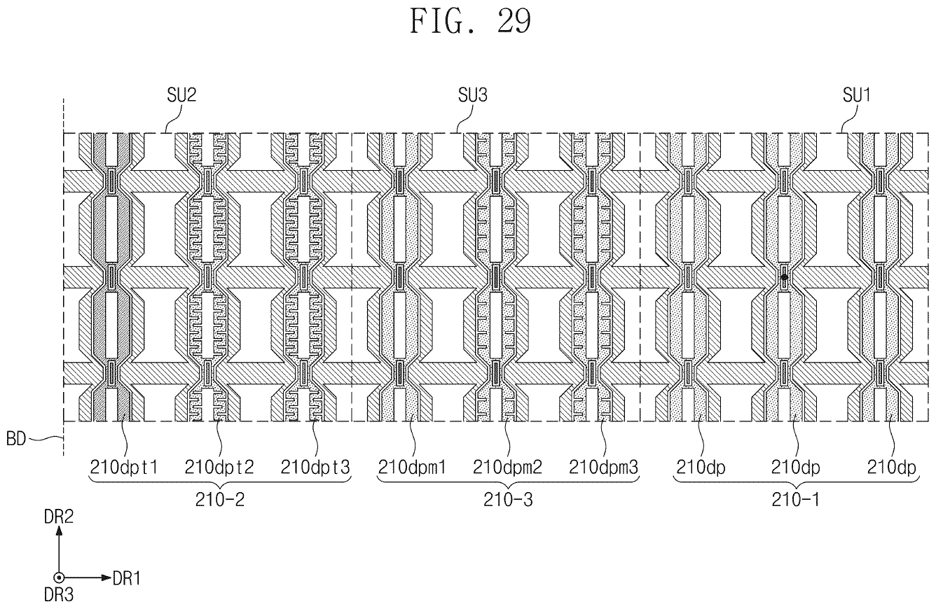

FIG. 28 is a plan view illustrating a sensing area 200Ac according to one or more embodiments of the present disclosure. FIG. 29 is a plan view illustrating a second conductive layer of three sensing units SU2, SU3, and SU1 according to one or more embodiments of the present disclosure.

Referring to FIGS. 7, 28, and 29, the sensing area 200Ac may include the plurality of sensing units SU1, SU2, and SU3. The sensing units SU1, SU2, and SU3 may include the first sensing units SU1, the second sensing units SU2, and the third sensing units SU3. The third sensing units SU3 may be disposed between the first sensing units SU1 and the second sensing units SU2.

Referring to FIG. 29, a first-first electrode 210-1 overlapping the first sensing unit SU1 may include a plurality of first sub-electrodes 210dp that are arranged along the first direction DR1 and that have substantially the same shape. A first-second electrode 210-2 overlapping the second sensing unit SU2 may include a plurality of second sub-electrodes 210dpt1, 210dpt2, and 210dpt3 arranged along the first direction DR1. A first-third electrode 210-3 overlapping the third sensing unit SU3 may include a plurality of third sub-electrodes 210dpm1, 210dpm2, and 210dpm3 arranged along the first direction DR1.

The first sub-electrodes 210dp may have the same shape. Accordingly, the resistance ratio between the first sub-electrodes 210dp may be 1:1:1. The second sub-electrodes 210dpt1, 210dpt2, and 210dpt3 may be referred to as the second-first sub-electrode 210dpt1, the second-second sub-electrode 210dpt2, and the second-third sub-electrode 210dpt3. The resistance ratio between the second-first sub-electrode 210dpt1, the second-second sub-electrode 210dpt2, and the second-third sub-electrode 210dpt3 may be 0.5:2:2, but is not particularly limited thereto. The resistance ratio may be adjusted in various ways, as long as the resistance of the second-first sub-electrode 210dpt1 adjacent to the peripheral area 200NA is made lower.

The third sub-electrodes 210dpm1, 210dpm2, and 210dpm3 may be referred to as the third-first sub-electrode 210dpm1, the third-second sub-electrode 210dpm2, and the third-third sub-electrode 210dpm3. The resistance ratio between the third-first sub-electrode 210dpm1, the third-second sub-electrode 210dpm2, and the third-third sub-electrode 210dpm3 may have a value between the resistance ratio between the first sub-electrodes 210dp and the resistance ratio between the second-first sub-electrode 210dpt1, the second-second sub-electrode 210dpt2, and the second-third sub-electrode 210dpt3. For example, the resistance ratio between the third-first sub-electrode 210dpm1, the third-second sub-electrode 210dpm2, and the third-third sub-electrode 210dpm3 may be (more than 0.5 and less than 2):2:2.

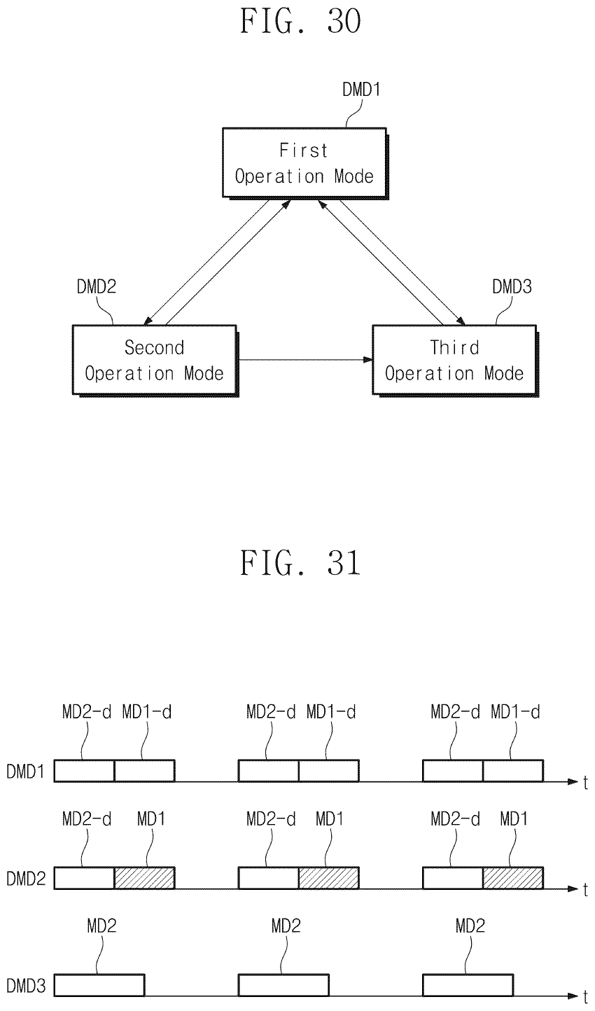

FIG. 30 is a view illustrating an operation of the sensor driver 200C (refer to FIG. 5) according to one or more embodiments of the present disclosure.

Referring to FIGS. 5 and 30, the sensor driver 200C may be selectively driven in one of a first operation mode DMD1, a second operation mode DMD2, and a third operation mode DMD3.

The first operation mode DMD1 may be referred to as a touch and pen standby mode, the second operation mode DMD2 may be referred to as a touch activation and pen standby mode, and the third operation mode DMD3 may be referred to as a pen activation mode. The first operation mode DMD1 may be a mode in which the sensor driver 200C waits for the first input 2000 and the second input 3000. The second operation mode DMD2 may be a mode in which the sensor driver 200C senses the first input 2000 and waits for the second input 3000. The third operation mode DMD3 may be a mode in which the sensor driver 200C senses the second input 3000.

In one or more embodiments of the present disclosure, the sensor driver 200C may first be driven in the first operation mode DMD1. When the first input 2000 is sensed in the first operation mode DMD1, the sensor driver 200C may be switched (or, changed) to the second operation mode DMD2. Alternatively, when the second input 3000 is sensed in the first operation mode DMD1, the sensor driver 200C may be switched (or, changed) to the third operation mode DMD3.

In one or more embodiments of the present disclosure, when the second input 3000 is sensed in the second operation mode DMD2, the sensor driver 200C may be switched to the third operation mode DMD3. When the first input 2000 is released (or, not sensed) in the second operation mode DMD2, the sensor driver 200C may be switched to the first operation mode DMD1. When the second input 3000 is released (or, not sensed) in the third operation mode DMD3, the sensor driver 200C may be switched to the first operation mode DMD1.

FIG. 31 is a view illustrating an operation of the sensor driver 200C (refer to FIG. 5) according to one or more embodiments of the present disclosure.

Referring to FIGS. 5, 30, and 31, operations in the first to third operation modes DMD1, DMD2, and DMD3 are illustrated in order of time (t).

In the first operation mode DMD1, the sensor driver 200C may be repeatedly driven in a second mode MD2-d and a first mode MD1-d. During the second mode MD2-d, the sensor layer 200 may be scan-driven to detect the second input 3000. During the first mode MD1-d, the sensor layer 200 may be scan-driven to detect the first input 2000. Although FIG. 31 illustrates an example that the sensor driver 200C operates in the first mode MD1-d continuously after the second mode MD2-d, the sequence is not limited thereto.

In the second operation mode DMD2, the sensor driver 200C may be repeatedly driven in a second mode MD2-d and a first mode MD1. During the second mode MD2-d, the sensor layer 200 may be scan-driven to detect the second input 3000. During the first mode MD1, the sensor layer 200 may be scan-driven to detect the coordinates of the first input 2000.

In the third operation mode DMD3, the sensor driver 200C may be driven in a second mode MD2. During the second mode MD2, the sensor layer 200 may be scan-driven to detect the coordinates of the second input 3000. In the third operation mode DMD3, the sensor driver 200C may not operate in the first mode MD1-D or MD1 until the second input 3000 is released (or, not sensed).

Referring to FIG. 7 together, in the first mode MD1-d and the first mode MD1, all of the third electrodes 230 and the fourth electrodes 240 may be grounded or may receive a constant voltage. Alternatively, in the first mode MD1-d and the first mode MD1, the third electrodes 230, and the fourth electrodes 240 may all be floated (or, electrically floated). In another case, in the first mode MD1-d and the first mode MD1, a signal in phase with a transmission signal provided to the first electrodes 210 may be applied to the third electrodes 230 and the fourth electrodes 240. In this case, touch noise may be prevented from being introduced through the third electrodes 230 and the fourth electrodes 240.

In the second mode MD2-d and the second mode MD2, first ends of the third electrodes 230 and the fourth electrodes 240 may all be floated. In addition, in the second mode MD2-d and the second mode MD2, second ends of the third electrodes 230 and the fourth electrodes 240 may all be grounded or floated. Accordingly, compensation of a sensing signal may be maximized by the coupling between the first electrodes 210 and the third electrodes 230 and the coupling between the second electrodes 220 and the fourth electrodes 240.

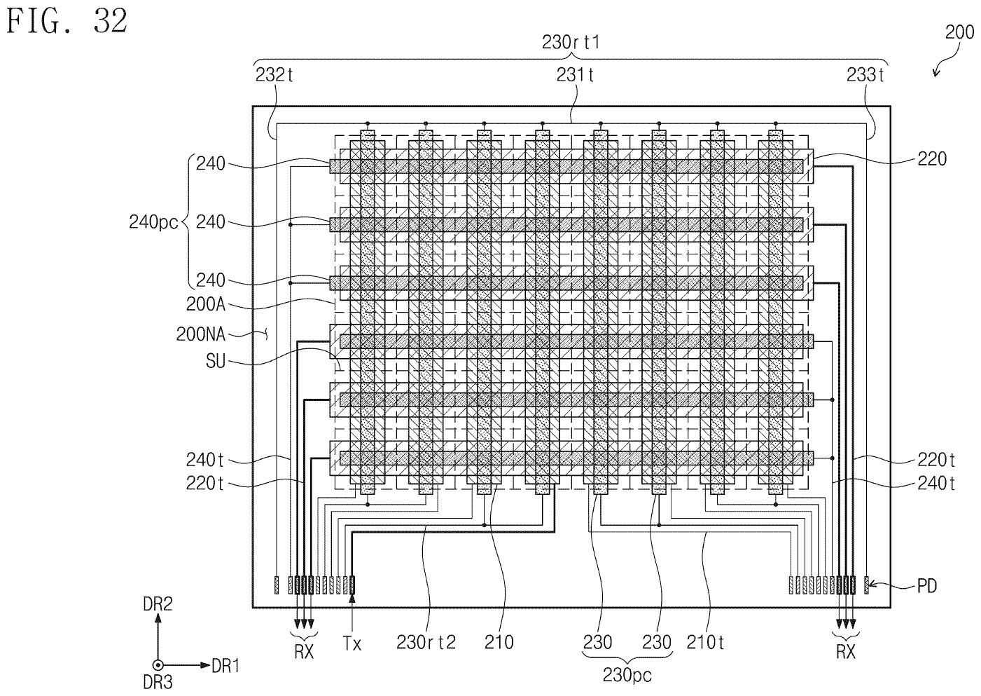

FIG. 32 is a view for explaining the first mode according to one or more embodiments of the present disclosure.

Referring to FIGS. 5, 31, and 32, the first mode MD1-d of the first operation mode DMD1 and the first mode MD1 of the second operation mode DMD2 may include a mutual capacitance detection mode. FIG. 32 is a view for explaining the mutual capacitance detection mode in the first mode MD1-d of the first operation mode DMD1 and the first mode MD1 of the second operation mode DMD2.

In the mutual capacitance detection mode, the sensor driver 200C may sequentially provide a transmission signal TX to the first electrodes 210 and may detect the coordinates of the first input 2000 using a reception signal RX detected through the second electrodes 220. For example, the sensor driver 200C may sense a change in the mutual capacitance between the first electrodes 210 and the second electrodes 220 and may calculate the input coordinates.

FIG. 32 illustrates an example that the transmission signal TX is provided to one first electrode 210 and the reception signal RX is output from the second electrodes 220. The sensor driver 200C may sense a change in the capacitance between the first electrode 210 and each of the second electrodes 220 and may detect the input coordinates of the first input 2000.

In one or more embodiments of the present disclosure, at least one of the first mode MD1-d of the first operation mode DMD1 and the first mode MD1 of the second operation mode DMD2 may further include a self-capacitance detection mode. In the self-capacitance detection mode, the sensor driver 200C may calculate the input coordinates by outputting drive signals to the first electrodes 210 and the second electrodes 220 and sensing a change in the capacitance of each of the first electrodes 210 and the second electrodes 220.

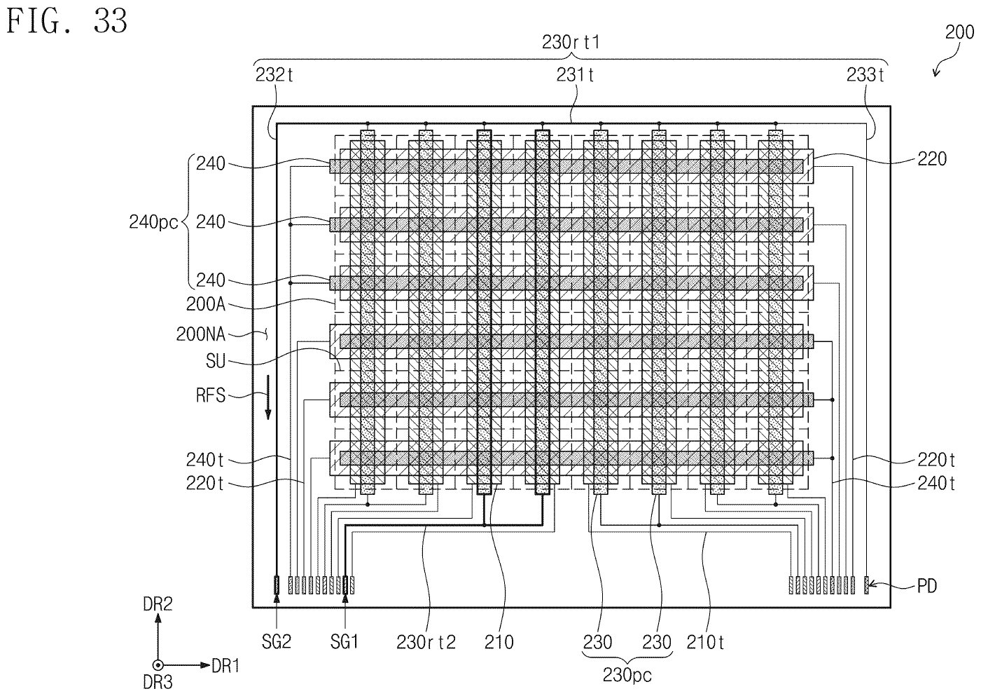

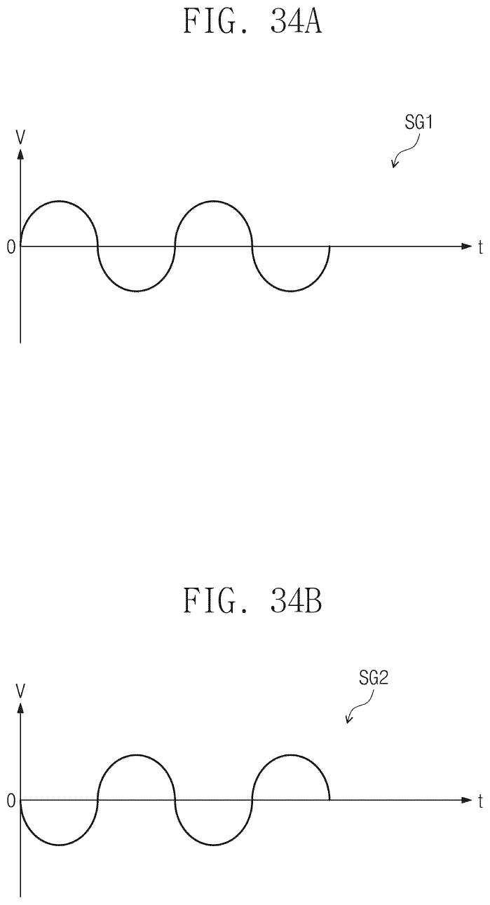

FIG. 33 is a view for explaining the second mode, particularly, the charging operation mode according to one or more embodiments of the present disclosure. FIG. 34A is a graph depicting the waveform of a first signal SG1 according to one or more embodiments of the present disclosure. FIG. 34B is a graph depicting the waveform of a second signal SG2 according to one or more embodiments of the present disclosure.

Referring to FIGS. 33, 34A, and 34B, the second mode MD2 may include the charging operation mode. The charging operation mode may include a searching charging operation mode and a tracking charging operation mode.

The searching charging operation mode may be an operation mode before the position of the pen PN is sensed. Accordingly, the first signal SG1 or the second signal SG2 may be sequentially provided to all channels included in the sensor layer 200. That is, in the searching charging operation mode, the entire area of the sensor layer 200 may be sequentially scanned. When the pen PN is sensed in the searching charging operation mode, the sensor layer 200 may be driven in the tracking charging operation mode. For example, in the tracking charging operation mode, the sensor driver 200C may sequentially output the first signal SG1 and the second signal SG2 to an area overlapping the point where the pen PN rather than the entire sensor layer 200 is sensed.

In the charging operation mode, the sensor driver 200C may apply the first signal SG1 to one pad from among the pads connected with the one end and the opposite end of the first loop trace lines 230rt1 and the second loop trace lines 230rt2 and may apply the second signal SG2 to another pad. The second signal SG2 may be an inverse signal of the first signal SG1. For example, the first signal SG1 may be a sinusoidal signal.

Because the first signal SG1 and the second signal SG2 are applied to at least two pads, a current RFS may have a current path to flow through the one pad to the other pad. In addition, since the first signal SG1 and the second signal SG2 are sinusoidal signals having an inverse phase relationship, the direction of the current RFS may be periodically varied. In one or more embodiments of the present disclosure, the first signal SG1 and the second signal SG2 may be square-wave signals having an inverse phase relationship.

When the first signal SG1 and the second signal SG2 have an inverse phase relationship, noise caused in the display layer 100 (refer to FIG. 4) by the first signal SG1 may be cancelled out by noise caused by the second signal SG2. Accordingly, a flicker phenomenon may not occur in the display layer 100, and the display quality of the display layer 100 may be improved.

In one or more embodiments of the present disclosure, the first signal SG1 may be a sinusoidal signal. However, without being limited thereto, the first signal SG1 may be a square-wave signal. The second signal SG2 may have a constant voltage (e.g., a predetermined constant voltage). For example, the second signal SG2 may be a ground voltage. That is, a pad to which the second signal SG2 is applied may be regarded as being grounded. Even in this case, the current RFS may flow from one pad to another pad. In addition, even though the other pad is grounded, the direction of the current RFS may be periodically varied because the first signal SG1 is a sinusoidal signal or a square-wave signal.

FIG. 33 illustrates an example that the second signal SG2 is provided to one end of one first loop trace lines 230rt1 and the first signal SG1 is provided to one first electrode group 230pc. The current RFS may flow along the current path including the first loop trace line 230rt1 and the first electrode group 230pc. The current path may have a coil shape. Accordingly, in the charging operation mode of the second mode, the resonance circuit of the pen PN may be charged by the current path.

According to the present disclosure, a current path having a loop coil pattern may be implemented by components included in the sensor layer 200. Accordingly, the electronic device 1000 (refer to FIG. 1A) may charge the pen PN using the sensor layer 200. Thus, a component having a coil for charging the pen PN does not need to be separately added so that an increase in the thickness and weight of the electronic device 1000 and a decrease in the flexibility of the electronic device 1000 may not occur.

In the charging operation mode, the first electrodes 210, the second electrodes 220, and the fourth electrodes 240 may be grounded or electrically floated or may receive a constant voltage. In particular, the first electrodes 210, the second electrodes 220, and the fourth electrodes 240 may be floated. In this case, the electric current RFS may not flow to the first electrodes 210, the second electrodes 220, and the fourth electrodes 240.

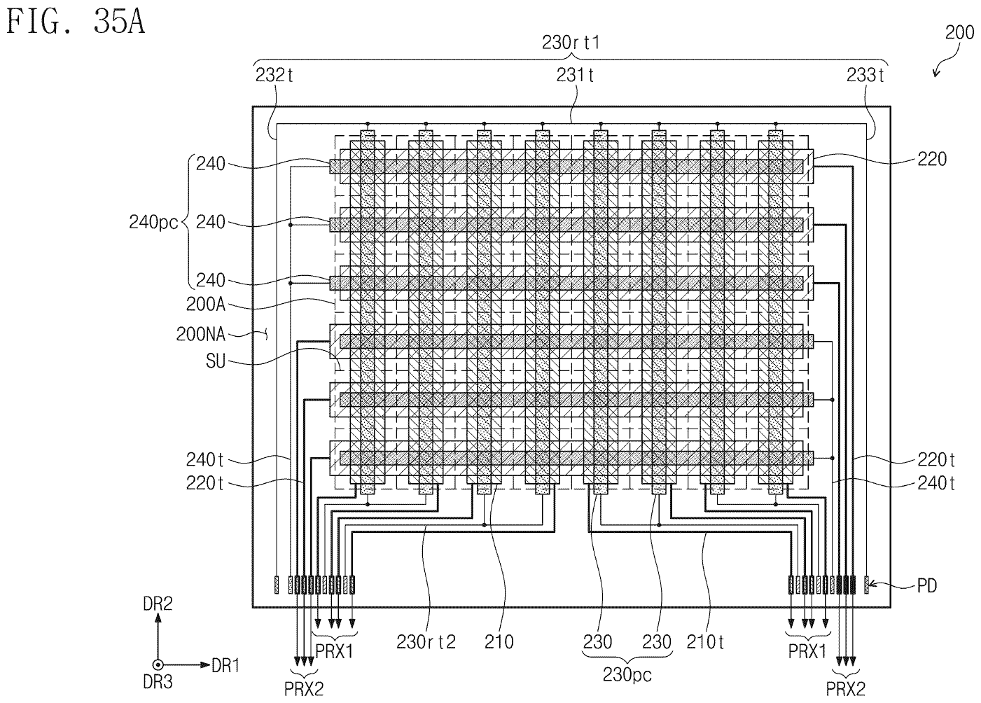

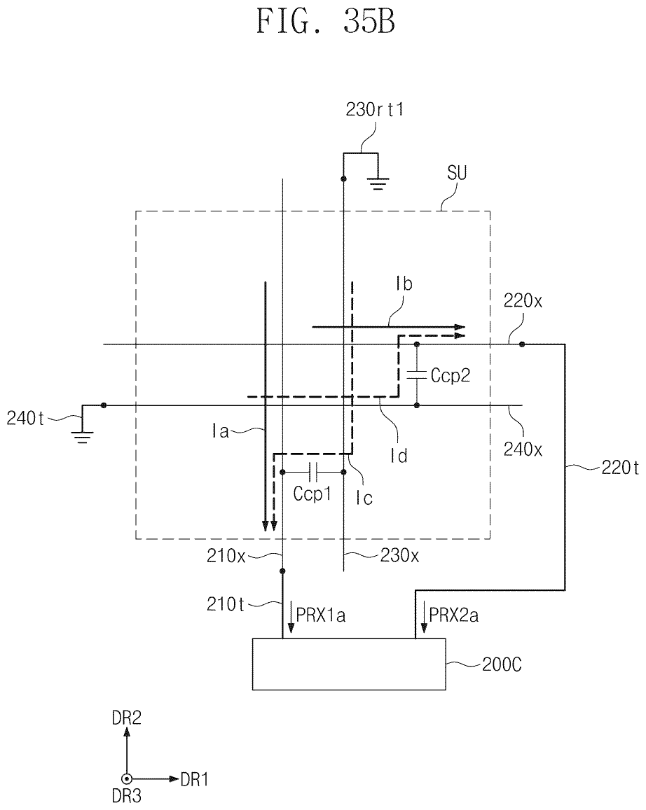

FIG. 35A is a view for explaining the second mode according to one or more embodiments of the present disclosure. FIG. 35B is a view for explaining the second mode based on one sensing unit SU according to one or more embodiments of the present disclosure.

Referring to FIGS. 35A and 35B, the second mode may include a charging operation mode and a pen sensing operation mode. FIGS. 35A and 35B are views for explaining the pen sensing operation mode.

Referring to FIG. 35A, in the pen sensing operation mode, first reception signals PRX1 may be output from the first electrodes 210, and second reception signals PRX2 may be output from the second electrodes 220. In FIG. 35B, one sensing unit SU through which first to fourth induced currents Ia, Ib, Ic, and Id generated by the pen PN flow is illustrated.

Referring to FIGS. 35A and 35B, in one or more embodiments of the present disclosure, the routing directions of one electrode and another electrode of the sensor layer 200 that overlap each other may be different from each other. For example, the routing direction of a first electrode 210x and the routing direction of a third electrode 230x may be different from each other. In addition, the routing direction of a second electrode 220x and the routing direction of a fourth electrode 240x may be different from each other. For example, in FIG. 35B, the first electrode 210x and the first trace line 210t may be connected with each other on the lower side of the sensing unit SU, and the third electrode 230x and the first loop trace line 230rt1 may be connected with each other on the upper side of the sensing unit SU. The second electrode 220x and the second trace line 220t may be connected with each other on the right side of the sensing unit SU, and the fourth electrode 240x and the group trace line 240t may be connected with each other on the left side of the sensing unit SU.

The RLC resonance circuit of the pen PN may emit a magnetic field having a resonant frequency while discharging charged charges. Due to the magnetic field provided by the pen PN, the first induced current Ia may be generated in the first electrode 210x, and the second induced current Ib may be generated in the second electrode 220x. In addition, the third induced current Ic may be generated in the third electrode 230x, and the fourth induced current Id may be generated in the fourth electrode 240x.

A first coupling capacitor Ccp1 may be formed between the third electrode 230x and the first electrode 210x, and a second coupling capacitor Ccp2 may be formed between the fourth electrode 240x and the second electrode 220x. The third induced current Ic may be transferred to the first electrode 210x through the first coupling capacitor Ccp1, and the fourth induced current Id may be transferred to the second electrode 220x through the second coupling capacitor Ccp2.

The sensor driver 200c may receive a first reception signal PRX1a based on the first induced current Ia and the third induced current Ic from the first electrode 210x and may receive a second reception signal PRX2a based on the second induced current Ib and the fourth induced current Id from the second electrode 220x. The sensor driver 200C may detect the input coordinates of the pen PN, based on the first reception signal PRX1a and the second reception signal PRX2a.

The sensor driver 200C may receive the first reception signal PRX1a from the first electrode 210x and may receive the second reception signal PRX2a from the second electrode 220x. In this case, first ends of the third electrode 230x and the fourth electrode 240x may all be floated. Accordingly, compensation of a sensing signal may be maximized by the coupling between the first electrode 210x and the third electrode 230x and the coupling between the second electrode 220x and the fourth electrode 240x.

In addition, second ends of the third electrode 230x and the fourth electrode 240x may be grounded or floated. Accordingly, the third induced current Ic and the fourth induced current Id may be sufficiently transferred to the first electrode 210x and the second electrode 220x by the coupling between the first electrode 210x and the third electrode 230x and the coupling between the second electrode 220x and the fourth electrode 240x.

As described above, the resistances or shapes of the channels disposed adjacent to the peripheral area may be asymmetrically designed. For example, the current paths of the channels may be adjusted closer to the peripheral area than the centers of the channels. In this case, a difference between signals, for example, a difference in intensity between induced currents may be further increased during differential sensing, and thus the pen sensing sensitivity in the area adjacent to the peripheral area may be further improved.

While the present disclosure has been described with reference to embodiments thereof, it will be apparent to those of ordinary skill in the art that various changes and modifications may be made thereto without departing from the spirit and scope of the present disclosure as set forth in the following claims and their equivalents.

What is claimed is:

1. An electronic device comprising:
a sensor layer having a sensing area and a peripheral area adjacent to the sensing area; and
a sensor driver configured to drive the sensor layer,
wherein the sensor layer comprises:
a plurality of first electrodes arranged along a first direction; and
a plurality of second electrodes configured to cross the plurality of first electrodes and arranged along a second direction crossing the first direction,
wherein the sensing area comprises a plurality of sensing units arranged along the first direction and the second direction,
wherein the plurality of sensing units comprises a first sensing unit spaced from the peripheral area and a second sensing unit in contact with the peripheral area,
wherein the plurality of first electrodes comprises a first-first electrode configured to overlap the first sensing unit and a first-second electrode configured to overlap the second sensing unit,
wherein the plurality of second electrodes comprises a second-first electrode configured to overlap the first sensing unit and a second-second electrode configured to overlap the second sensing unit,
wherein the first-first electrode and the second-first electrode have a symmetrical structure with respect to a line extending in the first direction and a line extending in the second direction in the first sensing unit, and
wherein the first-second electrode and the second-second electrode have an asymmetrical structure with respect to at least one of a line extending in the first direction or a line extending in the second direction in the second sensing unit.

2. The electronic device of claim 1, wherein the first-first electrode comprises a plurality of first sub-electrodes arranged along the first direction and having substantially the same shape,
wherein the first-second electrode comprises a plurality of second sub-electrodes arranged along the first direction, and
wherein resistance of one second sub-electrode from among the plurality of second sub-electrodes is lower than resistance of another second sub-electrode from among the plurality of second sub-electrodes.

3. The electronic device of claim 2, wherein the one second sub-electrode is closer to the peripheral area than the another second sub-electrode.

4. The electronic device of claim 2, wherein the one second sub-electrode has a larger area than the another second sub-electrode.

5. The electronic device of claim 2, wherein the one second sub-electrode comprises a plurality of first mesh lines having a first line width, and the another second sub-electrode comprises a plurality of second mesh lines having a second line width smaller than the first line width.

6. The electronic device of claim 2, wherein the sensor layer further comprises a plurality of third electrodes arranged along the first direction, and the plurality of third electrodes overlap the plurality of first electrodes in a one-to-one correspondence,
wherein the plurality of third electrodes comprises one third electrode configured to overlap the first-second electrode, and
wherein the one third electrode comprises a plurality of third sub-electrodes arranged along the first direction.

7. The electronic device of claim 6, wherein the plurality of third sub-electrodes comprises a third-first sub-electrode configured to overlap the one second sub-electrode and a third-second sub-electrode configured to overlap the other second sub-electrode, and resistance of the third-first sub-electrode is lower than resistance of the third-second sub-electrode.

8. The electronic device of claim 7, wherein the third-first sub-electrode comprises a first bridge pattern on a same layer as the one second sub-electrode,
wherein the third-second sub-electrode comprises a second bridge pattern on a same layer as the first bridge pattern, and
wherein resistance of the first bridge pattern is lower than resistance of the second bridge pattern.

9. The electronic device of claim 8, wherein a number of mesh lines included in the first bridge pattern is greater than a number of mesh lines included in the second bridge pattern.

10. The electronic device of claim 7, wherein first capacitance between the one second sub-electrode and the third-first sub-electrode is greater than second capacitance between the another second sub-electrode and the third-second sub-electrode, and
wherein the third-first sub-electrode is closer to the peripheral area than the third-second sub-electrode.

11. The electronic device of claim 1, wherein the plurality of sensing units further comprises a third sensing unit between the first sensing unit and the second sensing unit,
wherein the plurality of first electrodes further comprises a first-third electrode configured to overlap the third sensing unit, and
wherein the first-third electrode has a shape different from a shape of the first-first electrode and a shape of the first-second electrode.

12. The electronic device of claim 11, wherein the first-first electrode comprises a plurality of first sub-electrodes arranged along the first direction and having substantially the same shape,
wherein the first-second electrode comprises a plurality of second sub-electrodes arranged along the first direction,
wherein the first-third electrode comprises a plurality of third sub-electrodes arranged along the first direction,
wherein the plurality of first sub-electrodes have a same resistance ratio, and
wherein a maximum difference in resistance ratio between the plurality of second sub-electrodes is greater than a maximum difference in resistance ratio between the plurality of third sub-electrodes.

13. The electronic device of claim 1, wherein the first-second electrode comprises a first layer electrode on a same layer as the first-first electrode and a second layer electrode located below the first layer electrode and electrically connected with the first layer electrode.

14. The electronic device of claim 1, wherein the sensor layer further comprises an additional electrode connected with one second electrode from among the plurality of second electrodes, and
wherein the plurality of second electrodes are sequentially arranged along the second direction, and the one second electrode is one of two second electrodes located at outermost positions from among the plurality of second electrodes.

15. The electronic device of claim 14, wherein the sensor layer further comprises:
a plurality of first trace lines electrically connected with the plurality of first electrodes; and
a plurality of second trace lines electrically connected with the plurality of second electrodes, and
wherein some of the plurality of second trace lines are located between the one second electrode and the additional electrode.

16. The electronic device of claim 15, further comprising:
a display layer located below the sensor layer, the display layer comprising a display area and a non-display area adjacent to the display area,
wherein the some of the plurality of second trace lines overlap the display area.

17. The electronic device of claim 1, wherein a crossing area where the first-second electrode and the second-second electrode overlap each other in the second sensing unit is closer to the peripheral area than a center of the second sensing unit.

18. The electronic device of claim 1, wherein the first sensing unit and the second sensing unit are spaced from each other in the first direction, and the first sensing unit has a greater width in the first direction than the second sensing unit.

19. An electronic device comprising:
a sensor layer having a sensing area and a peripheral area adjacent to the sensing area; and
a sensor driver configured to drive the sensor layer,
wherein the sensor layer comprises:
a plurality of first electrodes;
a plurality of second electrodes configured to cross the plurality of first electrodes;
a plurality of third electrodes configured to overlap the plurality of first electrodes; and
a plurality of fourth electrodes configured to cross the plurality of first electrodes,
wherein the sensing area comprises a plurality of sensing units arranged along a first direction and a second direction crossing the first direction,
wherein the plurality of sensing units comprises a first sensing unit spaced from the peripheral area and a second sensing unit in contact with the peripheral area,
wherein the plurality of first electrodes comprises a first-first electrode configured to overlap the first sensing unit and a first-second electrode configured to overlap the second sensing unit, and
wherein the first-first electrode has a shape different from a shape of the first-second electrode.

20. An electronic device comprising:
a sensor layer in which a sensing area and a peripheral area adjacent to the sensing area are defined; and
a sensor driver configured to drive the sensor layer,
wherein the sensing area includes a plurality of sensing units,
wherein the plurality of sensing units include a first sensing unit spaced apart from the peripheral area and a second sensing unit in contact with the peripheral area,
wherein the second sensing unit includes a first sub-area adjacent to the peripheral area and a second sub-area spaced apart from the peripheral area with the first sub-area therebetween, and
wherein an area occupied by a conductive pattern configured to transfer a predetermined signal in the first sub-area is greater than an area occupied by a conductive pattern configured to transfer the predetermined signal in the second sub-area.
